(19) United States
(12) Patent Application Publication
(10) Pub. No.: US 2026/0347142 A1
(43) Pub. Date: Nov. 5, 2026

(54) OUTPUT DEVICE AND OUTPUT ASSEMBLY

(71) Applicant: Beyond Power Inc., Shenzhen, Guangdong (CN)

(72) Inventors: ZHANGXING ZHOU, Shenzhen (CN); SIRONG HUANG, Shenzhen (CN); JUNCHENG CHEN, Shenzhen (CN); HONGTAO PAN, Shenzhen (CN); HANG YIN, Shenzhen (CN); JIALE HE, Shenzhen (CN); JIAHAO YI, Shenzhen (CN); JIEHONG MAI, Shenzhen (CN); QIANBIN ZUO, Shenzhen (CN)

(21) Appl. No.: 19/158,453

(22) PCT Filed: Feb. 21, 2024
(86) PCT No.: PCT/CN2024/077946

§ 371 Date: Aug. 21, 2025

(30) Foreign Application Priority Data
Feb. 21, 2023 (CN) 2023101725587
Feb. 21, 2023 (CN) 2023101804377
Feb. 21, 2023 (CN) 2023101864236
Feb. 21, 2023 (CN) 2023102030744
Feb. 21, 2023 (CN) 2023203461288
Feb. 21, 2023 (CN) 2023203568942
Feb. 21, 2023 (CN) 2023203642438
Feb. 21, 2023 (CN) 2023203912564
Jul. 17, 2023 (CN) 2023218794895
Sep. 28, 2023 (CN) 2023226803881

(51) Int. Cl. B65H 75/44; B65H 75/26; B65H 75/30

(52) U.S. Cl. CPC B65H 75/4486; B65H 75/265; B65H 75/30

(57) ABSTRACT

An output device and an output assembly are provided. The output device includes: a cordage box, a connecting structure configured to be fixedly connected to a base being provided on a rear side of the cordage box, and a traction cordage in the cordage box being led out from a front side of the cordage box; a motor, which is fixedly connected to the cordage box and is configured to provide a traction force for the traction cordage; and a power supply assembly, which is fixedly connected to the cordage box and is configured to supply power to the motor. Thus, a lever arm is shortened when the traction cordage is subjected to a force, so as to reduce a torque borne by the cordage box, which reduces the requirement of the strength of the cordage box and facilitates more stable fixation of the cordage box on the base.

### CROSS-REFERENCE TO RELATED APPLICATIONS

This Application is a National Stage of International Patent Application No. PCT/CN2024/077946, filed on Feb. 21, 2024, which claims the benefit of priority to Chinese Patent Application No. 202310172558.7, filed on Feb. 21, 2023, and Chinese Patent Application No. 202310180437.7, filed on Feb. 21, 2023, and Chinese Patent Application No. 202310203074.4, filed on Feb. 21, 2023, and Chinese Patent Application No. 202310186423.6, filed on Feb. 21, 2023, and Chinese Patent Application No. 202320356894.2, filed on Feb. 21, 2023, and Chinese Patent Application No. 202320346128.8, filed on Feb. 21, 2023, and Chinese Patent Application No. 202320391256.4, filed on Feb. 21, 2023, and Chinese Patent Application No. 202320364243.8, filed on Feb. 21, 2023, and Chinese Patent Application No. 202321879489.5, filed on Jul. 17, 2023, and Chinese Patent Application No. 202322680388.1, filed on Sep. 28, 2023, all of which are incorporated by reference herein.

### TECHNICAL FIELD

The present disclosure relates to the technical field of output devices, and in particular, to an output device and an output assembly.

### BACKGROUND

Cordage-type output devices are a widely used category of output devices. This type of device usually applies resistance or power to a cordage. During use, a user exercises by reciprocally pulling the cordage or being driven by the cordage. Some cordage-type output devices use a reel as a storage device for the cordage. A cordage head of the cordage is generally fixed to an end portion of a side of the reel, and then the cordage can be wound and arranged along an axial direction of the reel, which facilitates retraction and release of the cordage.

The output device needs to bear a large load during use and may be subjected to a large torque, demanding high structural reliability of the output device.

### SUMMARY OF THE INVENTION

The present disclosure provides an output device and an output assembly.

The output device according to an embodiment of the present disclosure includes:

Additional aspects and advantages of the present disclosure will be partly given in the following description, and partly will become apparent from the following description, or will be learned through the practice of the present disclosure.

### BRIEF DESCRIPTION OF THE DRAWINGS

The above and/or additional aspects and advantages of the present disclosure will become apparent and easily understood from the description of the embodiments in conjunction with the accompanying drawings.

FIG. 1 is a perspective structural view of an output device according to some embodiments of the present disclosure.

FIG. 2 is a perspective structural view of a cordage box according to some embodiments of the present disclosure.

FIG. 3 is a perspective structural view of a power supply assembly according to some embodiments of the present disclosure.

FIG. 4 is an exploded view of a partial structure of an output device according to some embodiments of the present disclosure.

FIG. 5 is a perspective structural view of an output device according to some embodiments of the present disclosure.

FIG. 6 is a partial enlarged view of portion A in FIG. 5.

FIG. 7 is a perspective structural view of an output device according to some embodiments of the present disclosure.

FIG. 8 is a partial enlarged view of portion B in FIG. 7.

FIG. 9 is a system block diagram of an output device according to some embodiments of the present disclosure.

FIG. 10 is a schematic diagram of a connection between a connecting structure and a base according to some embodiments of the present disclosure.

FIG. 11 is a schematic diagram of a connection between a connecting structure and a base according to some embodiments of the present disclosure.

FIG. 12 is a system block diagram of an output device according to some embodiments of the present disclosure.

FIG. 13 is a system block diagram of an output device according to some embodiments of the present disclosure.

FIG. 14 is a system block diagram of an output device according to some embodiments of the present disclosure.

FIG. 15 is a system block diagram of an output device according to some embodiments of the present disclosure.

FIG. 16 is a schematic diagram of combination scenarios of an output device in an embodiment.

FIG. 17 is a structural view of a heat dissipation cover according to an embodiment of the present disclosure.

FIG. 18 is a structural view of a locking apparatus according to an embodiment of the present disclosure.

FIG. 19 is an exploded structural view of a connecting structure according to an embodiment of the present disclosure.

FIG. 20 is a partial enlarged view of portion A in FIG. 19.

FIG. 21 is a perspective structural view of a connecting structure according to some embodiments of the present disclosure.

FIG. 22 is a structural view of a connecting structure according to some embodiments of the present disclosure.

FIG. 23 is a sectional view along section B-B in FIG. 22.

FIG. 24 is a sectional view along section C-C in FIG. 22.

FIG. 25 is a schematic diagram of a cooperation between a snap-fitting member and a first limiting groove according to some embodiments of the present disclosure.

FIG. 26 is a perspective structural view of a snap-fitting member according to some embodiments of the present disclosure.

FIG. 27 is a structural view of a base according to some embodiments of the present disclosure.

FIG. 28 is a side view of a base according to some embodiments of the present disclosure.

FIG. 29 is a sectional view along section D-D in FIG. 28.

FIG. 30 is a perspective structural view of a connecting structure according to some embodiments of the present disclosure.

FIG. 31 is a structural view of a connecting structure according to some embodiments of the present disclosure.

FIG. 32 is a sectional view along section E-E in FIG. 31.

FIG. 33 is a side view of a connecting structure according to some embodiments of the present disclosure.

FIG. 34 is a sectional view along section F-F in FIG. 33.

FIG. 35 is a perspective structural view of a limiting protrusion according to some embodiments of the present disclosure.

FIG. 36 is a perspective structural view of a locking member according to some embodiments of the present disclosure.

FIG. 37 is a perspective structural view of a locking member from another angle according to some embodiments of the present disclosure.

FIG. 38 is a perspective structural view of a locking member from another angle according to some embodiments of the present disclosure.

FIG. 39 is a perspective structural view of a locking member from another angle according to some embodiments of the present disclosure.

FIG. 40 is a schematic diagram of an output device according to some embodiments of the present disclosure.

FIG. 41 is a perspective structural view of a winding reel according to some embodiments of the present disclosure.

FIG. 42 is an exploded structural view of a winding reel according to some embodiments of the present disclosure.

FIG. 43 is a sectional structural view of a winding reel according to some embodiments of the present disclosure.

FIG. 44 is a structural view of an inner core and a winding reel housing according to some embodiments of the present disclosure.

FIG. 45 is a structural view of a split inner core according to some embodiments of the present disclosure.

FIG. 46 is a schematic diagram of an output device according to some embodiments of the present disclosure.

FIG. 47 is a perspective structural view of a winding reel according to some embodiments of the present disclosure.

FIG. 48 is an exploded structural view of a winding reel according to some embodiments of the present disclosure.

FIG. 49 is an enlarged view of portion IV of a winding reel in FIG. 48.

FIG. 50 is a perspective structural view of a cordage pressing block according to some embodiments of the present disclosure.

FIG. 51 is an overall structural view of a winding apparatus according to an embodiment of the present disclosure.

FIG. 52 is an exploded view of a winding apparatus according to an embodiment of the present disclosure.

FIG. 53 is an overall structural view of a winding disc according to an embodiment of the present disclosure.

FIG. 54 is a schematic diagram of a cordage wound on a winding disc according to an embodiment of the present disclosure.

FIG. 55 is another overall structural view of a winding disc according to an embodiment of the present disclosure.

FIG. 56 is another schematic diagram of a cordage wound on a winding disc according to an embodiment of the present disclosure.

FIG. 57 is an overall structural view of a protective cover according to an embodiment of the present disclosure.

FIG. 58 is an overall structural view of a winding disc according to another embodiment of the present disclosure.

FIG. 59 is an overall structural view of a winding disc according to another embodiment of the present disclosure.

FIG. 60 is a structural view of a pivoting cordage arranging scheme according to some embodiments of the present disclosure.

FIG. 61 is a schematic diagram of a linkage mechanism of a pivoting cordage arranging scheme according to some embodiments of the present disclosure.

FIG. 62 is a schematic diagram of a pivoting cordage arranging scheme and a guiding mechanism according to some embodiments of the present disclosure.

FIG. 63 is a schematic diagram of a guiding mechanism and a pivot angle detection apparatus in one embodiment of the present disclosure.

FIG. 64 is a schematic diagram of a guiding mechanism and a pivot angle detection apparatus in another embodiment of the present disclosure.

FIG. 65 is a structural view of a sliding cordage arranging scheme according to some embodiments of the present disclosure.

FIG. 66 is an internal structural view of a sliding cordage arranging scheme according to some embodiments of the present disclosure.

FIG. 67 is a schematic diagram of a cordage guiding mechanism of the sliding cordage arranging scheme according to some embodiments of the present disclosure.

FIG. 68 is a schematic diagram of a cordage arranging mechanism driven by a power mechanism according to some embodiments of the present disclosure.

FIG. 69 is a schematic diagram of a cordage arranging mechanism driven by a linkage mechanism according to some embodiments of the present disclosure.

FIG. 70 is a schematic diagram of an output device with a universal cordage outlet mechanism according to an embodiment of the present disclosure.

FIG. 71 is a schematic diagram of a universal cordage outlet mechanism according to an embodiment of the present disclosure, and a direction of a double arrow in the figure is a first direction.

FIG. 72 is a perspective view of a universal cordage outlet mechanism according to an embodiment of the present disclosure.

FIG. 73 is an exploded view of a universal cordage outlet mechanism according to an embodiment of the present disclosure.

FIG. 74 is a schematic diagram of a universal cordage outlet mechanism according to another embodiment of the present disclosure, and a direction of a double arrow in the figure is a first direction.

FIG. 75 is a perspective view of a universal cordage outlet mechanism according to another embodiment of the present disclosure.

FIG. 76 is an exploded view of a universal cordage outlet mechanism according to another embodiment of the present disclosure.

FIG. 77 is a schematic diagram of a cordage outlet seat covering a cordage outlet wheel according to an embodiment of the present disclosure.

FIG. 78 is a schematic diagram of a rotating seat and a cordage outlet seat according to an embodiment of the present disclosure.

FIG. 79 is a schematic diagram of a cordage outlet seat according to an embodiment of the present disclosure.

FIG. 80 is a structural view of a resistor structure according to some embodiments of the present disclosure.

FIG. 81 is an exploded view of a resistor structure according to some embodiments of the present disclosure.

FIG. 82 is a structural view of a first plate body according to some embodiments of the present disclosure.

FIG. 83 is a structural view of a resistor plate according to some embodiments of the present disclosure.

FIG. 84 is a structural view of a second plate body.

FIG. 85 is an exploded view of a battery according to some embodiments of the present disclosure.

FIG. 86 is a schematic diagram of an external structure of a second housing according to some embodiments of the present disclosure.

FIG. 87 is a schematic diagram of an internal structure of a second housing according to some embodiments of the present disclosure.

FIG. 88 is a schematic diagram of an external structure of a first housing according to some embodiments of the present disclosure.

FIG. 89 is a schematic diagram of an internal structure of a first housing according to some embodiments of the present disclosure.

FIG. 90 is a structural view of a battery cell according to some embodiments of the present disclosure.

FIG. 91 is an exploded view of a connection structure between a supporting rod and a first housing according to some embodiments of the present disclosure.

FIG. 92 is an exploded view of a connection structure between a supporting rod and a second housing according to some embodiments of the present disclosure.

FIG. 93 is a structural view of a key mounting position according to some embodiments of the present disclosure.

FIG. 94 is a structural view of a connecting busbar according to some embodiments of the present disclosure.

FIG. 95 is a structural view of another connecting busbar according to some embodiments of the present disclosure.

FIG. 96 is a structural view of a first connecting member according to some embodiments of the present disclosure.

FIG. 97 is a structural view of another first connecting member according to some embodiments of the present disclosure.

FIG. 98 is a structural view of a second connecting member according to some embodiments of the present disclosure.

FIG. 99 is a structural view of a connection structure between a connecting member and a coil according to some embodiments of the present disclosure.

FIG. 100 is an exploded view of a motor according to some embodiments of the present disclosure.

FIG. 101 is a structural view of a stator core according to some embodiments of the present disclosure.

FIG. 102 is a structural view of a structure in which a magnetic ring is mounted on a rotor shaft according to some embodiments of the present disclosure.

FIG. 103 is a structural view of a magnetic ring according to some embodiments of the present disclosure.

FIG. 104 is a schematic diagram of a cross-sectional structure of a rear-assembled magnetic ring according to some embodiments of the present disclosure.

### LIST OF REFERENCE SIGNS

cordage box 100, cordage box outlet 110, third limiting structure 111, micro switch 112,
universal cordage outlet mechanism 120, base 121, first channel 1211, rotating seat 122, second channel 1221, cordage outlet wheel 123, outlet wheel cordage groove 1231, cordage outlet seat 124, cordage outlet hole 1241, cordage guiding block 1242, cordage outlet groove 1243,
winding reel 130, inner core 131, fixing portion 1311, first winding groove 1312, nesting portion 1321, first limiting structure 1322, first connecting rib 1323, second limiting groove 1324,
winding heat dissipation channel 133, heat dissipation hole 1331, heat dissipation groove 1332, flange 134,
winding reel housing 135, second limiting structure 1351, second limiting protrusion 1352, second winding groove 1353,
reel body 136, fixing position 1361, second mounting position 1362, screw hole 1363, pressing block positioning groove 1364, first connecting surface 1365, first side surface 1366, first mounting position 1367,
cordage pressing block 137, cordage pressing block through hole 1371, pressing block positioning protrusion 1372, pressing block cordage groove 1373, cordage pressing protrusion 1373a, arc-shaped notch 1373b, second connecting surface 1374, second side surface 1375, winding surface 1376,
winding disc 138, winding position 1381, threading hole 1381a, convex plate 1381b, through hole 1381c, notch 1381d, cordage channel 1381e, base plate 1381f, third side surface 1382, fourth side surface 1383, protective cover 139, protective cover outlet 139a, first protruding portion 139b,
cordage arranging mechanism 140, pivoting seat 1411, cordage guiding arm 1412, pivoting angle detection apparatus 1413, magnetic ring 1414, magnetic member 1415, pivoting Hall sensor 1416, sliding seat 1421, smooth shaft 1422, linear bearing 1423, cordage guiding mechanism 1424, cordage arranging port 1425, rotating seat 1426, direction-changing port 1427, first direction-changing wheel 1428, second direction-changing wheel 1429, guiding mechanism 143, cordage guiding wheel 1431, limiting frame 1432, cordage guiding wheels 1433, linkage mechanism 144, self-locking worm wheel 1441, self-locking worm gear nut 1442, worm 1443, power mechanism 145,
connecting structure 200, snap-fitting member 210, first guiding slope 211, snap-fitting surface 212, third guiding slope 213, force-applying member 220, first stopping protrusion 230, guiding protrusion 240, seventh guiding slope 241, limiting step 242, elastic member 243, guiding groove 244, second top block 250,
locking member 300, limiting protrusion 310, clearance slot 320, fourth guiding slope 330, first top block 340, sixth guiding slope 341, toggle handle 350, first driving motor 360,
base 400, first limiting groove 410, second guiding slope 420, fifth guiding slope 430,
motor 500, motor housing 510, first unlocking trigger apparatus 511, motor key mounting position 512, second functional key 5121,
connecting busbar 520, mounting seat 521, insertion slot 5211, annular groove 5212, third protruding portion 5213, first connecting member 522, first connecting end 5221, plug-in portion 5222, first connecting portion 5223, second connecting member 523, second connecting end 5231, second connecting portion 5232, positioning portion 5233, connecting cover plate 524, insulating pad 525,
stator assembly 530, stator core 531, winding frame 532,
rotor assembly 540, rotor core 541, rotor shaft 542, keyway 5421, groove 5422, coil 550, active fan 562, magnetic ring 570, housing 571, magnetic ring snap 572, spline 573, magnetic component 574, series motor set 580, sub-motor 581,
power supply assembly 600,
battery 610, display screen 611, second quick-connect connector 6111, battery housing 612, first housing 6121, battery snap protrusion 6121a, fixing groove 6121b, second housing 6122, key mounting position 6123, first functional key 6124, second FPC flexible cable 6124a, second unlocking trigger apparatus 6125, fifth quick-connect connector 6125a, battery positioning protrusion 613, fixing rib 614, battery protruding portion 615, battery cell 616, cylindrical battery 6161, supporting rod 6162, central hole 6162a, battery snap structure 6162b, second connecting rib 6163, positioning groove 6163a, first FPC flexible cable 6164, elastic heat-conducting pad 6171, heat sink 6172, first quick-connect connector 618, first quick-connect sub-connector 6181, second quick-connect sub-connector 6182, battery holder 619,
heat dissipation cover 710, structural plate 711, heat dissipation plate 712,
resistor structure 720, first plate body 721, first heat-conducting component 722, resistor plate 723, second plate body 724, second heat-conducting component 725, resistor plate protruding edge 726, sixth quick-connect connector 727, avoidance hole 728, second temperature sensor 729, plate body through hole 7210,
heat dissipation fan 730, PCB board 740, third quick-connect connector 750, fourth quick-connect connector 760,
locking apparatus 810, locking arm 811, locking motor 812, locked shaft 813, mechanical self-locking transmission mechanism 814,
cordage 900.

### DETAILED DESCRIPTION

Embodiments of the present disclosure are described in detail below, and examples of the embodiments are shown in accompanying drawings, and the same or similar reference numerals represent the same or similar elements or elements having the same or similar functions. The embodiments described below with reference to the accompanying drawings are illustrative and are intended to explain the present disclosure and should not be construed as limiting the present disclosure.

In the description of the present disclosure, it should be understood that terms such as “center”, “longitudinal”, “transverse/lateral”, “length”, “width”, “thickness”, “up”, “down”, “front”, “back”, “left”, “right”, “vertical”, “horizontal”, “top”, “bottom”, “inner”, “outer”, “clockwise”, “counterclockwise”, etc., indicate orientations or positional relationships based on orientations or positional relationships shown in the accompanying drawings. These terms are used only for the convenience of describing the present disclosure and simplifying the description, and are not intended to indicate or imply that an apparatus or an element must have a specific orientation, be constructed and operated in a specific orientation, and therefore should not be construed as limiting the present disclosure. Additionally, terms such as “first” and “second” are used for descriptive purposes only and should not be construed as indicating or implying relative importance or implicitly indicating the number of technical features. Thus, features defined by “first” and “second” may explicitly or implicitly include one or more of the features. In the description of the present disclosure, the term “plurality of” means two or more, unless otherwise clearly and specifically defined.

In the description of the present disclosure, it should be noted that unless otherwise defined explicitly and specifically, terms such as “mount”, “connect”, “connection” should be understood broadly. For example, “connection” may be a fixed connection, a detachable connection, or an integral connection; or may be a mechanical connection, an electrical connection, or mutual communication; or may be a direct connection or an indirect connection through an intermediate media, or may be an internal connection of two elements or an interaction relationship between two elements. For those having ordinary skill in the art, specific meanings of the foregoing terms in the present disclosure may be understood according to specific situations.

In the present disclosure, unless otherwise defined explicitly and specifically, a first feature being “above” or “below” a second feature may include the first feature and the second feature being in direct contact, or may include the first and second features not being in direct contact but being in contact by using an additional feature between them. Moreover, a first feature being “above”, “upward”, and “on” a second feature may include the first feature being directly above and obliquely above the second feature, or only indicate that the first feature has a higher horizontal height than the second feature. A first feature being “below”, “beneath” and “underneath” the second feature includes the first feature being directly below and obliquely below the second feature, or only indicate that the first feature has a smaller horizontal height than the second feature.

The following disclosure provides many different embodiments or examples to implement different structures of the present disclosure. To simplify the disclosure of the present disclosure, components and arrangements of specific embodiments are described below. Of course, these are only examples and are not intended to limit the present disclosure. Additionally, the present disclosure may repeat reference numerals and/or reference letters in different embodiments for the purpose of simplicity and clarity, which does not indicate a relationship between the various embodiments and/or arrangements discussed. Furthermore, the present disclosure provides embodiments of various specific processes and material, but those having ordinary skill in the art may be aware of the application of other processes and/or the use of other materials.

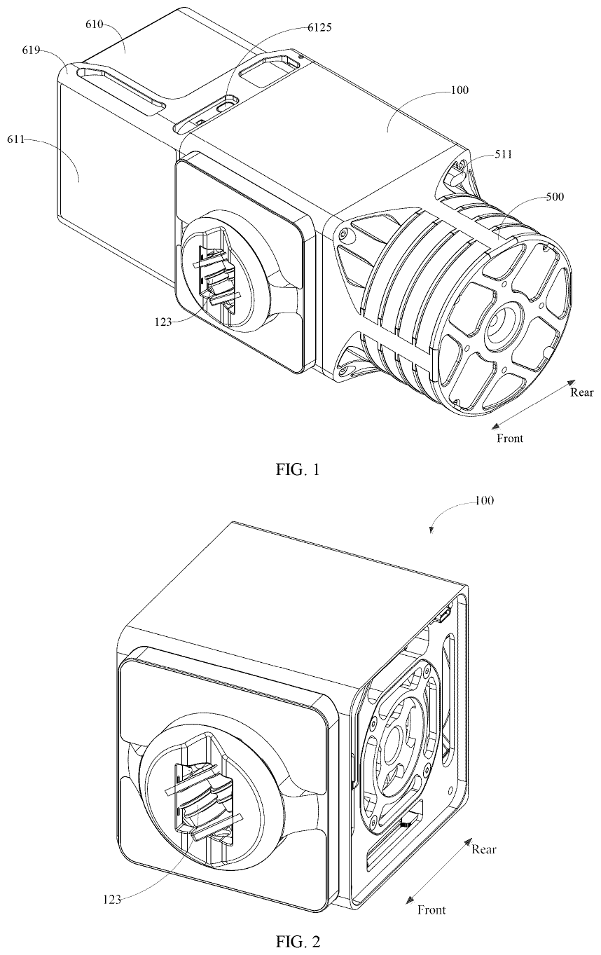

Referring to FIGS. 1-7, the output device in an embodiment of the present disclosure includes: a cordage box 100, a rear side of the cordage box 100 being provided with a connecting structure 200, the connecting structure 200 being configured to be fixedly connected to a base 400, and a cordage 900 from the cordage box 100 being led out from a front side of the cordage box 100; a motor 500, which is fixedly connected to the cordage box 100 and is configured to provide a traction force for the cordage 900; and a power supply assembly 600, which is fixedly connected to the cordage box 100 and is configured to supply power to the motor 500.

In an embodiment of the present disclosure, the rear side of the cordage box 100 is fixedly connected to the base 400 via the connecting structure 200 on the rear side, and the cordage 900 is led out from the front side of the cordage box 100. Thus, a lever arm may be shortened when the cordage 900 is subjected to a force, so as to reduce a torque borne by the cordage box 100, which not only reduces the requirement of the strength of the cordage box 100, but also facilitates more stable fixation of the cordage box 100 on the base 400.

In some embodiments, the motor 500 may be fixed to the cordage box 100 by a bolt. For example, a reel (not shown in the figure) connected to an output shaft of the motor 500 may be arranged in the cordage box 100, the cordage 900 is wound around the reel and may be led out of the cordage box 100 via a cordage outlet wheel 123 on the front side of the cordage box 100. The torque of the motor 500 may be transmitted to the reel to achieve a traction function.

In some embodiments, the fixed connection between the motor 500 and the cordage box 100 includes a detachable connection and a quick-release connection. The fixed connection between the power supply assembly 600 and the cordage box 100 includes a detachable connection and a quick-release connection. In some embodiments, the motor 500 includes a series motor set 580, and the series motor set 580 includes a plurality of sub-motors 581 with power shafts connected end to end. With the detachable connection of the motor 500 and the series motor set 580, a user may reasonably series-connect a suitable number of sub-motors 581 according to user needs. The end-to-end connection of the power shafts of adjacent sub-motors 581 may be both ends of the power shaft penetrate through the sub-motor 581 and are connected to adjacent motors 500; may be connected via a coupling or via a spline, for example, via a spline sleeve, or one end may be configured with a spline hole while an opposite end is configured with a spline. At the same time, power supplies of the sub-motors 581 in the series motor set 580 will be connected in parallel.

In some embodiments, the power supply assembly 600 is fixedly connected to the cordage box 100 via the motor 500, and the motor 500 is located between the cordage box 100 and the power supply assembly 600. In some embodiments, the motor 500 may also be located between the cordage box 100 and the power supply assembly 600, the motor 500 provides a driving force for the cordage box 100, and the power supply assembly 600 supplies power to both the motor 500 and the cordage box 100. This layout allows a product to achieve more diverse configurations, meeting user needs. In some embodiments, the power supply assembly 600 includes one or more of a battery 610, a power adapter, a connector, and a wiring rack.

When the power supply assembly 600 is a power adapter or a connector, the user may directly connect the output device to power for use, which is suitable for more application scenarios. In some embodiments, the power supply assembly 600 may also be used in combination with a battery 610, that is, the user may connect the output device to power for use, and retain the battery 610, which can meet power supply needs when power is off or when the output device is carried out, or in other situations where electricity connection is unavailable. In some embodiments, the power supply assembly 600 may also be a wiring-enabled rack, such as a power-connectable gantry. At this time, the cordage box 100 and the motor 500 may be directly assembled on the gantry and connected to power, which is suitable for more application scenarios.

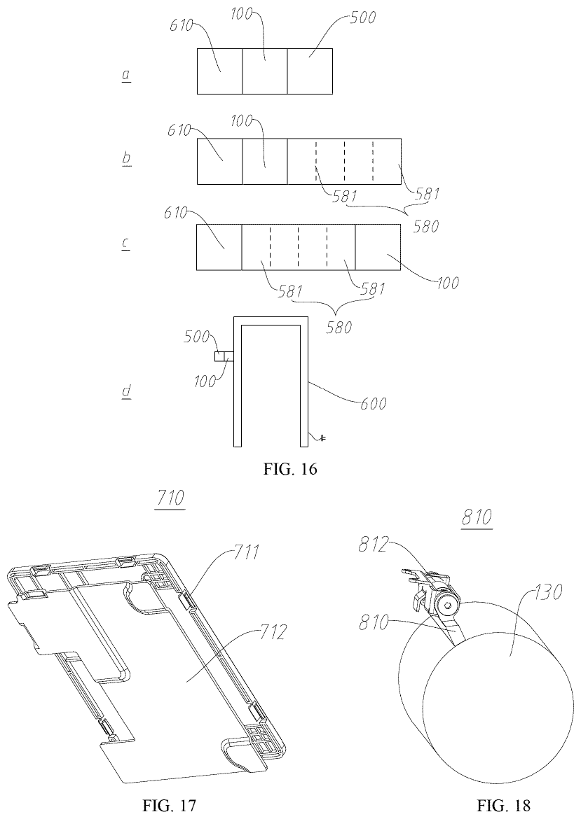

In some embodiments, as shown in FIG. 16, several possible combination scenarios are shown. FIG. 16a shows that a battery 610 and a motor 500 are located on both sides of the cordage box 100. FIG. 16b shows that a motor 500 is configured as a series motor set 580 with four sub-motors 581 connected in series. FIG. 16c shows that the series motor set 580 is located in the middle, with a battery 610 and a cordage box 100 on both sides respectively. FIG. 16d shows that a power supply assembly 600 uses a wiring-enabled gantry, and the cordage box 100 and the motor 500 are connected sequentially to the power supply assembly 600. At this time, the connecting structure 200 of the cordage box 100 does not need to be fixed separately; the gantry of the power supply assembly 600 may be configured to fix the output device.

In some embodiments, the motor 500 and the cordage box 100 are in communication with each other and form a heat dissipation channel; and/or, the cordage box 100 and the power supply assembly 600 are in communication with each other and form a heat dissipation channel; and/or, the motor 500 and the power supply assembly 600 are in communication with each other and form a heat dissipation channel.

In some embodiments, a heat dissipation channel actively dissipates heat through a heat dissipation fan 730, and the heat dissipation fan 730 is located in the heat dissipation channel.

After the motor 500, the cordage box 100, and the power supply assembly 600 are assembled, there is a heat dissipation channel such that the cordage box 100, and the power supply assembly 600 are in communication with each other, allowing for ventilation and heat dissipation to ensure continuous operation of the output device. For example, a channel in communication with interior of a housing of the motor 500 may be left at a contact surface between the motor 500 and the cordage box 100, and a channel in communication with the interior of the cordage box 100 may be left at a contact surface between the cordage box 100 and the motor 500. When the motor 500 and the cordage box 100 are connected, these two channels will also be in communication with each other to form a heat dissipation channel, and ventilation and heat dissipation will be performed simultaneously. In some embodiments, a heat dissipation fan 730 may also be provided to actively dissipate heat in the heat dissipation channel. The heat dissipation fan 730 may be specifically located on the cordage box 100, the motor 500, or the power supply assembly 600 and located in the heat dissipation channel.

In some embodiments, a heat dissipation cover 710 is provided on a housing 571 of the output device. A structural plate 711 can provide structural support for the heat dissipation cover 710, and the structural plate 711 has higher strength than the heat dissipation plate 712. The structural plate 711 has good thermal conductivity, and can absorb heat inside the housing 571 and transfer the heat outside the housing 571. In some embodiments, at least one heat dissipation hole 1331 is further provided on the structural plate 711 to conduct heat from the heat dissipation plate 712 to the outside. The heat dissipation plate 712 is located inside the structural plate 711. The heat dissipation plate 712 is detachably connected to the structural plate 711, to facilitate assembly and replacement. In some embodiments, the heat dissipation plate 712 is partially recessed inwardly to contact a heat-generating element in the housing 571, so as to better transfer heat to the outside. Preferably, the structural plate 711 is provided with a support portion inwardly at a position corresponding to an inward recess of heat dissipation plate 712 to provide support, ensuring close contact between the heat dissipation plate 712 and the heat-generating element while also transferring heat to the structural plate 711. For example, as shown in FIG. 17, the heat dissipation plate 712 and the structural plate 711 are connected by a snap-fit, and the heat dissipation plate 712 is provided with at least one inward recess according to a position of the heat-generating element in the housing 571, and the structural plate 711 is provided with the support portion at the corresponding position.

In some embodiments, a locking apparatus 810 is also provided. The locking apparatus 810 includes a movable locking arm 811. The locking arm 811 includes a first state in which the locking arm 811 contacts and presses against a locked shaft when power is off and a second state in which the locking arm 811 is away from the locked shaft when power is on. The locked shaft may be any winding reel 130 or cordage guiding wheel through which the cordage 900 passes, or a drive shaft or a motor shaft where the winding reel 130 is located, or any transmission shaft of a transmission mechanism between the winding reel 130 and the motor 500. Preferably, when power is off, the locking arm 811 locks the locked shaft via an elastic member, a magnetic member, or a mechanical self-locking transmission mechanism 814, or contacts and presses against the locked shaft through friction self-locking; and/or, when power is on, the locking arm 811 may is away from the locked shaft through a magnetic force of a locking electromagnet or a locking motor 812.

The output device is also provided with a locking apparatus 810, which is configured to lock any winding reel 130 or cordage-guiding wheel through which the cordage 900 passes, or a drive shaft or a motor shaft where the winding reel 130 is located, or any transmission shaft of a transmission mechanism between the winding reel 130 and the motor 500 when the device loses power, so as to prevent the cordage 900 suspending a load from causing the winding reel 130 to rotate and causing the load to fall to ground. At this time, the locking arm 811 is in the first state. The locking arm 811 of the locking apparatus 810 may be rotatably or slidably mounted. When the locking arm 811 is in the second state, the locking arm 811 rotates or slides away from the locked shaft to stop locking, to allow the output device to operate normally. Preferably, an elastic member or a groove configured to increase friction is provided on a contact surface between the locking arm 811 and the locked shaft.

Preferably, in the first state, a locking force exerted on the locking arm 811 is provided by an elastic force or a magnetic force or a mechanical self-locking transmission mechanism 814. For example, the elastic force can be exerted by the elastic member, or the magnetic force can be exerted by the magnetic member. The mechanical self-locking transmission mechanism 814, such as a self-locking worm gear, can also be provided, so that the locking arm 811 can be driven by the transmission mechanism to rotate and press against or leave the locked shaft, and cannot be driven by the locked shaft.

Preferably, in the first state, before power loss, the locking motor 812 or the locking electromagnet drives the locking arm 811 to contact the locked shaft. At this time, a force exerted by the locking arm 811 on the transmission shaft is within a friction angle between the locking arm 811 and the transmission shaft or winding reel 130, that is, the locking arm 811 can form a frictional self-locking with the transmission shaft or winding reel 130. At this time, self-locking can be achieved without setting an additional external force, that is, after power loss, the locking motor 812 or the electromagnet loses power and continues to lock the locked shaft.

In some embodiments, in the second state, the locking arm 811 is driven by the locking motor 812 or the electromagnet to rotate or slide away from the locked transmission shaft.

For example, as shown in FIG. 18, before power loss, the locking motor 812 drives the locking arm 811 to rotate into contact with the winding reel 130. After power loss, the locking motor 812 loses power, and the load drives the winding reel 130 via the cordage 900. The rotation of the winding reel 130 further increases contact effect of the locking arm 811, thereby locking the winding reel 130. After the locking motor 812 is started, the locking motor 812 drives the locking arm 811 to rotate away from the winding reel 130, so as to release the lock.

For example, as shown in FIG. 105, before power loss, the locking motor 812 drives the locking arm 811 to rotate and press against the motor shaft (the locked shaft) via a mechanical self-locking transmission mechanism 814. After power loss, since the mechanical self-locking transmission mechanism 814 is a self-locking nut-and-screw transmission, and a nut connected to the locking arm 811 cannot drive a screw to rotate, thereby maintaining a locking state. When power is supplied, the locking motor 812 drives the locking arm away from the motor shaft (the locked shaft 813) via the mechanical self-locking transmission mechanism 814. Two locking arms 811 are provided to lock the motor shaft (locked shaft) from two directions respectively.

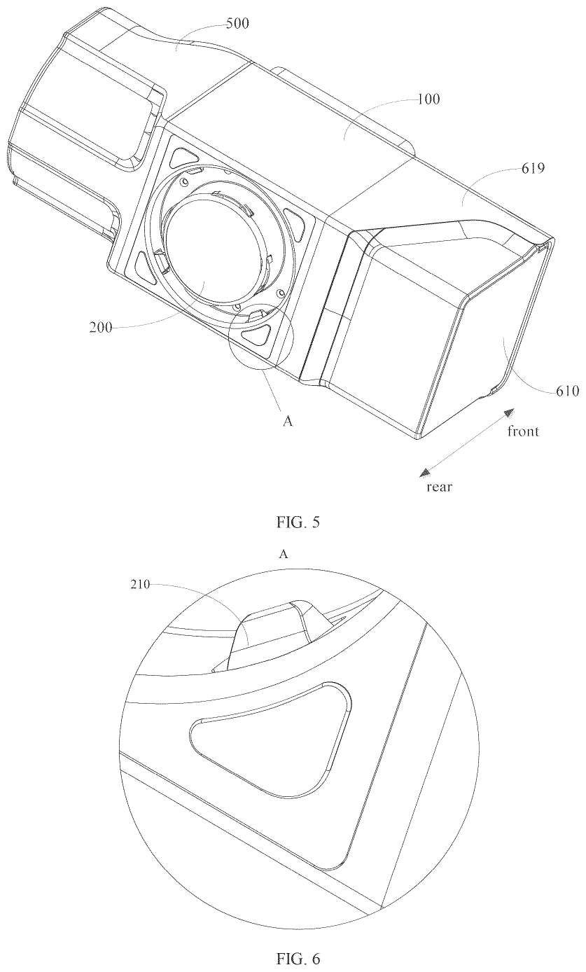

In some embodiments, referring to FIG. 1, FIG. 5, and FIG. 7, the motor 500 and the power supply assembly 600 are arranged on two opposite side surfaces of the cordage box 100.

In an embodiment, a weight of the motor 500 and the power supply assembly 600 (for example, the power supply assembly 600 may include a battery 610, etc.) is relatively large. By arranging the motor 500 and the power supply assembly 600 on the opposite sides of the cordage box 100, the weight can be balanced, and a center of the output device is roughly located in the middle, which facilitates the user to hold the output device stably.

It should also be noted that when the user is accustomed to holding the output device with both hands, design of the embodiment can facilitate the user to hold the motor 500 and the power supply assembly 600 with both hands respectively, so that the user's hands bear weight evenly, which also improves the stability of holding the output device and reduces the possibility of the user accidentally dropping the output device when holding the output device.

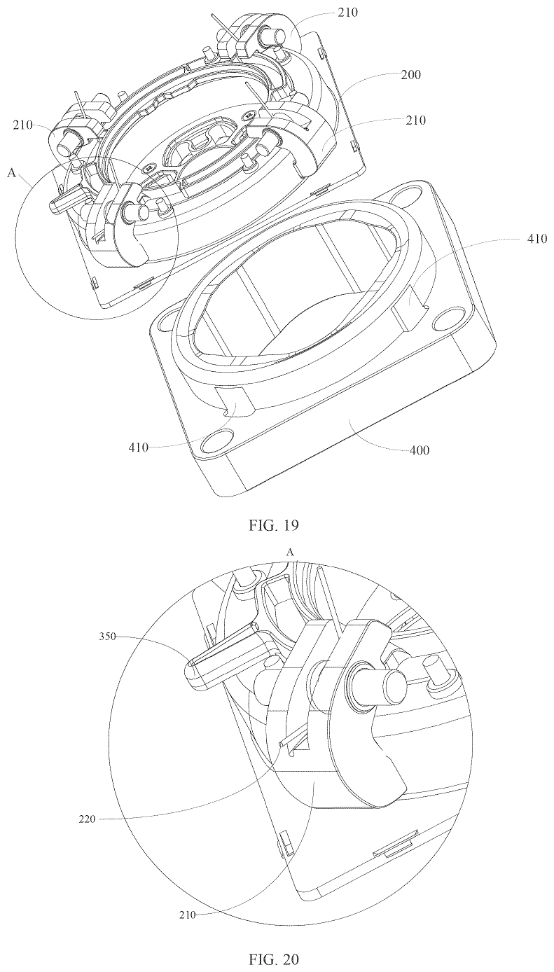

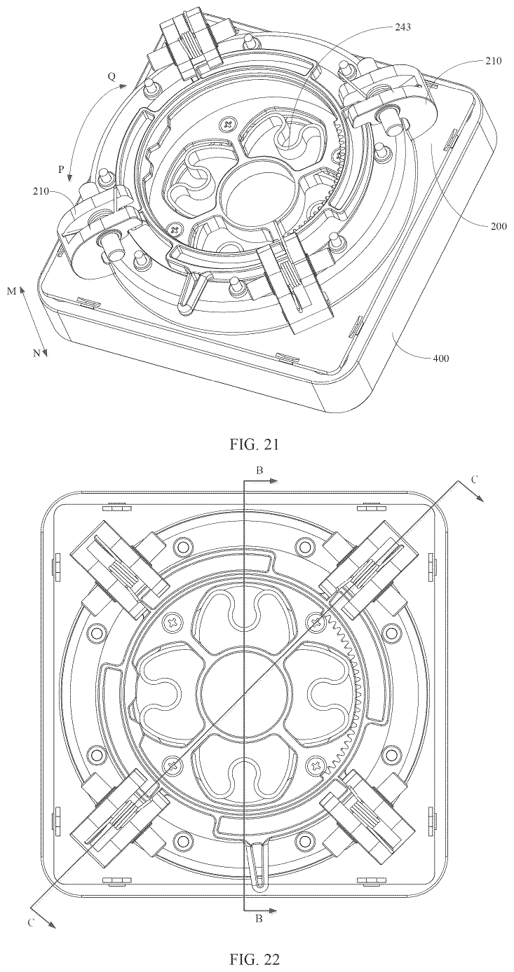

In some embodiments, referring to FIGS. 19-24, the base 400 may be provided with a first limiting portion, and the connecting structure 200 may be provided with a second limiting portion. The base 400 may be coupled to the connecting structure 200 in a first direction (for example, the first direction can be a MN direction in FIG. 21), and the first limiting portion and the second limiting portion may be locked along the first direction to lock the base 400 and the connecting structure 200. When it is necessary to unlock the base 400 and the connecting structure 200, the connecting structure 200 can move relative to the base 400 along a second direction to unlock the first limiting portion and the second limiting portion. In this way, the base 400 can be decoupled from the connecting structure 200 in the first direction, thereby enabling quick disassembly of the base 400 and the connecting structure 200.

Through the embodiment, when the base 400 and the connecting structure 200 need to be unlocked, unlocking can be achieved by making the base 400 and the connecting structure 200 move relative to each other. The unlocking operation is convenient, the disassembly efficiency is high, facilitating quick disassembly of the base 400 and the connecting structure 200.

Specifically, in some embodiments, the base 400 may be fixed to a fixed surface, such as a wall or a surface of another device. The connecting structure 200 may be fixedly connected to a device to be fixed, such as an output device, etc. For example, the connecting structure 200 may be fixed to a fixed device via a fixing member such as a bolt, or a screw, etc.

In an embodiment, the base 400 is coupled to the connecting structure 200 in the first direction and the first limiting portion is locked with the second limiting portion in the first direction, so that the device to be fixed can be fixed to a fixing surface.

In an embodiment, when the device to be fixed needs to be removed, the connecting structure 200 is configured as a movable structure, so that the connecting structure 200 can be moved relative to the base 400 along the second direction, thereby enabling the first limiting portion and the second limiting portion to disengage from each other in the first direction. Thus, the device to be fixed can be removed along the first direction.

Alternatively, in some other embodiments, the difference from the above embodiments is that the connecting structure 200 can be fixed to a fixed surface, and a first device can be fixedly connected to the device to be fixed. In this way, beneficial effect of quick connection and quick separation of the base 400 and the connecting structure 200 can be achieved, and the details are not be described in detail here.

In some embodiments, the connecting structure 200 is provided with at least two electrical contacts located at different positions, and the electrical contacts are connected to a short circuit detection apparatus. Preferably, there are four electrical contacts, which are respectively located at the four corners of the connecting structure 200.

When the connecting structure 200 is in correct contact with the base 400, a short circuit will be formed between the electrical contacts, thereby triggering a short-circuit detection apparatus. When the connecting structure 200 is in poor contact with the base 400, the electrical contacts will not form a short circuit, and the short-circuit detection apparatus cannot detect a short-circuit signal. This indicates poor contact and a signal is sent to a controller, which can further trigger an alarm. There are at least two electrical contacts located at different positions, and the electrical contacts can also be arranged in pairs at each location. For example, four electrical contacts can be arranged and respectively arranged at four corners of the connecting structure 200. When the four electrical contacts at the four corners are all electrically short-circuited with other batteries 610 and send a short-circuit signal, it indicates good contact at this time. When at least one electrical contact cannot send a short-circuit signal, it indicates poor contact at this time. For example, the electrical contacts can also be arranged in four pairs at the four corners of the connecting structure 200.

The following describes possible movement modes when the base 400 and the connecting structure 200 are unlocked.

In some embodiments, as shown in FIG. 21, when unlocking, the connecting structure 200 may be rotated relative to the base 400 (for example, may rotate along a PQ direction in FIG. 21). For example, when unlocking is required, the connecting structure 200 can be rotated relative to the base 400, and during the rotation, the first limiting portion and the second limiting portion are unlocked in the first direction, thereby achieving unlocking between the base 400 and the connecting structure 200 in the first direction, so as to facilitate separation of the base 400 and the connecting structure 200 and achieve disassembly.

More specifically, for example, the base 400 can be plugged into the connecting structure 200 in the first direction, for example, the base 400 can be at least partially embedded in the connecting structure 200 along the first direction, and the locking between the base 400 and the connecting structure 200 is achieved by the snap-fit connection between the base 400 and the connecting structure 200. Alternatively, the connecting structure 200 may be at least partially embedded into the base 400 along the first direction, and the locking between the base 400 and the connecting structure 200 is achieved by the snap-fit connection between the base 400 and the connecting structure 200.

In some other embodiments, when unlocking, the connecting structure 200 can slide relative to the base 400. For example, when unlocking is required, the connecting structure 200 can slide relative to the base 400, and during the sliding process, the first limiting portion and the second limiting portion are unlocked in the first direction, so as to facilitate separation of the base 400 and the connecting structure 200 and achieve disassembly.

The above is an exemplary illustration of movement modes when the base 400 and the connecting structure 200 are unlocked, and the present disclosure is not limited thereto.

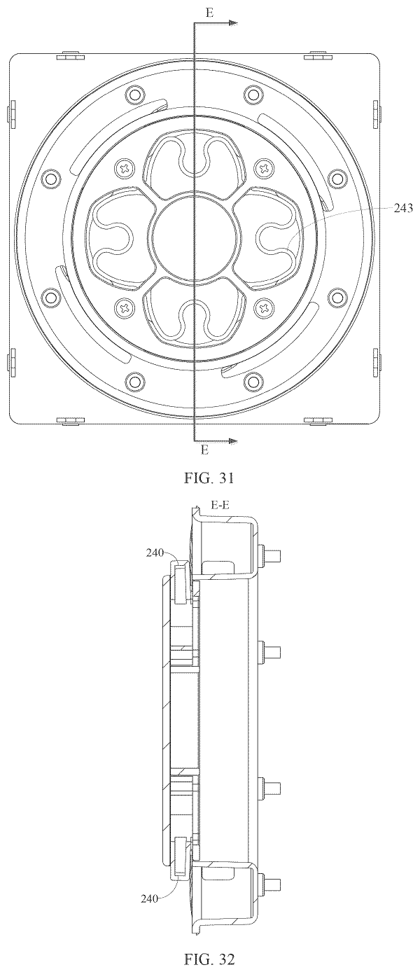

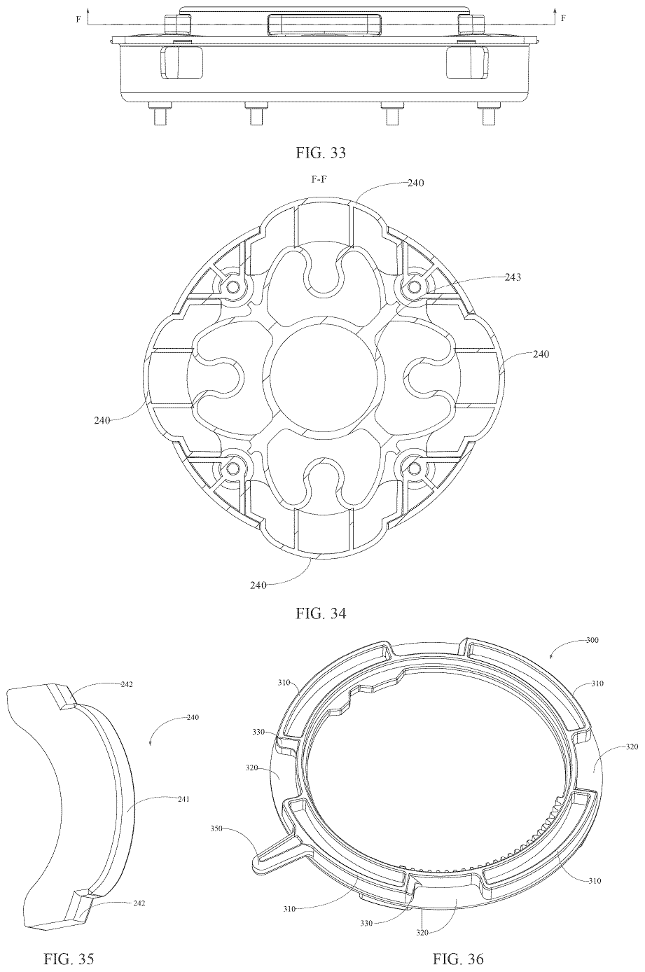

In some embodiments, referring to FIGS. 24-39, the first limiting portion may include a first limiting groove 410, and the second limiting portion may include a snap-fitting member 210 movably disposed on the connecting structure 200. The snap-fitting member 210 is snapped into the first limiting groove 410 to lock the base 400 and the connecting structure 200 in the first direction. In the embodiment, the snap-fitting member 210 snap-fits into the first limiting groove 410 and is in snap-fit engagement with the first limiting groove 410 in the first direction, so that the base 400 and the connecting structure 200 are locked in the first direction.

The following is an exemplary illustration of possible movement modes of the snap-fitting member 210 on the connecting structure 200.

In some embodiments, the snap-fitting member 210 may be rotatably disposed on the connecting structure 200. Referring to FIG. 22, and FIGS. 24-26, a rotating shaft may be provided on the connecting structure 200, and the rotating shaft passes through the snap-fitting member 210. The snap-fitting member 210 can rotate around the rotating shaft to achieve rotational arrangement of snap-fitting member 210 on the connecting structure 200.

In other embodiments, the snap-fitting member 210 may be slidably disposed on the connecting structure 200. For example, a sliding groove may be provided on the connecting structure 200, and the snap-fitting member 210 may cooperate with the sliding groove to achieve sliding arrangement of the snap-fitting member 210 on the connecting structure 200.

The above is an exemplary illustration of movement modes of the snap-fitting member 210 on the connecting structure 200. It is understood that the snap-fitting member 210 may also be other movement forms on the connecting structure 200, such as pivoting via a connecting rod, etc., and the present disclosure is not limited thereto.

In some embodiments, referring to FIGS. 20-24, the connecting structure 200 is further provided with a force-applying member 220 connected to the snap-fitting member 210. The force-applying member 220 is configured to move the snap-fitting member 210 toward the first limiting groove 410 to maintain the snap-fit connection with the first limiting groove 410.

In an embodiment, the force-applying member 220 can enable snap-fitting member 210 to maintain a tendency to move into the first limiting groove 410, thereby enabling the snap-fitting member 210 to maintain the snap-fit connection with the first limiting groove 410, so as to improve the stability of the snap-fit connection between the snap-fitting member 210 and the first limiting groove 410, and further improve the stability of the base 400 and the connecting structure 200 being locked in the first direction.

For example, when the snap-fitting member 210 is rotatably disposed on the connecting structure 200, the force-applying member 220 may be a torsion spring. The torsion spring may be sleeved outside a rotating shaft of the snap-fitting member 210. Both ends of the torsion spring abut against the snap-fitting member 210 and the connecting structure 200 respectively. The torsion spring enables the snap-fitting member 210 to maintain a rotational tendency to rotate into the first limiting groove 410 and snap-fit into the first limiting groove 410, thereby maintaining the snap-fit connection between the snap-fitting member 210 and the first limiting groove 410.

For another example, when the snap-fitting member 210 is slidably disposed on the connecting structure 200, the force-applying member 220 may be a compression spring. Both ends of the compression spring abut against the snap-fitting member 210 and the connecting structure 200 respectively. The spring enables the snap-fitting member 210 to maintain a tendency to extend toward a side of the first limiting groove 410, thereby maintaining the snap-fit connection between the snap-fitting member 210 and the first limiting groove 410.

For another example, the force-applying member 220 may also be a first permanent magnet. A second permanent magnet cooperating with the first permanent magnet may be provided on the connecting structure 200 or the base 400. The first permanent magnet, for example, may be fixed on the snap-fitting member 210. Through the interaction (such as attraction or repulsion) between the first permanent magnet and the second permanent magnet, the snap-fitting member 210 is maintained with a tendency to move into the first limiting groove 410.

In some embodiments, referring to FIG. 26, a first guiding slope 211 is formed on an outer sidewall of the snap-fitting member 210. The height of the first guiding slope 211 in the second direction gradually changes. When the connecting structure 200 moves relative to the base 400 along the second direction, the first guiding slope 211 can abut against the first limiting groove 410, and guide the snap-fitting member 210 to disengage from the first limiting groove 410.

Referring to FIG. 26, the height of the first guiding slope 211 in the second direction gradually changes. For example, from a distal end of the snap-fitting member 210 away from the connecting structure 200 to a proximal end of the snap-fitting member 210 connected to the connecting structure 200, the height of the first guiding slope 211 in the second direction gradually increases. In other words, from the distal end of the snap-fitting member 210 to the proximal end of the snap-fitting member 210, the first guiding slope 211 gradually extends toward an outside of the snap-fitting member 210 in the second direction. Thus, when the connecting structure 200 moves relative to the base 400 in the second direction, a side of the first guiding slope 211 close to the proximal end of the snap-fitting member 210 first abuts against a sidewall of the first limiting groove 410. Under guidance of the first guiding slope 211, the snap-fitting member 210 gradually moves out of the first limiting groove 410, and a contact position where the first guiding slope 211 contacts the first limiting groove 410 also gradually moves toward the distal end of the snap-fitting member 210 until the distal end of the snap-fitting member 210 disengages from the first limiting groove 410, and the snap-fitting member 210 and the first limiting groove 410 are unlocked in the first direction.

Further, in some embodiments, referring to FIG. 26, the first guiding slopes 211 are respectively formed on two opposite outer sidewalls of the snap-fitting member 210 in the second direction. From the proximal end of the snap-fitting member 210 connected to the connecting structure 200 to the distal end of the snap-fitting member 210 away from the connecting structure 200, a distance between the two first guiding slopes 211 in the second direction gradually decreases.

In the embodiment, first guiding slopes 211 are respectively formed on two opposite sidewalls of the snap-fitting member 210 in the second direction. From the proximal end of the snap-fitting member 210 to the distal end of the snap-fitting member 210, a distance between the two first guiding slopes 211 in the second direction gradually decreases. Thus, on one hand, any one of the first guiding slopes 211 can guide the snap-fitting member 210 to unlock from the first limiting groove 410, and the connecting structure 200 can be unlocked by moving along any direction in the second direction relative to the base 400, improving freedom of unlocking. On the other hand, the width of the distal end of the snap-fitting member 210 in the second direction is also reduced, facilitating the distal end of the snap-fitting member 210 to smoothly snap-fit into the first limiting groove 410, and making alignment easier during installation of the base 400 and the connecting structure 200.

In some embodiments, referring to FIGS. 27-29, a second guiding slope 420 is formed on an inner sidewall of the first limiting groove 410. The height of the second guiding slope 420 in the second direction gradually changes. When the connecting structure 200 moves relative to the base 400 along the second direction, the second guiding slope 420 can abut against the snap-fitting member 210, and guide the snap-fitting member 210 to disengage from the first limiting groove 410.

The height of the second guiding slope 420 in the second direction gradually changes. For example, from an outer opening of the first limiting groove 410 to the inside of the first limiting groove 410, the height of the second guiding slope 420 in the second direction gradually increases. In other words, from the outer opening of the first limiting groove 410 to the inside of the first limiting groove 410, the second guiding slope 420 gradually extends into the first limiting groove 410 in the second direction. Thus, when the connecting structure 200 moves relative to the base 400 in the second direction, the snap-fitting member 210 first abuts against a side of the second guiding slope 420 located inside the first limiting groove 410. Under guidance of the second guiding slope 420, the snap-fitting member 210 gradually moves out of the first limiting groove 410 until the snap-fitting member 210 passes over a side of the second guiding slope 420 close to the outer opening of the first limiting groove 410, and the snap-fitting member 210 moves out of the first limiting groove 410, the snap-fitting member 210 disengages from the first limiting groove 410, and the base 400 and the connecting structure 200 are unlocked in the first direction.

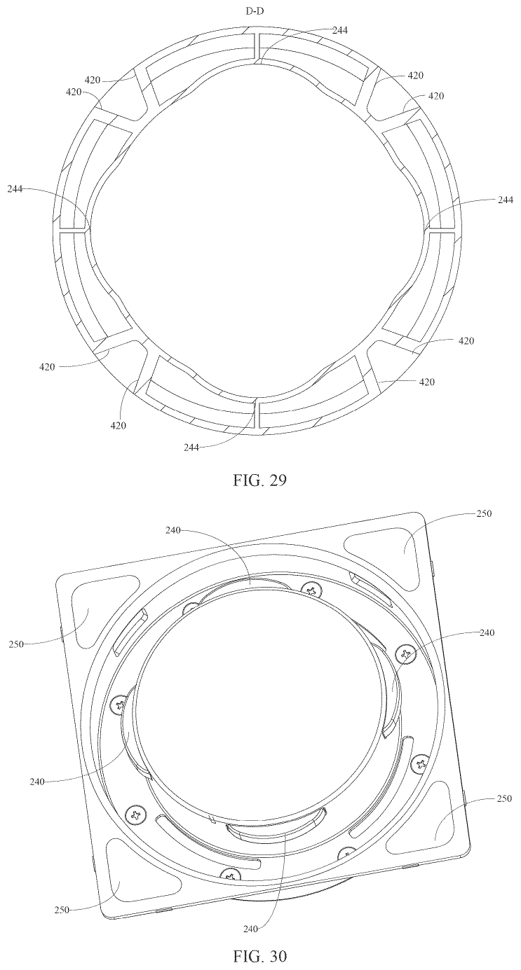

Further, in some embodiments, referring to FIG. 29, the second guiding slopes 420 are respectively formed on two opposite inner sidewalls of the first limiting groove 410 in the second direction. From the outer opening of the first limiting groove 410 to the inside of the first limiting groove 410, a distance between the two second guiding slopes 420 in the second direction gradually decreases.

In the embodiment, on one hand, any one of the second guiding slopes 420 can guide the snap-fitting member 210 to unlock from the first limiting groove 410, and the connecting structure 200 can be unlocked by moving along any direction in the second direction relative to the base 400, improving freedom of unlocking. On the other hand, the width of the opening of the first limiting groove 410 in the second direction is also increased, facilitating the snap-fitting member 210 to more easily engage with the limiting groove, and making alignment easier during installation of the base 400 and the connecting structure 200.

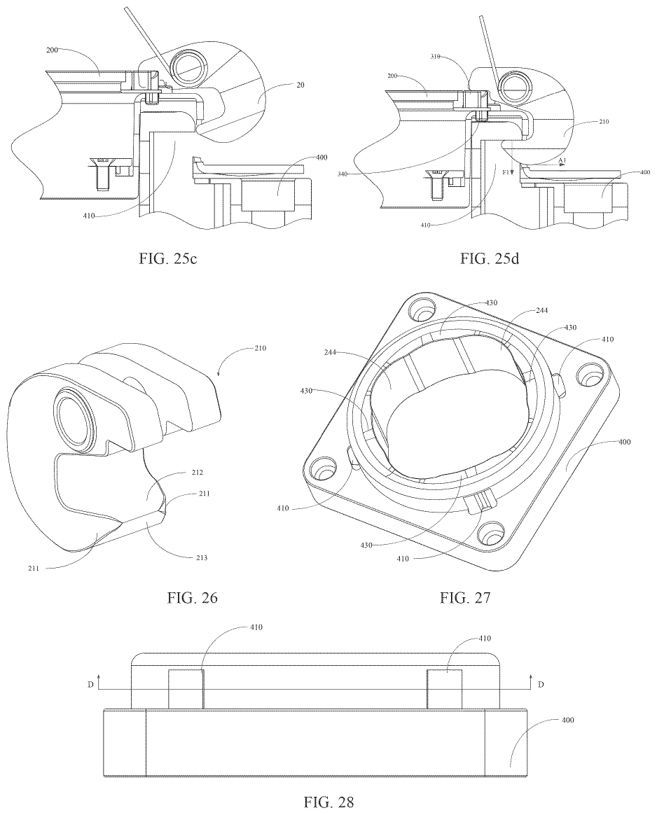

In some embodiments, referring to FIG. 25 and FIG. 26, the two opposite outer sidewalls of the snap-fitting member 210 in the first direction are respectively formed with a snap-fitting surface 212 and a third guiding slope 213. During snap-fitting, the snap-fitting surface 212 contacts the first limiting groove 410 to snap-fit in the first direction, and the height of the third guiding slope 213 in the first direction gradually changes.

In the embodiment, the snap-fitting surface 212 of the snap-fitting member 210 abuts against the first limiting groove 410 to achieve snap-fitting between the snap-fitting member 210 and the first limiting groove 410. During coupling process of the base 400 and the connecting structure 200 in the first direction, the third guiding slope 213 first contacts a plane around the first limiting groove 410 on the connecting structure 200. Since the height of the third guiding slope 213 gradually changes in the first direction, during the coupling process of the connecting structure 200 relative to the base 400 in the first direction, the third guiding slope 213 can guide the movement of the snap-fitting member 210, enabling the snap-fitting member 210 to smoothly pass over an edge of the opening of the first limiting groove 410, and then the snap-fitting surface 212 can be in snap-fit engagement with the first limiting groove 410.

For example, when the snap-fitting member 210 is rotatably connected to the connecting structure 200, referring to FIG. 25(a), the third guiding slope 213 abuts against an outer sidewall of the first limiting groove 410 on the base 400. Then, referring to FIG. 25(b), the third guiding slope 213 can guide the snap-fitting member 210 to rotate toward an outside of the first limiting groove 410, referring to FIG. 25(c), until the snap-fitting member 210 passes over the edge of the opening of the first limiting groove 410, the snap-fitting member 210 rotates into the first limiting groove 410, referring to FIG. 25(d), the snap-fitting surface 212 of the snap-fitting member 210 is in snap-fit engagement with the first limiting groove 410, so that the snap-fitting member 210 is in snap-fit engagement with the first limiting groove 410 in the first direction.

For another example, when the snap-fitting member 210 is slidably connected to the connecting structure 200, the third guiding slope 213 can guide the snap-fitting member 210 to slide toward a side away from the first limiting groove 410 until the snap-fitting member 210 passes over the edge of the opening of the first limiting groove 410, and the snap-fitting member 210 slides into the first limiting groove 410, and the snap-fitting surface 212 of the snap-fitting member 210 is in snap-fit engagement with the first limiting groove 410, so that the snap-fitting member 210 is in snap-fit engagement with the first limiting groove 410 in the first direction.

In some embodiments, when the snap-fitting member 210 is in snap-fit engagement with the first limiting groove 410, a force exerted by the first limiting groove 410 on the snap-fitting member 210 is perpendicular to a movement direction of the snap-fitting member 210 when the snap-fitting member 210 is unlocked from the first limiting groove 410.

In the embodiment, when the snap-fitting member 210 is in snap-fit engagement with the first limiting groove 410, the force exerted by the first limiting groove 410 on the snap-fitting member 210 is perpendicular to the movement direction of the snap-fitting member 210 when unlocking from the first limiting groove 410. Thus, the snap-fitting member 210 can be self-locked, reducing accidental unlocking between the snap-fitting member 210 and the first limiting groove 410, and improving the reliability of fixation between the base 400 and the connecting structure 200.

For example, when the snap-fitting member 210 is rotatably disposed on the connecting structure 200, referring to FIG. 25(d), the movement direction of the snap-fitting member 210 when unlocking from the first limiting groove 410 is a tangential direction of rotation of the snap-fitting member 210 in the state shown in FIG. 25(d) (for example, a direction A1 in the figure). The force exerted by the first limiting groove 410 on the snap-fitting member 210 is as shown in FIG. 25(d) (for example, a direction F1 in the figure), and a direction of the force is perpendicular to the movement direction of the snap-fitting member 210 when unlocking, thereby enabling self-locking of the snap-fitting member 210 in a current position.

For another example, when the snap-fitting member 210 is slidably disposed on the connecting structure 200, the force exerted by the first limiting groove 410 on the snap-fitting member 210 is perpendicular to a sliding direction of the snap-fitting member 210, which can also achieve self-locking and reduce the possibility of accidental unlocking between the snap-fitting member 210 and the first limiting groove 410.

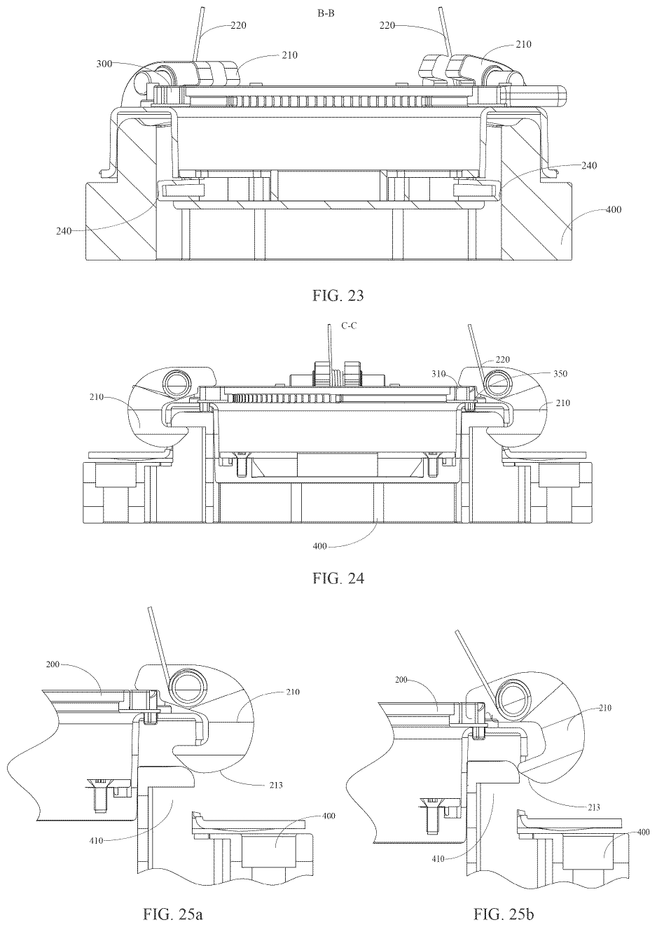

In some embodiments, referring to FIGS. 23-25 and FIGS. 36-39, the output device may further include a locking member 300, and the locking member 300 is movably disposed on the connecting structure 200. When the snap-fitting member 210 is locked with the first limiting groove 410, the locking member 300 can move relative to the connecting structure 200 and abut against the snap-fitting member 210 to limit the movement of the snap-fitting member 210.

In the embodiment, the locking member 300 is configured to limit the movement of the snap-fitting member 210 when the snap-fitting member 210 is locked with the first limiting groove 410, thereby maintaining a locked state between the snap-fitting member 210 and the first limiting groove 410, preventing accidental unlocking between the snap-fitting member 210 and the first limiting groove 410, so that the reliability of locking between the base 400 and the connecting structure 200 is higher. When a device (e.g., the output device) is fixed via the base 400 and the connecting structure 200, the fixed device can withstand greater loads in different directions, improving safety of the fixed device during operation.

In some embodiments, the locking member 300 includes a first position that allows the snap-fitting member 210 to move freely, and a second position that restricts the movement of the snap-fitting member 210. The locking member 300 can move between the first position and the second position.

In the embodiment, when the locking member 300 moves to the first position, the snap-fitting member 210 can move freely. In other words, the snap-fitting member 210 has a movement freedom to be unlocked from the first limiting groove 410. Thus, when the locking member 300 is located at the first position, the snap-fitting member 210 can be moved and unlocked from the first limiting groove 410, enabling disassembly of the base 400 and connecting structure 200. After the snap-fitting member 210 is locked with the first limiting groove 410, when the locking member 300 moves to the second position, the locking member 300 abuts against the snap-fitting member 210, and the locking member 300 limits the movement of the snap-fitting member 210. At this time, the snap-fitting member 210 cannot be unlocked from the first limiting groove 410, and the reliability of the locking between the base 400 and the connecting structure 200 is higher.

In a possible embodiment, the first position may correspond to a position interval. In other words, there may be a plurality of first positions. When the locking member 300 moves to the position interval corresponding to the first position, the locking member 300 may have a movement freedom to be unlocked from the first limiting groove 410.

In an embodiment, the locking member 300 may be slidably disposed on the connecting structure 200. For example, a sliding groove configured to accommodate the locking member 300 may be provided on the connecting structure 200, and the locking member 300 is embedded in the sliding groove and can be slidable along the sliding groove to the first position and second position respectively. Alternatively, a sliding groove is provided on one of the locking member 300 and the connecting structure 200, and a sliding block configured to mate with the sliding groove is provided on the other of the locking member 300 and the connecting structure 200, so that the locking member 300 is slidably disposed on the connecting structure 200. With the cooperation of the sliding groove and the sliding block, the locking member 300 can slide to the first position and second position respectively.

In another embodiment, the locking member 300 may be rotatably disposed on the connecting structure 200, and the locking member 300 may be rotated on the connecting structure 200 to the first position and second position, respectively.

In some embodiments, referring to to FIGS. 23-25, the locking member 300 is movably disposed on the connecting structure 200, and the locking member 300 is provided with a limiting protrusion 310 and a clearance slot 320. When the locking member 300 moves to the second position, the limiting protrusion 310 abuts against the snap-fitting member 210 to limit the movement of the snap-fitting member 210. When the locking member 300 moves to the first position, the clearance slot 320 overlaps with the snap-fitting member 210, so that the snap-fitting member 210 has a movement freedom to be unlocked from the first limiting groove 410.

In the embodiment, when the locking member 300 moves to the second position, the limiting protrusion 310 abuts against the snap-fitting member 210 to limit the movement of the snap-fitting member 210, reducing the possibility of accidental unlocking between the snap-fitting member 210 and the limiting protrusion 310. When the locking member 300 moves to the first position, the clearance slot 320 provides clearance for the movement of the snap-fitting member 210, so that the snap-fitting member 210 has a movement freedom to be unlocked from the first limiting groove 410.

In a possible embodiment, referring to FIG. 36, the clearance slot 320 may be formed by a surface of the locking member 300 being recessed downward, and a depth of the clearance slot 320 is less than a thickness of the locking member 300. The snap-fitting member 210 can move (for example, rotate) into the clearance slot 320 and disengage from the first limiting groove 410 in the first direction, so that the snap-fitting member 210 and the first limiting groove 410 are unlocked.

In another possible embodiment, referring to FIG. 38, the clearance slot 320 may also be a through groove provided on the locking member 300. The snap-fitting member 210 can move (e.g., rotate) in the clearance slot 320 to unlock from the first limiting groove 410.

In some embodiments, referring to FIGS. 36-38, the locking member 300 further includes a fourth guiding slope 330, the fourth guiding slope 330 connects the adjacent limiting protrusion 310 and the clearance slot 320. The fourth guiding slope 330 gradually increases in height from the clearance slot 320 to the limiting protrusion 310.

In the embodiment, after the snap-fitting member 210 is in snap-fit engagement with the first limiting groove 410 in the first direction, the locking member 300 can move from the first position to the second position. During the movement of the locking member 300, the fourth guiding slope 330 can contact the snap-fitting member 210, thereby guiding the snap-fitting member 210 to abut against the limiting protrusion 310 to limit the movement of the snap-fitting member 210.

In some embodiments, referring to FIGS. 19-25 and FIGS. 36-38, there are a plurality of snap-fitting members 210, and the plurality of snap-fitting members 210 is arranged at intervals along a circumferential direction of the connecting structure 200. The locking member 300 is annular, and the locking member 300 is provided with a plurality of sets of limiting protrusions 310 and clearance slots 320 corresponding to the snap-fitting members 210. The locking member 300 can rotate relative to the connecting structure 200 and rotate to the first position or the second position. The center of the locking member 300 is coincident with the rotation axis of the locking member 300.

In the embodiment, the locking member 300 rotates around the center of the locking member 300. When the locking member 300 is located at the first position, the clearance slot 320 on the locking member 300 overlaps with the corresponding snap-fitting member 210, and the snap-fitting member 210 can move and be snap-fitted into the first limiting groove 410. After the snap-fitting member 210 is in snap-fit engagement with the first limiting groove 410, the locking member 300 can be rotated from the first position to the second position. After the locking member 300 is rotated to the second position, the limiting protrusion 310 of the locking member 300 abuts against the corresponding snap-fitting member 210, and the movement of the snap-fitting member 210 is limited. Thus, the plurality of snap-fitting members 210 can be locked simultaneously through rotation of the locking member 300, improving operational efficiency.

In some embodiments, the output device further includes a first driving motor 360, which is fixed on the connecting structure 200 and is drivingly connected to the locking member 300. The first driving motor 360 is configured to drive the locking member 300 to move.

For example, when the locking member 300 is rotatably or slidably disposed on the connecting structure 200, an output shaft of the first driving motor 360 may be in driving connection with the locking member 300 via a rack-and-pinion mechanism. Alternatively, when the locking member 300 is slidably disposed on the connecting structure 200, the first driving motor 360 may be in driving connection with the locking member 300 via a screw feed mechanism.

In a possible embodiment, the first driving motor 360 is configured to drive the locking member 300 to move in response to a first in-position signal emitted by a first position detection apparatus, so that the locking member 300 abuts against the snap-fitting member 210. The first in-position signal is configured to indicate that the connecting structure 200 is coupled to the base 400. For example, a controller of the first driving motor 360 may be communicatively connected to the first position detection apparatus, and the controller of the first driving motor 360 may control the first driving motor 360 to operate according to the first in-position signal from the first position detection apparatus.

In the embodiment, the first position detection apparatus detects whether the base 400 is coupled to the connecting structure 200. It can be understood that when the base 400 is coupled to the connecting structure 200, the base 400 and the connecting structure 200 are mounted in place. The first driving motor 360 may drive the locking member 300 to move in response to the first in-position signal emitted by the first position detection apparatus, such as driving the locking member 300 to move from the first position to the second position, so as to achieve the locking of the snap-fitting member 210.

For example, the first position detection apparatus may be a Hall sensor, and a permanent magnet cooperating with the Hall sensor may be provided. One of the Hall sensor and the permanent magnet is disposed on the base 400, and the other of the Hall sensor and the permanent magnet is disposed on the connecting structure 200. After the base 400 and the connecting structure 200 are coupled in place, a magnetic field of the permanent magnet triggers the Hall sensor, and the controller of the first driving motor 360 controls the first driving motor 360 to start operating in response to the first in-position signal triggered by the Hall sensor, and the first driving motor 360 drives the locking member 300 to move.

Alternatively, the first position detection apparatus may be a reed switch. Similarly, the reed switch may be configured in a similar manner to the Hall sensor. The cooperation between the reed switch and the permanent magnet may be configured to detect whether the base 400 and the connecting structure 200 are coupled in place, which can be achieved by referring to the foregoing embodiments, and will not be described in detail here.

For another example, the first position detection apparatus may be a limit switch, which may be individually disposed on the base 400 or individually disposed on the connecting structure 200. After the base 400 and the connecting structure 200 are coupled in place, the limit switch is triggered, and the controller of the first driving motor 360 controls the first driving motor 360 to start operating in response to the triggering of the limit switch, and the first driving motor 360 drives the locking member 300 to move. In another alternative embodiment, limit switches may be respectively disposed on the base 400 and the connecting structure 200, and the controller of the first driving motor 360 may be configured to control the first driving motor 360 to start operating when both the limit switch on the base 400 and the limit switch on the connecting structure 200 are triggered, so as to reduce the possibility of false triggering of the first driving motor 360.

In another alternative embodiment, the first in-position signal is configured to indicate that the snap-fitting member 210 is in snap-fit engagement with the first limiting groove 410.

In the embodiment, when the snap-fitting member 210 is in snap-fit engagement with the first limiting groove 410, the first position detection apparatus emits the first in-position signal, and the first driving motor 360 drives the locking member 300 to move in response to the first in-position signal, such as driving the locking member 300 to move from the first position to the second position, so as to achieve the locking of the snap-fitting member 210.

For example, the first position detection apparatus may be a Hall sensor, and a permanent magnet cooperating with the Hall sensor may be provided. One of the Hall sensor and the permanent magnet is disposed on the snap-fitting member 210, and the other of the Hall sensor and the permanent magnet is disposed on the base 400 or the connecting structure 200. After the snap-fitting member 210 is in snap-fit engagement with the first limiting groove 410, a magnetic field of the permanent magnet triggers the Hall sensor, and the controller of the first driving motor 360 controls the first driving motor 360 to start operating in response to the first in-position signal triggered by the Hall sensor, and the first driving motor 360 drives the locking member 300 to move.

Alternatively, the first position detection apparatus may be a reed switch. Similarly, the reed switch may be configured in a similar manner to the Hall sensor. The cooperation between the reed switch and the permanent magnet may be configured to detect whether the snap-fitting member 210 is in snap-fit engagement with the first limiting groove 410, which can be achieved by referring to the foregoing embodiments, and will not be described in detail here.

For another example, the first position detection apparatus may be a limit switch, which may be individually disposed on the base 400 or individually disposed on the connecting structure 200. After the snap-fitting member 210 is in snap-fit engagement with the first limiting groove 410, the limit switch is triggered (for example, triggered by the snap-fitting member 210), and the controller of the first driving motor 360 controls the first driving motor 360 to start operating in response to the triggering of the limit switch, and the first driving motor 360 drives the locking member 300 to move. In another alternative embodiment, limit switches may be respectively disposed on the base 400 and the connecting structure 200, and the controller of the first driving motor 360 may be configured to control the first driving motor 360 to start operating when both the limit switch on the base 400 and the limit switch on the connecting structure 200 are triggered, so as to reduce the possibility of false triggering of the first driving motor 360.

In some embodiments, the output device further includes a second position detection apparatus, which is communicatively connected to the first driving motor 360. The second position detection apparatus is configured to detect a current position of the locking member 300 and generate a second in-position signal when the locking member 300 moves to a preset limit position, and the second in-position signal is configured to stop the first driving motor 360 that is in motion.

For example, the second position detection apparatus may be communicatively connected to the controller of the first driving motor 360, the second in-position signal emitted by the second position detection apparatus may be sent to the controller of the first driving motor 360, and the controller of the first driving motor 360 controls the first driving motor 360 in motion to stop.

In the embodiment, the second in-position signal indicates that the locking member 300 moves to a preset limit position, and the first driving motor 360 stops operating in response to the second in-position signal, so as to achieve precise control of the first driving motor 360.

In a possible embodiment, the second position detection apparatus may be a limit switch disposed on the connecting structure 200, and when the locking member 300 moves to a preset limit position, the locking member 300 triggers the limit switch.

In another possible embodiment, the second position detection apparatus may also be a photoelectric gate, and when the locking member 300 moves to a preset limit position, the photoelectric gate is triggered.

In another possible embodiment, the second position detection apparatus may be a Hall element, and a permanent magnet cooperating with the Hall element may be provided. For example, the Hall element may be disposed on the connecting structure 200. For example, the permanent magnet is disposed on the locking member 300. When the locking member 300 moves to a preset limit position, the Hall element is triggered.

In another possible embodiment, the second position detection apparatus may be a reed switch, which is configured similarly to the Hall element, and will not be described in detail here.

In some embodiments, the locking member 300 is further connected to a toggle handle 350, and the toggle handle 350 extends from the connecting structure 200.

In the embodiment, the toggle handle 350 extends from the connecting structure 200, and the movement of the locking member 300 can be manually controlled by the toggle handle 350. For example, a strip groove configured to limit the movement range of the toggle handle 350 may be provided on the connecting structure 200, and the toggle handle 350 moves in the strip groove so that the locking member 300 can move to the first position and the second position respectively.

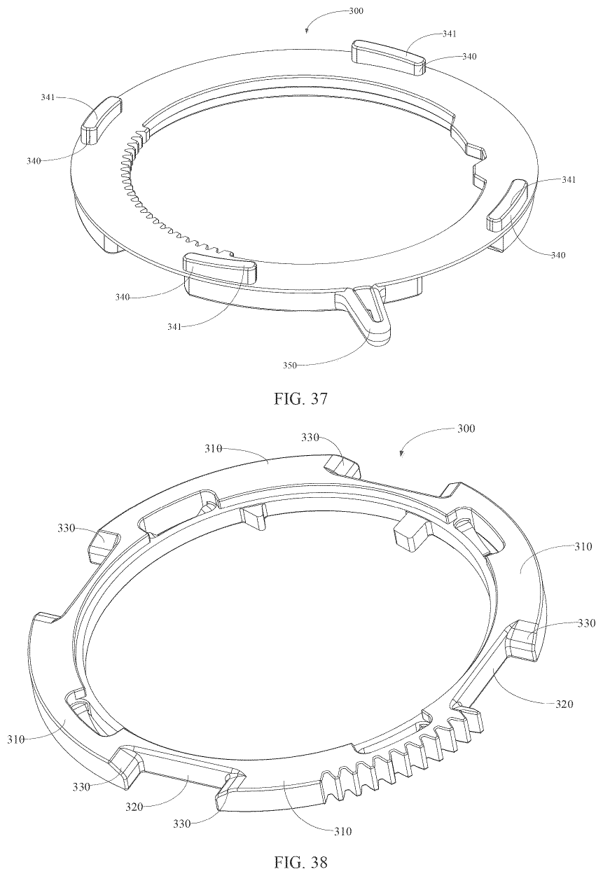

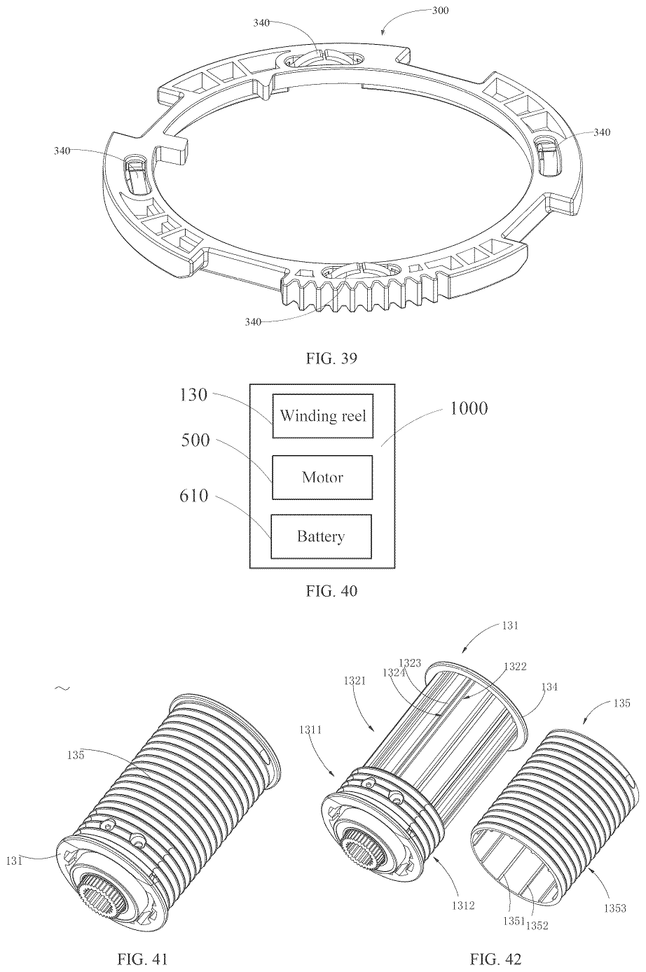

In some embodiments, referring to FIG. 24, FIG. 25, FIG. 37 and FIG. 39, the locking member 300 is provided with a first top block 340, and when the locking member 300 moves to the second position, the first top block 340 abuts against the base 400 in the first direction.

First, the possible application background of an embodiment is described. When the first limiting portion and the second limiting portion are locked, the base 400 and the connecting structure 200 can be locked. However, due to factors such as processing errors and assembly errors, after the base 400 and the connecting structure 200 are locked, there may be a certain gap between the base 400 and the connecting structure 200, causing the base 400 and the connecting structure 200 to shake relative to each other, affecting the stability and the reliability of the connection. For example, when the base 400 is fixed on a fixed surface and the connecting structure 200 is connected to the output device, during use of the output device, the connecting structure 200 will shake relative to the base 400, affecting the stability of the connection and also aggravating the wear of the base 400 and the connecting structure 200.

In an embodiment, by providing the first top block 340, the base 400 and the connecting structure 200 can be abutted against each other, thereby eliminating gaps caused by processing errors, assembly errors, etc., and improving the reliability of the connection between the base 400 and the connecting structure 200.

Specifically, in an embodiment, the first top block 340 is provided on the locking member 300. When the locking member 300 moves to the second position, the locking member 300 abuts against the snap-fitting member 210 and limits the movement of the snap-fitting member 210, so that the snap-fit connection between the snap-fitting member 210 and the first limiting groove 410 is more reliable. At the same time, the first top block 340 abuts against the base 400 in the first direction, and the first top block 340 can fill the gap between the base 400 and the connecting structure 200, so that the base 400 and the connecting structure 200 are locked as a whole, reducing the possibility of shaking of the base 400 and the connecting structure 200. It should also be noted that by providing the first top block 340 on the locking member 300, reuse of a driving mechanism can be achieved; that is, by driving the locking member 300, the locking of the snap-fitting member 210 can be achieved, and the first top block 340 can be driven to abut against the connecting structure 200, which is convenient for simplifying structure and improving reliability.

In some embodiments, referring to FIG. 27, a fifth guiding slope 430 is provided on a side of the base 400 facing the connecting structure 200; along a moving direction of the locking member 300, the height of the fifth guiding slope 430 in the first direction gradually changes. When the locking member 300 moves to the second position, the first top block 340 abuts against the fifth guiding slope 430.

In the embodiment, the height of the fifth guiding slope 430 in the first direction gradually changes. During the movement of the locking member 300, for example, the height of the fifth guiding slope 430 in the first direction gradually increases. In other words, during the movement of the locking member 300 toward the second position, a distance between the first top block 340 and the fifth guiding slope 430 gradually decreases. When the locking member 300 moves to the second position, or before the locking member 300 moves to the second position, the first top block 340 abuts against the fifth guiding slope 430. When the locking member 300 is fixed in the second position, the locking member 300 and the fifth guiding slope 430 are in a state of abutting against each other.

In one possible embodiment, before the locking member 300 moves to the second position, the first top block 340 abuts against the fifth guiding slope 430, and then, as the locking member 300 continues to move to the second position, under guiding action of the fifth guiding slope 430, the gap between the base 400 and the connecting structure 200 gradually decreases until the locking member 300 has moved to the second position. At this time, the gap between the base 400 and the connecting structure 200 is eliminated through interaction between the first top block 340 and the fifth guiding slope 430.

In some embodiments, referring to FIG. 37 and FIG. 39, a sixth guiding slope 341 is provided at an end of the first top block 340 abutting against the fifth guiding slope 430. During the movement of the locking member 300 from the first position to the second position, the sixth guiding slope 341 is mated with the fifth guiding slope 430. In the embodiment, the sixth guiding slope 341 on the first top block 340 is mated with the fifth guiding slope 430, so that the first top block 340 abuts against the fifth guiding slope 430 via the sixth guiding slope 341, and a sliding resistance can be reduced during relative sliding of the first top block 340 and the fifth guiding slope 430.

For example, before the first top block 340 abuts against the fifth guiding slope 430, the sixth guiding slope 341 and the fifth guiding slope 430 may be parallel to each other. After the first top block 340 abuts against the fifth guiding slope 430, the sixth guiding slope 341 may fit with the fifth guiding slope 430.

In some embodiments, referring to FIG. 39, the first top block 340 may also be configured as a deformable structure, for example, the first top block 340 may be a cantilever structure as shown in FIG. 39. Thus, the first top block 340 may be deformed after abutting against the base 400, and may adapt to gaps of different sizes between the base 400 and the connecting structure 200, causing lower requirements for processing errors and assembly errors and better applicability.

In some embodiments, the connecting structure 200 further includes a first stopping protrusion 230, and the first stopping protrusion 230 is fixed on the connecting structure 200. The first stopping protrusion 230 is configured to be mated with a second stopping protrusion on the locking member 300 to limit the movement range of the locking member 300. In the embodiment, the first stopping protrusion 230 on the connecting structure 200 is mated with the second stopping protrusion on the locking member 300 to limit the movement range of the locking member 300. For example, two first stopping protrusions 230 may be provided on the connecting structure 200, and the two stopping protrusions limit the movement range of locking member 300. When the locking member 300 moves within the range of movement, the locking member 300 can move to the first position and the second position respectively.

Background technology that may be applied to following embodiments is described herein. When the base 400 and the connecting structure 200 are coupled along the first direction, alignment between the base 400 and the connecting structure 200 is usually required. However, during actual use, it is difficult for the user to quickly find a correct position during installation, resulting in the base 400 and the connecting structure 200 being misaligned. As a result, the base 400 and the connecting structure 200 may be difficult to connect normally or may have an unstable connection.

Based on this, in some embodiments, referring to FIG. 23 and FIGS. 29-35, the connecting structure 200 may further include: a retractable guiding protrusion 240, a retracting direction of the guiding protrusion 240 intersects with the first direction; an elastic member 243, mated with the guiding protrusion 240 to keep the guiding protrusion 240 in a tendency to extend outward; and a guiding groove 244, the guiding groove 244 is adapted to the guiding protrusion 240 after extending outward. The guiding protrusion 240 may be disposed on the connecting structure 200, and the guiding groove 244 may be disposed on the base 400. When the first limiting portion and the second limiting portion are locked, the guiding protrusion 240 is embedded in the guiding groove 244. When the connecting structure 200 moves relative to the base 400 along the second direction, the guiding protrusion 240 contracts and passes over the guiding groove 244.

In the solution, when the first limiting portion and the second limiting portion are locked, the extended guiding protrusion 240 is embedded in the guiding groove 244. Since an extending direction of the guiding protrusion 240 intersects with the first direction, when the base 400 and the connecting structure 200 are plugged in along the first direction, the base 400 and the connecting structure 200 can be plugged in along the first direction only when the guiding protrusion 240 and the guiding groove 244 overlap with each other. Thus, through cooperation of the guiding protrusion 240 and the guiding groove 244, a relative position of the base 400 and the connecting structure 200 in the second direction can be limited, so that the base 400 and the connecting structure 200 can only be plugged in at a specific position, facilitating users to connect the base 400 and the connecting structure 200 in a standardized manner.

When the base 400 and the connecting structure 200 are unlocked, the base 400 and the connecting structure 200 move relatively along the second direction, and the guiding protrusion 240 contracts under extrusion of the guiding groove 244, and finally the guiding protrusion 240 passes over the guiding groove 244, which does not limit relative movement of the base 400 and the connecting structure 200, facilitating smooth unlocking of the base 400 and the connecting structure 200.

Referring to FIGS. 30-35, for example, a limiting step 242 may be disposed on the limiting protrusion 310, and the limiting step 242 abuts against an inner wall of the connecting structure 200 to prevent the limiting step 242 from detaching from the connecting structure 200. The elastic member 243 may be, for example, a deformable structure, and the elastic member 243 abuts against an inner wall of the limiting protrusion 310. When the limiting protrusion 310 extends from a quick-release member, the limiting step 242 of the limiting protrusion 310 abuts against the inner wall of the connecting structure 200, and the inner side of the limiting protrusion 310 abuts against the elastic member 243.

Of course, the elastic member 243 may also be a spring, which will not be described in detail here.

In some embodiments, referring to FIG. 35, a seventh guiding slope 241 is disposed on a side of the guiding protrusion 240 mated with the guiding groove 244, and the height of the seventh guiding slope 241 gradually changes along the second direction.

In this solution, the seventh guiding slope 241 can guide the guiding protrusion 240 to be embedded in the guiding groove 244, or guide the guiding protrusion 240 to pass over the first limiting groove 410. Specifically, when the base 400 and the connecting structure 200 are coupled along the first direction, when the guiding protrusion 240 is not completely aligned with the guiding groove 244, the seventh guiding slope 241 abuts against the first limiting groove 410, so as to provide a component force or a torque to guide and align the guiding protrusion 240, thereby guiding the limiting protrusion 310 to align with the first limiting groove 410, and further aligning the base 400 with the connecting structure 200. During unlocking process of the base 400 and the connecting structure 200, the base 400 and the connecting structure 200 move relatively in the second direction, and at this time, the seventh guiding slope 241 can abut against the guiding groove 244. A force exerted by the guiding groove 244 on the seventh guiding slope 241 causes the guiding protrusion 240 to gradually contract, and finally the guiding protrusion 240 passes over the guiding groove 244 under guidance of the seventh guiding slope 241, so as to achieve smooth unlocking of the base 400 and the connecting structure 200.

In some embodiments, referring to FIG. 35, along the second direction, the height of the seventh guiding slope 241 first increases and then decreases.

In the embodiment, along the second direction, the height of the seventh guiding slope 241 first increases and then decreases, so that when the base 400 and the connecting structure 200 move relatively toward either side in the second direction, the limiting protrusion 310 can be contracted through guiding action of the seventh guiding slope 241, so that the limiting protrusion 310 passes over the first limiting groove 410, thereby achieving smooth unlocking of the base 400 and the connecting structure 200.

For example, the base 400 and the connecting structure 200 can rotate relative to each other along the second direction. At a viewing angle shown in FIG. 22, the connecting structure 200 can rotate clockwise or counterclockwise relative to the base 400, both of which can enable the limiting protrusion 310 pass over the first limiting groove 410, so that bidirectional unlocking of the connecting structure 200 and the base 400 can be achieved, and it is more convenient for the user to use.

Referring to FIG. 35, for example, the seventh guiding slope 241 may be an arc-shaped surface.

In other embodiments of the present disclosure, the difference from the above embodiments is that the guiding groove 244 is disposed on the connecting structure 200, and the guiding protrusion is disposed on the base 400. The relevant arrangement has been fully described in the above embodiments, and will not be described in detail here.

The background technology that may be applied to following embodiments is described herein. When the first limiting portion and the second limiting portion are locked, the base 400 and the connecting structure 200 can be locked. However, due to factors such as processing errors and assembly errors, after the base 400 and the connecting structure 200 are locked, there may be a certain gap between the base 400 and the connecting structure 200, causing the base 400 and the connecting structure 200 to shake relative to each other, affecting the stability and the reliability of the connection. For example, when the base 400 is fixed on a fixed surface and the connecting structure 200 is connected to the output device, during use of the output device, the connecting structure 200 will shake relative to the base 400, affecting the stability of the connection and also aggravating the wear of the base 400 and the connecting structure 200.

Based on this, in an embodiment, a deformable second top block 250 and/or a deformable third top block is provided to fill the gap between the base 400 and the connecting structure 200.

In some embodiments, referring to FIG. 30, a deformable second top block 250 is disposed on a side of the connecting structure 200 facing the base 400. When the connecting structure 200 is locked with the base 400, the second top block 250 abuts against the base 400.

In the embodiment, the second top block 250 on the connecting structure 200 can abut against the base 400, so as to fill the gap between the base 400 and the connecting structure 200, reduce shaking of the base 400 and the connecting structure 200, and improve the stability of the connection between the base 400 and the connecting structure 200. By configuring the second top block 250 to be deformable, dimensional deviations caused by processing errors, assembly errors, etc. can be accommodated.

For example, the second top block 250 may be a rubber block.

In some embodiments, a deformable third top block is fixedly disposed on a side of the base 400 facing the connecting structure 200, and when the connecting structure 200 is locked with the base 400, the third top block abuts against the connecting structure 200.

In the embodiment, the third top block on the base 400 can abut against the base 400, so as to fill the gap between the base 400 and the connecting structure 200, reduce shaking of the base 400 and the connecting structure 200, and improve the stability of the connection between the base 400 and the connecting structure 200. By configuring the third top block to be deformable, dimensional deviations caused by processing errors, assembly errors, etc. can be accommodated.

For example, the third top block may be a rubber block.

In some possible embodiments, a third top block is disposed on the base 400, and a second top block 250 is disposed on the connecting structure 200.

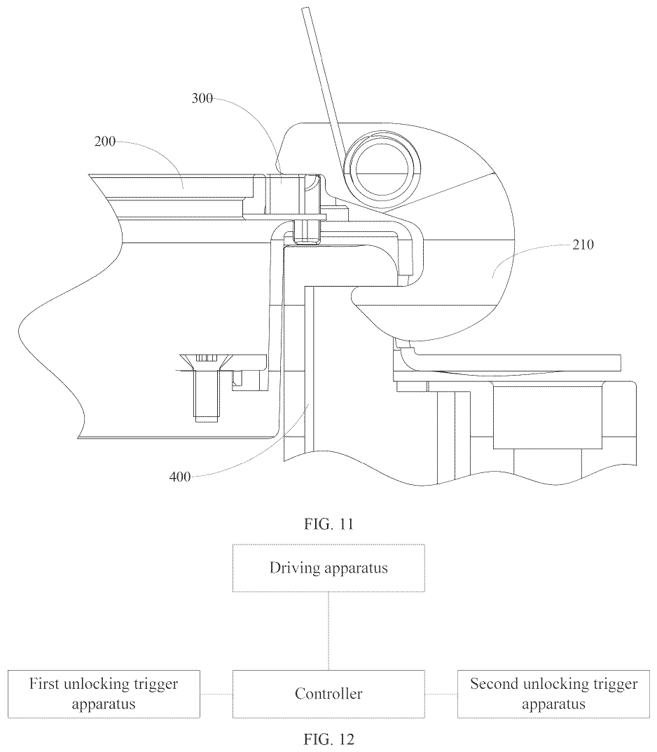

In some embodiments, referring to FIG. 1 and FIG. 12, the output device may further include: a locking mechanism, the locking mechanism is configured to lock the connecting structure 200; a first unlocking trigger apparatus 511 (for example, a push switch) disposed on the motor 500 and communicatively connected to the locking mechanism; and a second unlocking trigger apparatus 6125 (for example, a push switch) disposed on the power supply assembly 600 and communicatively connected to the locking mechanism. The locking mechanism is configured to unlock the connecting structure 200 when both the first unlocking trigger apparatus 511 and the second unlocking trigger apparatus 6125 are triggered.

In the embodiment, by arranging the first unlocking trigger apparatus and the second unlocking trigger apparatus on the motor 500 and the power supply assembly 600 respectively, and when both the first unlocking trigger apparatus 511 and the second unlocking trigger apparatus 6125 are triggered, the connecting structure 200 can be unlocked. Thus, the user can be guided to hold the output device with both hands to detach the output device from the base 400, reducing the possibility of accidental falling due to unstable holding when the output device is detached from the base 400, thereby improving user safety during use.

In some embodiments, referring to FIG. 10 to FIG. 12, the locking mechanism may include: a locking member 300 movably disposed on the cordage box 100, the locking member 300 being configured to abut against the connecting structure 200 to lock the connecting structure 200; and a driving apparatus in transmission connection with the locking member 300 and connected to the first unlocking trigger apparatus 511 and the second unlocking trigger apparatus 6125. The driving apparatus is configured to: when both the first unlocking trigger apparatus 511 and the second unlocking trigger apparatus 6125 are triggered, drive the locking member 300 to move to unlock the connecting structure 200.

In the embodiment, the locking member 300 is driven by the driving apparatus to move relative to the cordage box 100. For example, the locking member 300 may be slidably disposed on the cordage box 100, and an output shaft of the driving apparatus (for example, a motor) may be in driving connection with the locking member 300 via a gear-rack engagement. Thus, when the driving apparatus operates, the driving apparatus can drive the locking member to slide relative to the cordage box 100.

In some embodiments, referring to FIG. 10 and FIG. 11, the connecting structure 200 may include: a snap-fitting member 210 (for example, a hook) movably disposed on the cordage box 100, the snap-fitting member 210 is in snap-fit engagement with the base 400 to fix the cordage box 100 to the base 400. When the snap-fitting member 210 is in snap-fit engagement with the base 400, the locking member 300 can abut against the snap-fitting member 210 to limit the movement of the snap-fitting member 210. The driving apparatus is configured to: when both the first unlocking trigger apparatus 511 and the second unlocking trigger apparatus 6125 are triggered, drive the locking member 300 to move to release the abutment between the locking member 300 and the snap-fitting member 210.

For example, referring to FIG. 10 and FIG. 11, the snap-fitting member 210 may be rotatably disposed on the cordage box 100. After the snap-fitting member 210 is in snap-fit engagement with the base 400, the output device can be fixed on the base 400. Then, the locking member 300 can abut against the snap-fitting member 210 to limit the snap-fitting member 210 from rotating toward an outside of the base 400 to disengage from the base 400, thereby locking the snap-fitting member 210. When both the first unlocking trigger apparatus 511 and the second unlocking trigger apparatus 6125 are triggered, the driving apparatus can drive the locking member 300 to move, so that the locking member 300 and the snap-fitting member 210 are released from abutment, and the snap-fitting member 210 can be rotated toward the outside of the base 400 and disengage from the base 400, thus releasing the output device from the base 400.

Referring to FIGS. 41-43, in some embodiments, the winding reel 130 includes an inner core 131 and a winding reel housing 135. The winding reel housing 135 is partially or fully sleeved on an outer side of the inner core 131, and the winding reel housing 135 is configured to wind the cordage 900. The thermal conductivity of the winding reel housing 135 is greater than the thermal conductivity of the inner core 131.

The winding reel housing 135 is sleeved on the outer side of the inner core 131. Since the thermal conductivity of the winding reel housing 135 is greater than the thermal conductivity of the inner core 131, after the cordage 900 is wound on the winding reel housing 135, the cordage 900 can quickly conduct heat to dissipate heat, avoiding excessive heat generated by long-term friction between the cordage 900 and the winding reel 130 from affecting operation of the output device.

Specifically, the inner core 131 may be a cylindrical structure, and a shaft hole may be provided through an axis of the inner core 131, and a spline may be disposed in the shaft hole to be connected to the motor 500, so that the motor 500 can drive the winding reel 130 to rotate. The material of the inner core 131 may include plastic or hard rubber, etc., which not only has good structural strength, but also can effectively reduce overall weight of the winding reel 130.

The winding reel housing 135 may be a hollow cylindrical structure, and the diameter of an inner peripheral wall of the winding reel housing 135 may be adapted to an outer diameter of the inner core 131, so as to be fittingly sleeved on the outer side of the inner core 131. In some embodiments, as shown in FIG. 44, when the winding reel housing 135 is fully sleeved on the outer side of the inner core 131, the cordage 900 can be wound on the outer side of the winding reel housing 135, so that heat generated by friction between the cordages 900 or between the cordage 900 and the winding reel housing 135 can be directly conducted to the winding reel housing 135.

In some embodiments, the winding reel housing 135 is partially sleeved on the outer side of the inner core 131. Since the inner core 131 can be made of materials such as plastic or hard rubber, it is convenient to process a structure for fixing the cordage 900. At this time, an end portion of the cordage 900 is fixed to the inner core 131. In some embodiments, the end portion of the cordage 900 is fixed to the inner core 131, and a portion of the cordage 900 close to the fixing end is also wound on the inner core 131, and a remaining portion of the cordage 900 is wound on the winding reel housing 135. Since when the cordage 900 is pulled or retracted on the winding reel 130, a portion farther from the fixing end of the cordage 900 is more likely to be stretched frequently, thereby generating more heat. Thus, the winding reel housing 135 is configured to dissipate heat for the portion, so that heat from the portion of the cordage 900 wound on the winding reel housing 135 can be timely conducted out through the winding reel housing 135.

In some embodiments, the winding reel housing 135 may be made of metal materials with high thermal conductivity such as copper or iron, so that the winding reel housing 135 can better conduct the heat generated by the cordage 900 during the stretching-retracting and friction process, so that the winding reel 130 can better dissipate heat.

Referring to FIGS. 41-43, in some embodiments, a first limiting structure 1322 is disposed on an outer peripheral side of the inner core 131, and a second limiting structure 1351 corresponding to the first limiting structure 1322 is disposed on an inner peripheral side of the winding reel housing 135.

Thus, the winding reel housing 135 can be fixed and limited by cooperation of the second limiting structure 1351 with the first limiting structure 1322 on the inner core 131, so as to avoid a situation where the winding reel housing 135 shifts relative to the inner core 131 when the inner core 131 rotates. When the inner core 131 rotates, rotations of the winding reel housing 135 and the inner core 131 are relatively synchronized, and connection and installation are more stable.

Specifically, the first limiting structure 1322 may be disposed on the outer peripheral wall of the inner core 131, and the second limiting structure 1351 may be disposed on the inner peripheral wall of the winding reel housing 135. The first limiting structure 1322 and the second limiting structure 1351 are aligned with each other, so that the winding reel housing 135 can be stably connected and mounted with the inner core 131.

Referring to FIGS. 41-43, in some embodiments, both the first limiting structure and the second limiting structure 1351 are arranged to extend along an axial direction of the winding reel 130.

Thus, the first limiting structure 1322 and the second limiting structure 1351 can better cooperate to limit the winding reel housing 135 and the inner core 131, preventing the winding reel housing 135 and the inner core 131 from shifting relative to each other when the winding reel 130 rotates.

Specifically, the first limiting structure 1322 may extend along an axial direction of the inner core 131, and the second limiting structure 1351 corresponds to the first limiting structure 1322 and extends along an axial direction of an inner housing. When the winding reel 130 rotates, the inner core 131 is driven by the motor 500 to rotate around the axis of the inner core 131, and the first limiting structure 1322 and the second limiting structure 1351 extend axially, so that a force direction between the inner core 131 and the winding reel housing 135 is perpendicular to a rotation direction of the winding reel 130, thereby achieving a better limiting effect. At the same time, when the inner core 131 is assembled with the winding reel housing 135, the inner core 131 and the winding reel housing 135 can be sleeved circumferentially, so that the first limiting structure 1322 and the second limiting structure 1351 are plugged in and matched with each other circumferentially.

Of course, in some other embodiments, the first limiting structure 1322 and the second limiting structure 1351 may also be arranged around a circumferential direction of the inner core 131 and the winding reel housing 135 at a certain angle, or be arranged in other forms, which is not specifically limited in the present disclosure.

Referring to FIGS. 41-43, in some embodiments, the first limiting structure 1322 includes a first connecting rib 1323, and the first connecting rib 1323 extends along the axial direction of the inner core 131 and protrudes from an outer peripheral surface of the inner core 131, and a second limiting groove 1324 is formed on the first connecting rib 1323.

The second limiting structure 1351 includes a second limiting protrusion 1352, and the second limiting protrusion 1352 extends along an axial direction of the winding reel housing 135 and protrudes from an inner peripheral surface of the winding reel housing 135, and the second limiting protrusion 1352 is snap-fitted in the second limiting groove 1324.

Thus, the inner core 131 can be limited by cooperation of the first connecting rib 1323 with the second limiting protrusion 1352 on the winding reel housing 135, and the second limiting protrusion 1352 is snap-fitted in the second limiting groove 1324 on the first connecting rib 1323. At the same time, a gap is formed between the winding reel housing 135 and the inner core 131 under the action of the first connecting rib 1323 and the second limiting protrusion 1352, thereby effectively improving heat dissipation efficiency of the winding reel housing 135.

Specifically, the first connecting rib 1323 may be protruded on the outer peripheral wall of the inner core 131 and be in a continuous long strip structure, extending along the axial direction of the inner core 131. In some other embodiments, the first connecting rib 1323 may also be in an intermittent strip structure or a block structure, etc., which is not limited in the present disclosure. A second limiting groove 1324 is formed on a side of the first connecting rib 1323 facing the winding reel housing 135, and the shape of the second limiting groove 1324 may be adapted to the shape of the second limiting protrusion 1352. The second limiting protrusion 1352 may generally also be in a continuous long strip structure, and when the winding reel housing 135 is sleeved on the inner core 131, the second limiting protrusion 1352 can be snap-fitted in the second limiting groove 1324.

Since the first connecting rib 1323 is protruded on the outer peripheral wall of the inner core 131, after the winding reel housing 135 is mounted, there will be a certain gap between the winding reel housing 135 and the inner core 131, forming a winding heat dissipation channel 133. After the cordage 900 is wound on the winding reel housing 135, the winding heat dissipation channel 133 can accelerate the heat dissipation effect of the winding reel housing 135.

Referring to FIGS. 41-43, in some embodiments, there are a plurality of first connecting ribs 1323 and the second limiting protrusions 1352. The plurality of first connecting ribs 1323 is arranged at intervals around a circumferential direction of the nesting portion 1321, and the plurality of second limiting protrusions 1352 is arranged at intervals around an inner periphery of the winding reel housing 135, and the first connecting ribs 1323 are in one-to-one correspondence with the second limiting protrusions 1352.

Thus, the plurality of first connecting ribs 1323 and the plurality of second limiting protrusions 1352 can better support the winding reel housing 135, and a contact area between the winding reel housing 135 and the inner core 131 is larger, resulting in a better heat dissipation effect for the cordage 900 on the winding reel housing 135.

Specifically, the plurality of first connecting ribs 1323 may be evenly arranged at intervals around a circumferential direction of the inner core 131. Correspondingly, the plurality of second limiting protrusions 1352 may be evenly arranged at intervals around an inner circumference of the winding reel housing 135. The number of the first connecting ribs 1323 corresponds to the number of the second limiting protrusions 1352, and the present disclosure does not limit the number of the first connecting ribs 1323 and the second limiting protrusions 1352.

Of course, in some other embodiments, the first limiting structure 1322 and the second limiting structure 1351 may also be connected and mounted in other forms. For example, a second limiting groove 1324 is directly provided on the outer peripheral wall of the inner core 131 to be mounted corresponding to the second limiting protrusion 1352 on the winding reel housing 135, etc. The present disclosure does not limit specific structures of the first limiting structure 1322 and the second limiting structure 1351.

Referring to FIGS. 41-44, in some embodiments, a plurality of winding heat dissipation channels 133 communicating from an end portion to the outside is formed on the outer side of the inner core 131. The plurality of winding heat dissipation channels 133 is located on an inner side of the winding reel housing 135 and can timely transfer heat from the inner side of the winding reel housing 135 to the outside. In some embodiments, the winding heat dissipation channel 133 is arranged axially, which is more convenient for heat dissipation in the channel, ensuring the heat dissipation effect, and improving structural stability. In some embodiments, the winding heat dissipation channel 133 is arranged along a spiral. Through rotation of the winding reel, the spirally arranged winding heat dissipation channel 133 can drive internal gas to generate airflow, thereby actively dissipating heat, further enhancing the heat dissipation effect. There may be a plurality of winding heat dissipation channels 133, and the multiple winding heat dissipation channels 133 are arranged at intervals in a circumferential direction of the outer side of the inner core 131.

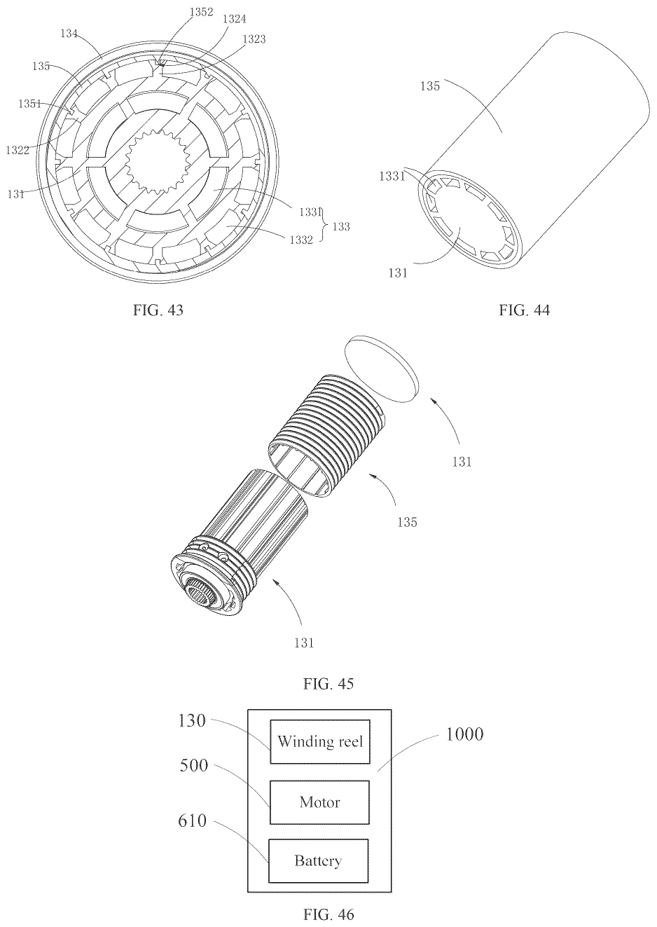

Specifically, the winding heat dissipation channel 133 may be a heat dissipation hole 1331 provided inside the inner core 131 and communicating with both ends of the inner core 131 adjacent to the outer side. The winding heat dissipation channel 133 may be a heat dissipation groove 1332 provided on the outer side of the inner core 131 and communicating with both ends of the inner core 131. The heat dissipation groove 1332 and the winding reel housing 135 sleeved on the outer side together enclose to form the winding heat dissipation channel 133. The winding heat dissipation channel 133 may be as shown in FIG. 43, the winding heat dissipation channels 133 formed by the two ways can coexist, at this time, the heat dissipation hole 1331 is located on an inner side of the heat dissipation groove 1332.

Referring to FIGS. 41-43, in some embodiments, the inner core 131 is axially divided into a fixing portion 1311 and a nesting portion 1321 connected to the fixing portion 1311. The fixing portion 1311 is configured to fix the cordage 900, and the winding reel housing 135 is sleeved on the nesting portion 1321. Thus, an end of the cordage 900 can be fixed on the fixing portion 1311 and then wound on the winding reel housing 135.

Specifically, the fixing portion 1311 may be disposed at an end of the inner core 131, and a cordage 900 fixing structure may be disposed on the fixing portion 1311. The end of the cordage 900 may be fixedly connected to the fixing portion 1311, and then wound from a fixing end of the cordage 900 toward the nesting portion 1321. The nesting portion 1321 is connected to other side of the fixing portion 1311 and is coaxially arranged with the fixing portion 1311. The first limiting structure 1322 may be disposed on an outer peripheral wall of the nesting portion 1321. A length of the winding reel housing 135 may be adapted to a length of the nesting portion 1321, and the winding reel housing 135 is sleeved on an outer side of the nesting portion 1321.

Referring to FIGS. 41-43, in some embodiments, a first winding groove 1312 is formed on an outer peripheral surface of the fixing portion 1311, and a second winding groove 1353 is formed on an outer peripheral surface of the winding reel housing 135. When the winding reel housing 135 is sleeved on the nesting portion 1321, the outer peripheral surface of the winding reel housing 135 is aligned with the outer peripheral surface of the fixing portion 1311, and an end portion of the first winding groove 1312 close to the nesting portion 1321 is connected to an end portion of the second winding groove 1353.

Thus, when the winding reel housing 135 is mounted on the nesting portion 1321, the outer peripheral surfaces of the winding reel housing 135 and the fixing portion 1311 can be integrally aligned with each other, so that the cordage 900 can be wound more neatly on an outer peripheral surface of the winding reel 130. Meanwhile, the first winding groove 1312 and the second winding groove 1353 can play a role in assisting cordage winding to a certain extent, further improving flatness of the cordage 900 wound outside the winding reel 130, and effectively preventing the cordage 900 from knotting or pressing when winding.

Specifically, an outer diameter of the fixing portion 1311 may be larger than an outer diameter of the nesting portion 1321. After the winding reel housing 135 is sleeved on the nesting portion 1321, the outer peripheral surface of the winding reel housing 135 can be aligned with the outer peripheral surface of the fixing portion 1311, which is beneficial for winding of the cordage 900 on the winding reel 130. A first winding groove 1312 may be provided on the outer peripheral surface of the fixing portion 1311, and the first winding groove 1312 is continuously disposed around a circumferential direction of the fixing portion 1311 and extends toward the nesting portion 1321. A second winding groove 1353 may be provided on the outer peripheral surface of the winding reel housing 135, and a starting end of the second winding groove 1353 close to the fixing portion 1311 is connected to a tail end of the first winding groove 1312.

Widths of the first winding groove 1312 and the second winding groove 1353 may be set according to a thickness of the cordage 900, and the present disclosure does not limit the widths of the first winding groove 1312 and the second winding groove 1353.

After the cordage 900 is fixed on the fixing portion 1311, the cordage 900 can be first wound along the first winding groove 1312 and then wound along the second winding groove 1353, so that the arrangement of the cordage 900 on the winding reel 130 will be more flat and regular, avoiding overlapping winding of a plurality of revolutions of the cordage 900 and affecting winding and unwinding of the cordage 900.

Referring to FIGS. 41-43, in some embodiments, the inner core 131 is formed by injection molding, and when the inner core 131 is injection molded, the winding reel housing 135 is placed in a mold to be integrally formed with the inner core 131.

Thus, manufacturing process in which the inner core 131 and the winding reel housing 135 are directly integrally injection-molded through the mold is relatively convenient and efficient, and connection and installation between the winding reel housing 135 and the inner core 131 are also more stable.

Specifically, during the manufacturing process of the winding reel 130, the inner core 131 may be injection-molded first, and then the winding reel housing 135 may be directly injection-molded on the outside of the inner core 131 via the mold, and overall injection molding method is relatively efficient and convenient, improving manufacturing efficiency of the winding reel 130. The first winding groove 1312 and the second winding groove 1353 can be continuously opened and formed on the outer peripheral wall of the whole after integral injection molding, ensuring continuity between the first winding groove 1312 and the second winding groove 1353.

Referring to FIGS. 41-43, in some embodiments, flanges 134 are disposed circumferentially on both ends of the inner core 131 toward the outside, and the flanges protrude in a direction away from the axis of the inner core 131.

Thus, the flanges on both sides of the inner core 131 can effectively prevent the cordage 900 from slipping off the winding reel 130 when the cordage 900 is wound to an end portion of the inner core 131, improving the stability of the cordage 900 when winding.

Specifically, the flange may be formed in a sheet shape protruding around the end portion of the inner core 131 in a direction away from the axis, so that when the cordage 900 is wound to both ends of the winding reel 130, the flange can prevent the cordage 900 from slipping, enabling the cordage 900 to be better wound on the winding reel 130. A specific protruding height of the flange may be determined according to a thickness of the cordage 900 and a winding height of the cordage 900 on the winding reel 130, which is not limited in the present disclosure.

In some embodiments, the inner core 131 is arranged in a split manner, and the winding reel housing 135 is detachably sleeved on the outer side of the inner core 131. Thus, the winding reel housing 135 can be detached and replaced from the inner core 131, facilitating maintenance and replacement when the winding reel housing 135 is damaged.

Specifically, as shown in FIG. 45, the inner core 131 may be configured as a split structure, that is, two split parts of the inner core 131 can be connected and detached by means of screwing or snapping. When the winding reel housing 135 needs to be replaced or detached, the two split parts of the inner core 131 can be separated, and then the winding reel housing 135 can be directly removed from the nesting portion 1321. In the embodiment, when mounting the winding reel housing 135, attention should be paid to the coupling between the second winding groove 1353 on the winding reel housing 135 and the first winding groove 1312 on the fixing portion 1311.

In some embodiments, the first winding groove 1312 and the second winding groove 1353 can be aligned through cooperation of the first limiting structure 1322 and the second limiting structure 1351. In some embodiments, the winding reel housing 135 may be first mounted on the nesting portion 1321, and then the first winding groove 1312 and the second winding groove 1353 may be processed on the fixing portion 1311 and the winding reel housing 135, so that the coupling between the first winding groove 1312 and the second winding groove 1353 will be more accurate, facilitating the winding of the cordage 900.

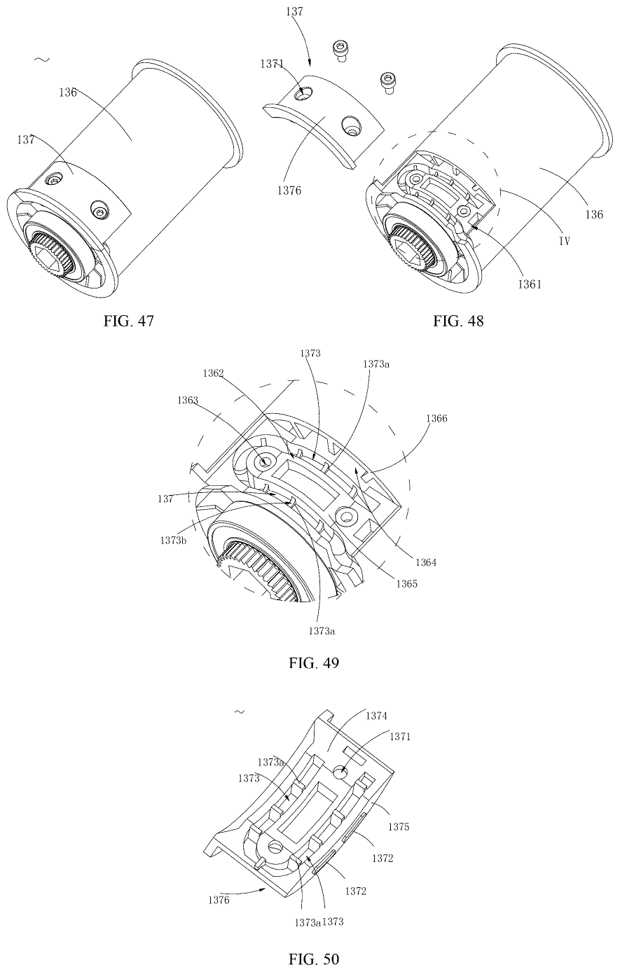

Referring to FIG. 47 and FIG. 48, the winding reel 130 according to an embodiment of the present disclosure includes a reel body 136 and a cordage pressing block 137, the reel body 136 is configured for winding, and a fixing position 1361 is opened on a side surface of the reel body 136. The cordage pressing block 137 is mounted on the fixing position 1361, and the cordage pressing block 137 and the fixing position 1361 press and fix the cordage 900. In some embodiments, the reel body 136 may be the inner core 131.

In the winding reel 130 according to an embodiment of the present disclosure, the cordage 900 is pressed and fixed by the cordage pressing block 137 and the fixing position 1361 on the reel body 136 to stably fix the cordage 900 on the winding reel 130, preventing the cordage 900 from loosening, and enabling the end of the cordage 900 to be hidden and fixed in the fixing position 1361 to avoid a fixing part of the cordage 900 affecting rotation of the winding reel 130.

Specifically, the reel body 136 may be in a cylindrical structure to facilitate the rotation of the winding reel 130, enabling the cordage 900 to be better wound on the outer peripheral wall of the winding reel 130. The reel body 136 may be injection-molded from materials such as plastic or hard rubber, which not only has a relatively simple manufacturing process and is easy to manufacture, but also has good structural strength and is not easily damaged. The present disclosure does not limit the material and forming method of the reel body 136.

The fixing position 1361 may be provided on the outer peripheral wall of the reel body 136, and the cordage pressing block 137 is mounted in cooperation with the fixing position 1361 to press an end of the cordage 900, so that the end of the cordage 900 is more firmly fixed under the pressing of the cordage pressing block 137 and the fixing position 1361, thereby preventing the cordage 900 from loosening during the winding process of the winding reel 130. At the same time, cooperation mode between the cordage pressing block 137 and the fixing position 1361 also enables the fixing of the cordage 900 more convenient and efficient.

Further, the fixing position 1361 may be configured in a groove shape, recessed from the outer peripheral wall of the reel body 136 toward an axis of the reel body 136. The shape of the cordage pressing block 137 may be adapted to a recessed shape of the fixing position 1361, that is, the cordage pressing block 137 may be tightly buckled in the fixing position 1361, which can avoid affecting rotation of the reel body 136 and the winding of the cordage 900 on the reel body 136.

When mounting the cordage 900, the end of the cordage 900 may be placed in the fixing position 1361, and then the cordage pressing block 137 is buckled on the fixing position 1361, so that the cordage 900 can be firmly pressed between the cordage pressing block 137 and the fixing position 1361, ensuring more stable fixing of the cordage 900. At the same time, the fixing end of the cordage 900 can be also hidden between the cordage pressing block 137 and the fixing position 1361, preventing the fixing end of the cordage 900 from knotting with the cordage 900 during subsequent winding process and affecting the rotation of the winding reel 130.

Referring to FIGS. 48-50, in some embodiments, the fixing position 1361 is located at an end portion of a peripheral wall of the reel body 136, and the cordage pressing block 137 is mounted in alignment with the fixing position 1361.

Thus, the cordage 900 can be arranged from one end of the winding reel 130 to the other end during winding, so that the cordage 900 is arranged more evenly on the winding reel 130, avoiding cordage entanglement when winding or unwinding of the cordage 900.

Specifically, the fixing position 1361 may be formed at an end portion of the outer peripheral wall of the reel body 136, and thus the end of the cordage 900 will be fixed at a side of an end portion of the reel body 136. When winding, the cordage 900 can be wound from one end of the fixing position 1361 of the reel body 136 to the other end, and the cordage 900 can be evenly and tightly arranged on the winding reel 130.

In an embodiment of the present disclosure, a length of the cordage 900 may be set to a length of one layer arranged from one end of the reel body to the other end, so that the cordage 900 is not easy to be knotted or entangled when arranged. Of course, when the cordage 900 is relatively long, the cordage 900 may also be arranged from one end of the reel body 136 to the other end in one layer, and then wound back to form a second layer. Since the cordage 900 is wound more tightly in a first layer, the second layer can also better avoid entanglement and knotting with the first layer when the second layer is wound.

In other embodiments, the fixing position 1361 may be located at any position on the outer peripheral wall of the reel body 136, and the present disclosure does not limit an opening position of the fixing position 1361 on the reel body 136.

Referring to FIGS. 48-50, in some embodiments, a pressing block cordage groove 1373 is provided on the fixing position 1361 and/or the cordage pressing block 137. The pressing block cordage groove 1373 is configured to accommodate the cordage 900, and the cordage pressing block 137 and/or the fixing position 1361 press the cordage 900 in the pressing block cordage groove 1373.

Thus, the end of the cordage 900 can be placed in the pressing block cordage groove 1373 and then pressed by the cordage pressing block 137, making installation of the cordage 900 more convenient and preventing the end of the cordage 900 from shifting randomly during pressing.

Specifically, the pressing block cordage groove 1373 may be provided on the fixing position 1361, or may be provided on the cordage pressing block 137, or may be provided on both the fixing position 1361 and the cordage pressing block 137. A depth of the pressing block cordage groove 1373 may be set according to the diameter of the cordage 900. When both the fixing position 1361 and the cordage pressing block 137 are provided with the pressing block cordage grooves 1373, a height of a cross-section enclosed by the two pressing block cordage grooves 1373 may be set according to the diameter of the cordage 900. When fixing the cordage 900, the end of the cordage 900 can be first placed in the pressing block cordage groove 1373, and then the cordage pressing block 137 is mounted on the fixing position 1361, so that the end of the cordage 900 can be accurately pressed between the cordage pressing block 137 and the fixing position 1361 under the limitation of the pressing block cordage groove 1373, preventing the end of the cordage 900 from shifting randomly and not being pressed during pressing.

In some embodiments, the pressing block cordage groove 1373 is curved. Thus, the resistance to pulling the cordage 900 in a cordage groove is improved, and the curved pressing block cordage groove 1373 can provide a greater fixing force to the cordage 900 at a curved position. After the cordage pressing block 137 presses the cordage 900, the cordage 900 can be more stable and more firmly fixed in the pressing block cordage groove 1373. For example, the pressing block cordage groove 1373 may be in an arc shape, a ring shape, a S shape, etc. The present disclosure does not limit this.

Referring to FIGS. 48-50, in some embodiments, the fixing position 1361 is provided with a second mounting position 1362, and when the cordage pressing block 137 is mounted on the reel body 136, the pressing block cordage groove 1373 is arranged around the second mounting position 1362.

Thus, the cordage pressing block 137 can be mounted in cooperation with the second mounting position 1362 on the fixing position 1361. The pressing block cordage groove 1373 arranged around the second mounting position 1362 can not only be curved to enhance fixing the stability of the cordage 900, but also reduce an opening area of the fixing position 1361 on the reel body 136, making installation more convenient. In addition, when the pressing block cordage groove 1373 is arranged around the second mounting position 1362, and the cordage pressing block 137 is fixed through the second mounting position 1362, pressure provided by the second mounting position 1362 can better act on the pressing block cordage groove 1373, so as to press the cordage through the pressing block cordage groove 1373.

Specifically, the second mounting position 1362 may be located in a middle position inside a groove of the fixing position 1361, and correspondingly, a middle part of the cordage pressing block 137 may be provided with a structure matching with the second mounting position 1362, so that the cordage pressing block 137 can be mounted and fixed with the second mounting position 1362. The pressing block cordage groove 1373 can be arranged around the second mounting position 1362, which not only increases a length of the end of the cordage 900 in the pressing block cordage groove 1373, but also can increase the friction force of the cordage 900 in the pressing block cordage groove 1373 by curving and placing the cordage 900 in the pressing block cordage groove 1373. Furthermore, the second mounting position 1362 can provide better pressing force for the pressing block cordage groove 1373, so that the cordage 900 can be mounted more firmly and stably.

Referring to FIGS. 48-50, in some embodiments, a second mounting position 1362 is provided on the fixing position 1361, a screw hole 1363 is opened on the second mounting position 1362, and a cordage pressing block through hole 1371 corresponding to the screw hole 1363 is opened on the cordage pressing block 137. The cordage pressing block 137 is fixed on the fixing position 1361 by passing a screw through the cordage pressing block through hole 1371 and screwing the screw into the screw hole 1363.

Thus, the cordage pressing block 137 can press the cordage 900 by cooperating with the screw hole 1363 on the mounting position, which has a strong fixing effect, and is convenient for installation and disassembly, and facilitates replacement of the cordage 900.

Specifically, the second mounting position 1362 may be formed in a middle position inside a groove of the fixing position 1361 and may be in a boss-like structure. At least one screw hole 1363 is provided on the second mounting position 1362, and the number and the position of the screw hole 1363 may be selected according to size of the second mounting position 1362. The present disclosure does not limit the shape of the second mounting position 1362 and the number and the position of the screw hole 1363 provided on the second mounting position 1362.

Correspondingly, a cordage pressing block through hole 1371 corresponding to the position and the number of the screw hole 1363 may be provided on the cordage pressing block 137. A screw passes through the cordage pressing block through hole 1371 and is screwed into the screw hole 1363 to fix the cordage pressing block 137 on the fixing position 1361, thereby pressing the cordage 900 between the cordage pressing block 137 and the fixing position 1361, which has a good fixing effect on the cordage 900, and is convenient for installation and disassembly of the cordage pressing block 137.

Referring to FIGS. 48-50, in some embodiments, a plurality of cordage pressing protrusions 1373a is provided on the fixing position 1361 and/or the cordage pressing block 137. The cordage pressing protrusions 1373a are arranged at intervals along an extending direction of the pressing block cordage groove 1373.

Thus, when the cordage pressing block 137 is mounted on the fixing position 1361, the cordage pressing protrusion 1373a can further press the cordage 900, improving the stability of the cordage 900 in the pressing block cordage groove 1373, enhancing fixing strength of the cordage 900, and preventing the cordage 900 from loosening.

Specifically, the cordage pressing protrusions 1373a may be provided on the fixing position 1361, or on the cordage pressing block 137, or on both the fixing position 1361 and the cordage pressing block 137. When the cordage pressing protrusion 1373a is provided on the fixing position 1361, if the pressing block cordage groove 1373 is provided on the fixing position 1361, the cordage pressing protrusion 1373a may be formed in the pressing block cordage groove 1373 on the fixing position 1361; if no pressing block cordage groove 1373 is provided on the fixing position 1361, the cordage pressing protrusion 1373a may be provided at a position corresponding to the pressing block cordage groove 1373 on the cordage pressing block 137, and a plurality of cordage pressing protrusions 1373a is arranged at intervals along the extending direction of the pressing block cordage groove 1373. When the cordage pressing protrusion 1373a is provided on the cordage pressing block 137, if the pressing block cordage groove 1373 is provided on the cordage pressing block 137, the cordage pressing protrusion 1373a may be provided in the pressing block cordage groove 1373; if no pressing block cordage groove 1373 is provided on the cordage pressing block 137, the cordage pressing protrusion 1373a may be formed at a position corresponding to the pressing block cordage groove 1373 on the cordage pressing block 137, and a plurality of cordage pressing protrusions 1373a is also arranged at intervals along the extending direction of the pressing block cordage groove 1373. Thus, when the cordage pressing block 137 is pressed tightly, the cordage pressing protrusion 1373a can better clamp the cordage 900 to prevent the cordage 900 from slipping off.

In some embodiments, when the cordage pressing protrusions 1373a are provided on both the fixing position 1361 and the cordage pressing block 137, the cordage pressing protrusion 1373a on the fixing position 1361 and the cordage pressing protrusion 1373a on the cordage pressing block 137 are arranged in a staggered manner, preventing the cordage 900 from being damaged due to excessive snapping by the cordage pressing protrusion 1373a, thereby avoiding interference with installation of the cordage pressing block 137 at the fixing position 1361 caused by alignment of the cordage pressing protrusion 1373a on the cordage pressing block 137 and the cordage pressing protrusion 1373a on the fixing position 1361. At the same time, the staggered arrangement of the cordage pressing protrusions 1373a above and below the cordage 900 increases snapping points for the cordage 900, further improving fixing effect of the cordage 900.

Referring to FIGS. 48-50, in some embodiments, the cordage pressing protrusion 1373a is a sheet-like structure, and a protruding direction of the cordage pressing protrusion 1373a is perpendicular to the extending direction of the pressing block cordage groove 1373. Thus, a contact point between the sheet-like cordage pressing protrusion 1373a and the cordage 900 is smaller, which can generate greater pressure on the cordage 900, improving the snapping effect of the cordage pressing protrusion 1373a on the cordage 900. The vertical arrangement can better press the cordage 900 in the pressing block cordage groove 1373.

In some embodiments, an arc-shaped notch 1373b is provided at a contact end of the cordage pressing protrusion 1373a that contacts the cordage 900. Thus, when the cordage pressing protrusion 1373a is pressed and contacted with the cordage 900, the arc-shaped notch 1373b can avoid damaging the cordage 900 after pressing, and play a certain protective role for the cordage 900 while fixing and pressing.

Specifically, the shape of the arc-shaped notch 1373b may be adapted to a thickness of the cordage 900. The arc-shaped notch 1373b of the cordage pressing protrusion 1373a on the fixing position 1361 may be provided at an end portion facing the cordage pressing block 137, and the arc-shaped notch 1373b of the cordage pressing protrusion 1373a on the cordage pressing block 137 may be provided at an end portion facing the fixing position 1361.

In some embodiments, the arc-shaped notch 1373b may be provided only on the cordage pressing protrusion 1373a on the fixing position 1361, or only on the cordage pressing protrusion 1373a on the cordage pressing block 137, so that the cordage pressing protrusion 1373a has a better snapping effect on the cordage 900. Of course, the arc-shaped notches 1373b may also be provided on the cordage pressing protrusion 1373a on the fixing position 1361 and on the cordage pressing protrusion 1373a on the cordage pressing block 137, which is not limited in the present disclosure.

Referring to FIGS. 48-50, in some embodiments, one of the fixing position 1361 and the cordage pressing block 137 is provided with a pressing block positioning protrusion 1372, and the other of the fixing position 1361 and the cordage pressing block 137 is provided with a pressing block positioning groove 1364, and the pressing block positioning protrusion 1372 and the pressing block positioning groove 1364 are arranged correspondingly.

Thus, when mounting the cordage pressing block 137, the cordage pressing block 137 can be positioned via the pressing block positioning protrusion 1372 and the pressing block positioning groove 1364, enabling accurate alignment of the cordage pressing block 137 and making installation more convenient and efficient.

Specifically, when a pressing block positioning protrusion 1372 is provided on the fixing position 1361, a pressing block positioning groove 1364 is provided on the cordage pressing block 137. When a pressing block positioning groove 1364 is provided on the fixing position 1361, a pressing block positioning protrusion 1372 is provided on the cordage pressing block 137. The number of the pressing block positioning protrusions 1372 may be at least one, and the number and the position of the pressing block positioning grooves 1364 correspond to those of the pressing block positioning protrusions 1372.

When installing the cordage pressing block 137, the pressing block positioning protrusion 1372 can be aligned with the pressing block positioning groove 1364 first, and then a bolt is tightened to fix. Thus, the cordage pressing block through hole 1371 on the cordage pressing block 137 and the screw hole 1363 on the fixing position 1361 are also aligned one by one, facilitating the bolt to pass through and tighten to fix the cordage pressing block 137.

Referring to FIGS. 48-50, in some embodiments, the fixing position 1361 includes a first connecting surface 1365 and a first side surface 1366 located on a side of the first connecting surface 1365, and the first connecting surface 1365 is configured to press the cordage 900.

The cordage pressing block 137 includes a second connecting surface 1374 opposite to the first connecting surface 1365, and a second side surface 1375 opposite to the first side surface 1366. The pressing block positioning protrusion 1372 and the pressing block positioning groove 1364 are respectively located on the first side surface 1366 and the second side surface 1375.

Thus, the pressing block positioning protrusion 1372 and the pressing block positioning groove 1364 located on the side surfaces of the fixing position 1361 and the cordage pressing block 137 can not only play a positioning role in installation and fixing of the cordage pressing block 137, but also play an auxiliary role in pressing the cordage to a certain extent.

Specifically, the first connecting surface 1365 may be a surface on the fixing position 1361 that corresponds to the cordage pressing block 137 for pressing the cordage, and the pressing block cordage groove 1373 and the second mounting position 1362 may be located on the first connecting surface 1365. The first side surface 1366 may be connected to the first connecting surface 1365 and form a certain angle with the first connecting surface 1365. The second connecting surface 1374 may be a surface on the cordage pressing block 137 that cooperates with the first connecting surface 1365 to press the cordage, and the pressing block cordage groove 1373 may also be formed on the second connecting surface 1374. The second side surface 1375 is connected to the second connecting surface 1374 and is opposite to the first side surface 1366 when the cordage pressing block 137 is mounted.

The pressing block positioning protrusion 1372 and the pressing block positioning groove 1364 may be respectively formed on the first side surface 1366 and the second side surface 1375. That is, the pressing block positioning protrusion 1372 may be formed on the first side surface 1366, and the pressing block positioning groove 1364 may be formed on the second side surface 1375; or the pressing block positioning protrusion 1372 may be formed on the second side surface 1375, and the pressing block positioning groove 1364 is formed on the first side surface 1366, which is not limited in the present disclosure.

When mounting the cordage pressing block 137, the pressing block positioning protrusion 1372 and the pressing block positioning groove 1364 can be aligned first, so that the second side surface 1375 of the cordage pressing block 137 is aligned with the first side surface 1366. Then, a snapping position of the pressing block positioning protrusion 1372 and the pressing block positioning groove 1364 is configured as a fulcrum and a positioning point, and a bolt is tightened to press the cordage pressing block 137, ensuring installation accuracy of the cordage pressing block 137 and providing a better fixing effect for the cordage 900.

Referring to FIGS. 48-50, in some embodiments, the cordage pressing block 137 includes a winding surface 1376. The winding surface 1376 is an arcuate surface and is tangent to an outer peripheral surface of the reel body 136.

Thus, when the cordage pressing block 137 is mounted on the fixing position 1361, the winding surface 1376 of the cordage pressing block 137 can be aligned with the outer peripheral surface of the reel body 136, so that the cordage pressing block 137 can press the cordage 900 without affecting the winding of the cordage 900 on the reel body 136.

Specifically, the winding surface 1376 is a surface of the cordage pressing block 137 opposite to the first connecting surface 1365. When the cordage pressing block 137 is mounted on the fixing position 1361, an edge of the winding surface 1376 is connected to an edge of the reel body 136 and is tangent to the peripheral surface of the reel body 136. That is, after the cordage pressing block 137 is mounted on the fixing position 1361 to press the cordage 900, the winding surface 1376 will not protrude or be recessed relative to the outer peripheral surface of the reel body 136. Therefore, when the cordage 900 is wound on the reel body 136, the cordage pressing block 137 will not affect the winding of the cordage 900, so that the cordage 900 can be wound more neatly.

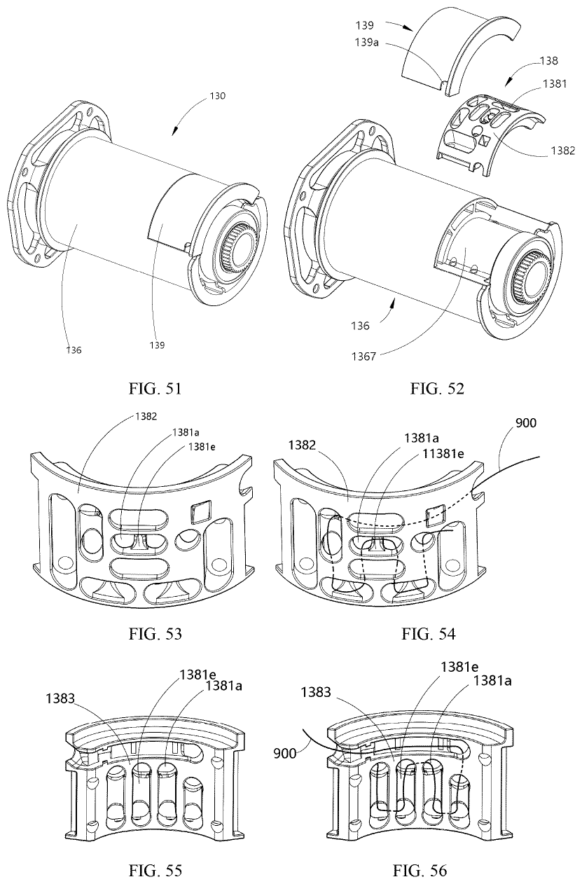

Referring to FIG. 51 and FIG. 52, in some embodiments, the winding reel 130 includes: a winding disc 138, which is provided with a plurality of winding positions 1381, and the plurality of winding positions 1381 is configured to wind an end of the cordage 900, so that the end of the cordage 900 is fixed to the winding disc 138; a reel body 136, the winding disc 138 is mounted on the reel body 136, and the reel body 136 is configured to wind the remaining portion of the cordage 900.

A winding apparatus in embodiments of the present disclosure includes a winding disc 138 and a reel body 136. In some embodiments, the winding disc 138 may be a cordage pressing block 137.

The winding disc 138 is provided with a plurality of winding positions 1381 for winding an end of the cordage 900, so that the end of the cordage 900 can be fixed to the winding disc 138, and then the remaining portion of the cordage 900 is wound on the reel body 136. Specifically, during winding, the cordage 900 can be regularly arranged along an axial direction of the reel body 136, so that the reel body 136 can rotate smoothly when the cordage 900 is pulled out or retracted. Thus, the arrangement of the winding positions 1381 enables an end of the cordage 900 to be fully wound and fixed on the winding disc 138, strengthens the connection between the cordage 900 and the winding disc 138, thereby improving the stability of the connection between the cordage 900 and the winding disc 138, and enhancing the safety performance of the winding apparatus.

It should be noted that the winding positions 1381 in embodiments of the present disclosure can enable the cordage 900 to turn multiple times when the cordage 900 passes through the plurality of winding positions 1381, and a turning angle is no less than 90 degrees, so that the cordage 900 can generate a large interaction force with the winding disc 138 at the winding positions 1381. As a result, the cordage 900 can be tortuously wound on the winding disc 138, is not easy to fall off, and has higher stability.

Referring to FIGS. 53-56, in some embodiments, the winding disc 138 includes a third side surface 1382 and a fourth side surface 1383 opposite to each other, and the plurality of winding positions 1381 includes a plurality of threading holes 1381a arranged at intervals, and the threading hole 1381a is in communication with the third side surface 1382 and the fourth side surface 1383; and the threading hole 1381a is configured for the cordage 900 to pass through. After the cordage 900 passes through the threading holes 1381a, the cordage 900 can be wound on the winding disc 138. Specifically, the passed cordage 900 will be partially located on the third side surface 1382 and partially located on the fourth side surface 1383, and even the cordage can form a staggered arrangement on the third side surface 1382 and/or the fourth side surface 1383, thereby strengthening connection and fixation between the cordage 900 and the winding disc 138.

Referring to FIG. 53 and FIG. 54, in some embodiments, the winding position 1381 includes a plurality of cordage channels 1381e provided on the third side surface 1382 of the winding disc 138, and both ends of the cordage channel 1381e are in communication with two of the threading holes 1381a on the third side surface 1382. Thus, the cordage channels 1381e can play a role in accommodating the cordage 900, so as to reduce protrusion of the cordage 900 on the third side surface 1382 of the winding disc 138 after the cordage 900 is wound on the winding disc 138.

Referring to FIG. 55 and FIG. 56, in some embodiments, the winding position 1381 further includes a plurality of cordage channels 1381e provided on the fourth side surface 1383 of the winding disc 138, and both ends of the cordage channels 1381e are in communication with two of the threading holes 1381a on the fourth side surface 1383. Thus, the cordage channels 1381e can also play a role in accommodating the cordage 900, so as to reduce protrusion of the cordage 900 on the fourth side surface 1383 of the winding disc 138 after the cordage 900 is wound on the winding disc 138.

Referring to FIGS. 54-56, in some embodiments, some cordage channels 1381e may extend longitudinally, and other cordage channels 1381e may extend transversely, thereby achieving a turning angle of the cordage 900 equal to 90 degrees, so that the cordage 900 can be firmly wound on the winding disc 138, and the winding of the cordage 900 can also be more regular, facilitating later disassembly or replacement of the cordage 900. Referring to FIGS. 54 to 56, in some embodiments, the cordage channel 1381e may be a groove provided on the third side surface 1382 and/or the fourth side surface 1383. Of course, in other embodiments, the cordage channel 1381e may also be a channel enclosed by a convex plate 1381b.

In some embodiments, the winding disc 138 is arc-shaped, the reel body 136 is provided with a first mounting position 1367, and the winding disc 138 is mounted on the first mounting position 1367; and/or the output device further includes a protective cover 139, the protective cover 139 is covered on the winding disc 138, and the protective cover 139 is further provided with a protective cover outlet 139a for the cordage 900 to pass through; an outer side of the winding disc 138 or an outer side of the protective cover 139 is tangent to an outer peripheral surface of the reel body 136. For example, referring to FIG. 51, the first mounting position 1367 is a recessed structure on a surface of the reel body 136, and installation of the winding disc 138 on the first mounting position 1367 can prevent the winding disc 138 from protruding from the outer peripheral surface of the reel body 136, and arc-shaped structure of the winding disc 138 can enable the outer side of the winding disc 138 tangent to the outer peripheral surface of the reel body 136, so that the winding disc 138 mounted on the first mounting position 1367 will not affect the winding of the cordage 900 on the reel body 136. In some embodiments, a winding apparatus further includes a protective cover 139, which can protect the winding disc 138 and the cordage 900 wound on the winding disc 138. After the cordage 900 is wound and fixed on the winding disc 138, the cordage 900 passes through the protective cover outlet 139a of the protective cover 139 and then is wound on the outer wall of the reel body 136. In addition, the outer side of the protective cover 139 can also be tangent to the outer peripheral surface of the reel body 136, so that the protective cover 139 will not affect the winding of the cordage 900 on the reel body 136.

In some embodiments, a protective cover positioning protrusion is provided on a side of the protective cover 139 facing the winding disc 138/the first mounting position 1367, and a protective cover positioning groove is provided on the winding disc 138. The protective cover positioning protrusion and the protective cover positioning groove are arranged correspondingly, which can provide positioning for installation of the protective cover 139. At the same time, the protective cover positioning groove can also be provided on the first mounting position 1367, or on both the first mounting position 1367 and the winding disc 138.

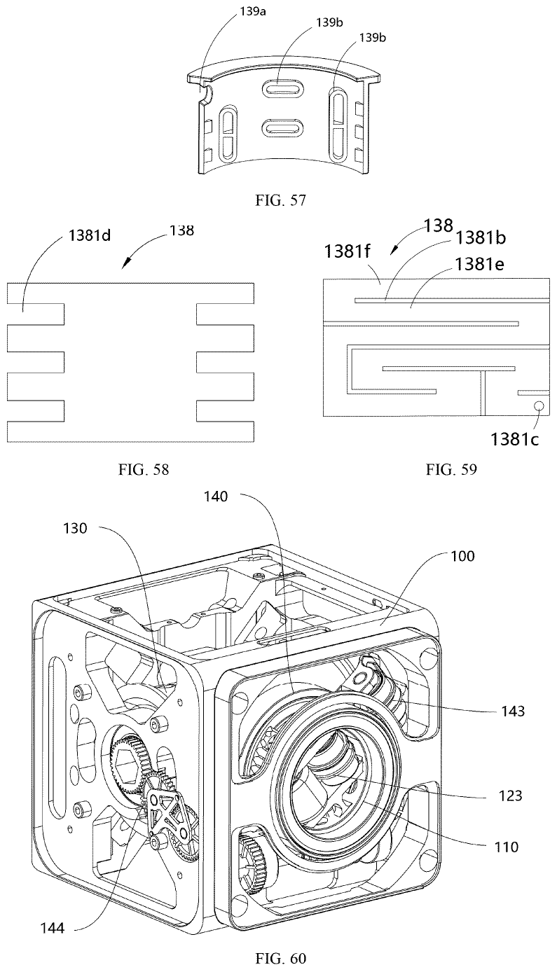

Referring to FIG. 57, in some embodiments, a side of the protective cover 139 facing the winding disc 138 is provided with a first protruding portion 139b, and the first protruding portion 139b is configured to press the cordage 900. Specifically, an arrangement position of the first protruding portion 139b is matched with a winding position of the cordage 900. Thus, when the protective cover 139 is closed, the first protruding portion 139b can further press the cordage 900 in the cordage channel 1381e, so as to further prevent the cordage 900 from loosening and falling off.

In some examples, after the cordage 900 is wound and fixed on the winding disc 138, the winding disc 138 can be fixed to the reel body 136 by a screw. After the protective cover 139 is covered on the winding disc 138, the winding disc 138 can also be fixed to the reel body 136 by a screw or a snap.

In some embodiments, a second protruding portion is provided on a side of the first mounting position 1367 facing the winding disc 138, and the second protruding portion is configured to press the cordage 900. Specifically, an arrangement position of the second protruding portion is matched with a winding position of the cordage 900. Thus, when the winding disc 138 is fixed in the first mounting position 1367, the second protruding portion will press the cordage 900 in the cordage channel 1381e.

In addition, in some embodiments, when the protective cover 139 also covers the winding disc 138, the winding disc 138 can be fully fixed in the first mounting position 1367, and a first side and a second side of the winding disc 138 can be respectively pressed against by the protective cover 139 and the reel body 136. At the same time, the cordage 900 in the cordage channel 1381e is respectively pressed by the first protruding portion 139b and/or the second protruding portion.

Specifically, referring to FIG. 54 and FIG. 56, when in use, the user passes an end of the cordage 900 through a plurality of threading holes 1381a in sequence, and the cordage 900 is correspondingly accommodated in a plurality of cordage channels 1381e; then the winding disc 138 with the cordage 900 wound thereon is mounted in the first mounting position 1367 by a screw or a snap-fit, and the second protruding portion on the first mounting position 1367 presses and fixes the cordage 900 in the cordage channel 1381e on the fourth side surface 1383. Then, the protective cover 139 is covered on the winding disc 138, and the remaining portion of the cordage 900 passes through the protective cover outlet 139a of the protective cover 139, then the protective cover 139 is mounted on the reel body 136 by a screw or a snap-fit. At this time, the first protruding portion 139b on the protective cover 139 presses and fixes the cordage 900 in the cordage channel 1381e on the third side surface 1382, and finally, the remaining portion of the cordage 900 is wound on the outer wall of the reel body 136.

Referring to FIG. 58, in some embodiments, the winding position 1381 includes a plurality of notches 1381d opened on opposite sides of the winding disc 138 for allowing the end portion of the cordage 900 to be wound in sequence. It can be understood that, in an embodiment, the winding disc 138 can be in a fishbone-like structure. When winding the cordage 900, the user passes the cordage 900 through a notch 1381d at one end of the winding disc 138, and then through another notch 1381d at the opposite end of the winding disc 138. Thus, the cordage 900 is repeatedly passed through the notches 1381d at the opposite ends, so that the cordage 900 can be wound on the winding disc 138. In some embodiments, the cordage 900 is wound on the winding disc 138 multiple times, and some of the cordages 900 can be staggered and overlapped, so that the cordage 900 wound on an outer ring may also squeeze the cordage 900 on an inner ring, thereby further making the cordage 900 wound on the winding disc 138 more stable and firm.

In some embodiments, a cordage channel 1381e can also be provided between adjacent notches 1381d, for example, a groove is provided so that the winding of the cordage 900 does not protrude from a surface of the winding disc 138.

Referring to FIG. 59, in some embodiments, the winding disc 138 includes a third side surface 1382 and a fourth side surface 1383 opposite to each other. At least one cordage channel 1381e is provided on the third side surface 1382 and/or the fourth side surface 1383 of the winding disc 138 for accommodating the cordage 900. Referring to FIG. 59, in some embodiments, the winding disc 138 further includes a base plate 1381f and a plurality of convex plates 1381b provided on the base plate 1381f and protruding toward the third side surface 1382 or the fourth side surface 1383, and the cordage channel 1381e is formed between the plurality of convex plates 1381b. The cordage 900 can be staggeredly wound and fixed on the plurality of convex plates 1381b through the cordage channel 1381e. In other embodiments, the winding disc 138 may also be provided with a through slot on the third side surface 1382 and/or the fourth side surface 1383, and the through slot forms the cordage channel 1381e.

In some embodiments, the cordage channel 1381e is arranged in a zigzag manner, so that the cordage 900 can form a bent or curved path when passing through the cordage channel 1381e, and can be wound on the winding disc 138 in a more curved or staggered manner, resulting in a firmer winding.

In some embodiments, at least one cordage channel 1381e is respectively provided on the third side surface 1382 and the fourth side surface 1383 of the winding disc 138. The winding disc 138 is also provided with at least one through hole 1381c or at least one notch 1381d on a side for communicating the cordage channels 1381e on the third side surface 1382 and the fourth side surface 1383. Thus, after the cordage 900 is wound on the winding disc 138 on the third side surface 1382, the cordage 900 can pass through the through hole 1381c to the fourth side surface 1383, so that the cordage 900 can continue to be wound on the fourth side surface 1383. In some embodiments, the winding disc 138 may not be provided with a through hole 1381c, but at least one notch 1381d is provided on the side. When the cordage 900 is wound on the third side surface 1382, the cordage 900 may be wound from the notch 1381d of the winding disc 138 to the fourth side surface 1383.

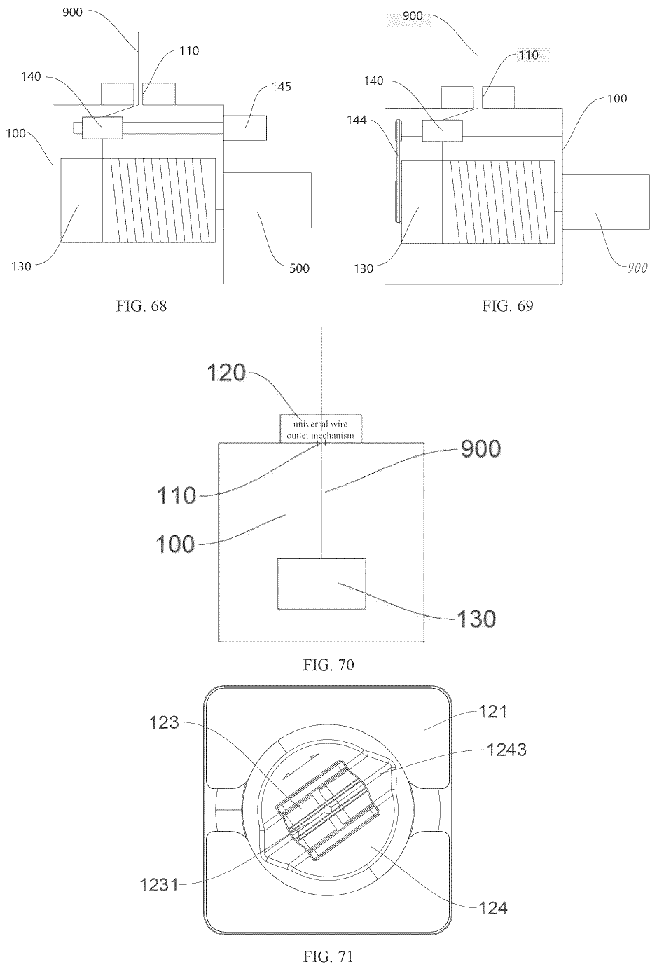

Referring to FIGS. 60-69, in an embodiment of the present disclosure, a cordage arranging mechanism 140 is disclosed, which is arranged in the cordage box 100, including a winding reel 130, a cordage arranging mechanism 140 and a linkage mechanism 144. The winding reel 130 is rotatably disposed on the cordage box 100, and the cordage arranging mechanism 140 is movably disposed on the cordage box 100. The linkage mechanism 144 is connected to the winding reel 130 and the cordage arranging mechanism 140, and enables the winding reel 130 and the cordage arranging mechanism 140 to be linked. When in use, the cordage 900 is wound on the winding reel 130, an end of the cordage 900 is fixed on the winding reel 130, and the other end passes through the cordage arranging mechanism 140 and passes out of the cordage box 100 from a cordage box outlet 110.

During operation, taking unwinding as an example, the cordage 900 is pulled, and at the same time, the winding reel 130 rotates to unwind. The winding reel 130 rotates to drive the cordage arranging mechanism 140 to move via the linkage mechanism 144, and the cordage arranging mechanism 140 moves synchronously with an unwinding position of the cordage 900 on the winding reel 130. For example, if the cordage 900 on the winding reel 130 is wound from left to right, the unwinding position of the cordage 900 is from the right to the left, and the cordage arranging mechanism 140 moves synchronously from the right to the left, that is, a movement direction of the cordage arranging mechanism 140 is consistent with an unwinding direction of the cordage 900 on the winding reel 130, so that the cordage 900 on the winding reel 130 can be guided by the cordage arranging mechanism 140, thereby achieving orderly unwinding. The cordage 900 after unwinding passes out of the cordage box 100 from the cordage box outlet 110, maintaining stable unwinding at a fixed position. Taking winding as an example, the winding reel 130 rotates to drive the cordage 900 to unwind, and at the same time, the winding reel 130 drives the cordage arranging mechanism 140 to move via the linkage mechanism 144. At this time, the cordage arranging mechanism 140 moves synchronously with a cordage arranging position of the cordage 900 on the winding reel 130. For example, if the cordage 900 on the winding reel 130 is wound from left to right, the cordage arranging position of the cordage 900 is from the left to the right, and the cordage arranging mechanism 140 moves synchronously from the left to the right, that is, the movement direction of the cordage arranging mechanism 140 is consistent with a cordage arranging direction of the cordage 900 on the winding reel 130, so that the cordage 900 retracted through the cordage box outlet 110 can be guided by the cordage arranging mechanism 140, thereby achieving orderly cordage arranging. The cordage 900 after cordage arranging is stably arranged on the winding reel 130, and the cordage 900 that has not been arranged is retracted in sequence at a fixed position 1361 of the cordage box outlet 110.

By configuring the linkage mechanism 144 and the cordage arranging mechanism 140, ordered arrangement and unwinding of the cordage 900 on the winding reel 130 can be automatically achieved by utilizing the rotation of the winding reel 130 when the winding reel 130 unwinds. At the same time, the cordage box outlet 110 located at the fixed position 1361 of the cordage box 100 can prevent the cordage leaving the winding reel 130 from being affected by the cordage arranging mechanism 140.

In some embodiments, as shown in FIG. 69, the present disclosure also discloses a cordage arranging and winding mechanism, and the cordage arranging and winding mechanism includes a cordage box 100, a winding reel 130, a cordage arranging mechanism 140 and a power mechanism 145. The winding reel 130 is rotatably arranged on the cordage box 100, the cordage arranging mechanism 140 is movably arranged on the cordage box 100, and the power mechanism 145 is configured to drive the cordage arranging mechanism 140 to move. When in use, the cordage 900 is wound on the winding reel 130, an end of the cordage 900 is fixed on the winding reel 130, and the other end passes through the cordage arranging mechanism 140 and passes through the cordage box 100 from the cordage box outlet 110.

During operation, when the winding reel 130 unwinds or winds the cordage, the power mechanism 145 drives the cordage arranging mechanism 140 to move in the same direction. For example, the cordage 900 is wound from left to right. When the winding reel 130 and the winding reel 130 unwinds, an unwinding direction is from right to left. At this time, the power mechanism 145 drives the cordage arranging mechanism 140 to move from right to left, so as to guide the cordage 900 at an unwinding position through the cordage arranging mechanism 140, enabling the cordage 900 to smoothly pass through the cordage box outlet 110. For example, the cordage 900 is wound from left to right of the winding reel 130. When the winding reel 130 arranges the cordage, an arranging direction is from left to right. At this time, the power mechanism 145 drives the cordage arranging mechanism 140 to move from left to right, ensuring that the cordage 900 can not be repeatedly arranged with each other, and preventing the cordage 900 from being entangled and knotted on the winding reel 130.

By configuring the power mechanism 145 and the cordage arranging mechanism 140, the power mechanism 145 can be configured to drive the cordage arranging mechanism 140 to move when the winding reel 130 unwinds and arranges the cordage, so as to achieve ordered arrangement and unwinding of the cordage 900 on the winding reel 130. At the same time, the cordage box outlet 110 located at the fixed position 1361 of the cordage box 100 can prevent the cordage leaving the winding reel 130 from being affected by the cordage arranging mechanism 140, or enable the irregular cordage 900 to be unwound orderly at the fixed position 1361 and then arranged neatly on the winding reel 130.

The concept of the cordage box 100 only refers to providing installation and positioning for the winding reel 130, the cordage arranging mechanism 140, the linkage mechanism 144, the power mechanism 145 and the cordage box outlet 110. The cordage box 100 can be a single component or a combination of a plurality of components fixed to each other. The movement of the cordage arranging mechanism 140 in the present disclosure can be translation or pivoting, which is not limited in the present disclosure. The linkage mechanism 144 can be a gear transmission via a gear set, or a belt transmission or a chain transmission, or a worm 1443/worm gear transmission, or a crank-slider mechanism, or a crank rocker mechanism or other contact transmission modes, or a non-contact force transmission (for example, through magnetic transmission, etc.); and any transmission mode in the related art is included therein. The power mechanism 145 can be a motor 500, or an electric push shaft, or other mechanical motion power sources such as hydraulic or pneumatic power sources, which can also include a transmission mechanism for transmitting power from the power source to the cordage arranging mechanism 140, and any power source or any integrated assembly of a power source and a transmission mechanism in the related art that can transmit power to the cordage arranging mechanism 140 for movement is included.

In some embodiments, as shown in FIGS. 60-64, the cordage arranging mechanism 140 is pivotably arranged on the cordage box 100, and a pivot point of the cordage arranging mechanism 140 is the cordage box outlet 110. Since the cordage arranging mechanism 140 pivots about the cordage box outlet 110, a distance between a position where the cordage 900 passes through the cordage arranging mechanism 140 and the cordage box outlet 110 is constant, that is, the cordage arranging mechanism 140 pivots to any position without affecting transmission of this section of the cordage 900, improving the stability of the cordage arranging mechanism 140.

In some embodiments, the cordage arranging mechanism 140 includes a pivoting seat 1411 and a cordage guiding arm 1412 connected to each other. The pivoting seat 1411 is rotatably disposed on the cordage box 100 around the cordage box outlet 110, and the cordage guiding arm 1412 is configured for the cordage 900 to pass through. An angle detection mechanism for detecting a pivot angle of the cordage arranging mechanism 140 is also provided. The pivot angle of the cordage arranging mechanism 140 can be calculated via a pivot angle detection apparatus 1413. Since a transmission ratio of the linkage mechanism 144 and the diameter of the winding reel 130 are both constants, the number of revolutions of the winding reel 130 can be obtained by calculating the pivot angle, and then working status of unwinding and winding can be obtained, such as working progress of unwinding or winding and arranging, or a length of the cordage 900 that has been wound or unwound, etc.

In some embodiments, as shown in FIG. 63, the pivot angle detection apparatus 1413 may include a magnetic ring 1414 provided on the pivoting seat 1411, that is, when the pivoting seat 1411 rotates, a pivoting Hall sensor 1416 fixed on the cordage box 100 can detect the change of magnetic field strength, and the pivot angle of the pivoting seat 1411 can be obtained according to magnitude of the magnetic field strength; as shown in the figure, the pivot angle detection apparatus 1413 can also be a magnetic member 1415 provided on the cordage guiding arm 1412 and a pivoting Hall sensor 1416 provided on the cordage box 100. When the cordage guiding arm 1412 rotates with the pivoting seat 1411, the pivoting Hall sensor 1416 fixed on the cordage box 100 can also sense the change of magnetic field strength, and the pivot angle of the pivoting seat 1411 and the cordage guiding arm 1412 can be obtained according to magnitude of the magnetic field strength.

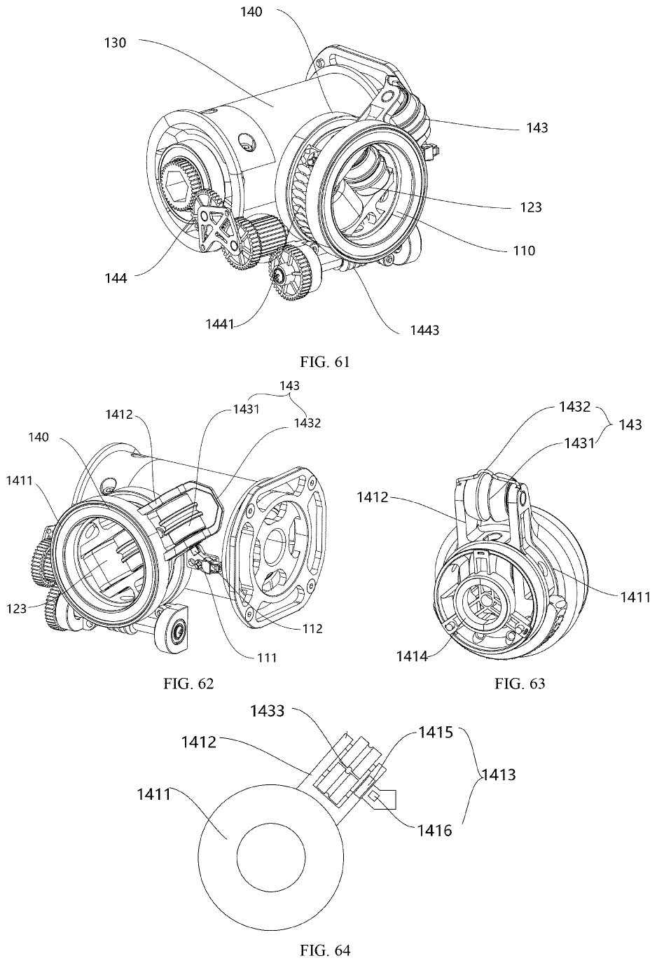

In some embodiments, as shown in FIGS. 61-62, the linkage mechanism 144 includes a self-locking worm wheel 1441 and a worm 1443. The winding reel 130 drives the worm 1443 on the pivoting seat 1411 to rotate through the worm 1443. By utilizing the self-locking effect of the self-locking worm wheel 1441 and the worm 1443, one-way transmission of the worm 1443 to the worm wheel can be achieved, and self-locking of the worm wheel to the worm 1443 can be achieved at the same time, which can prevent the pivoting seat 1411 from rotating incorrectly due to gravity, impact or other reasons and thus driving the winding reel 130 to rotate for unwinding.

The self-locking worm wheel 1441 includes a complete full-circle worm wheel, or may also be an incomplete partial worm wheel, as long as the arrangement of worm wheel teeth of the worm wheel satisfies the pivoting stroke.

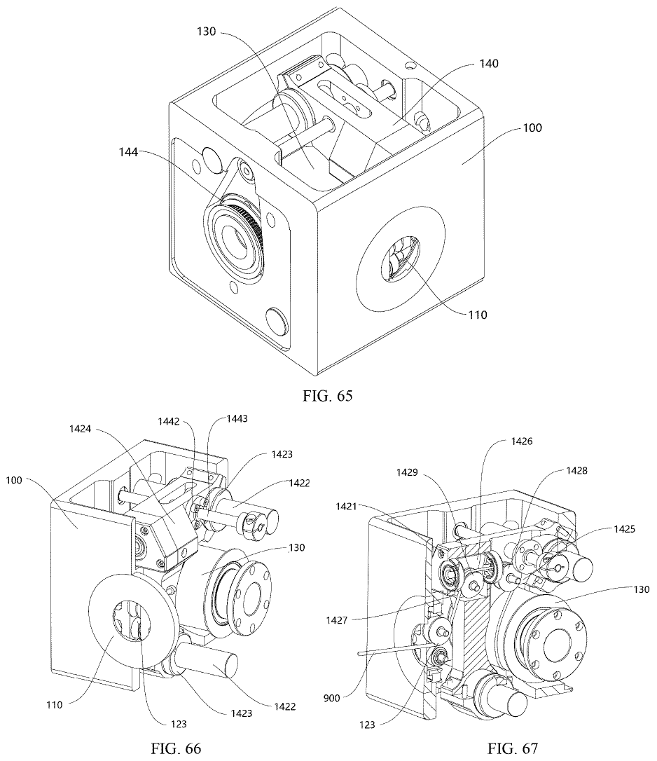

In some embodiments, as shown in FIGS. 65-67, the cordage arranging mechanism 140 is slidably disposed on the cordage box 100, and a sliding direction is parallel to an axial direction of the winding reel 130. When the winding reel 130 unwinds or winds and arranges the cordage, the movement of an unwinding position and an arranging position is parallel to an axis of the winding reel 130. By configuring the cordage arranging mechanism 140 in the same direction, the unwinding position, the arranging position and the cordage arranging mechanism 140 remain relatively stationary during unwinding or winding and arranging, further improving stability.

In some embodiments, as shown in FIG. 66, the cordage arranging mechanism 140 includes a sliding seat 1421 slidably disposed on the cordage box 100, and a cordage guiding mechanism 1424 disposed on the sliding seat 1421 and configured for the cordage 900 to pass through. A smooth shaft 1422 is disposed on the cordage box 100 along a direction parallel to an axial direction of the winding reel 130, and the sliding seat 1421 slides on the smooth shaft 1422 through a linear bearing 1423. The arrangement of the smooth shaft 1422 and the linear bearing 1423 can reduce the sliding resistance of the sliding seat 1421, improve the sliding precision of the sliding seat 1421. At the same time, the smooth shaft 1422 and the linear bearing 1423 can provide stable support for the sliding seat 1421. In some embodiments, there are at least two smooth shafts 1422 and at least two sliding seats 1421, and the two sets of smooth shafts 1422 can provide more stable support for the cordage box 100.

In some embodiments, the linkage mechanism 144 includes a worm 1443 and a self-locking worm gear nut 1442, The worm 1443 is in transmission connection with the winding reel 130, and the worm gear nut is disposed on the sliding seat 1421. Rotation of the winding reel 130 drives the worm 1443 to rotate, thereby driving the self-locking worm gear nut 1442 and the sliding seat 1421 to translate along the worm 1443. The self-locking worm gear nut 1442 can also achieve one-way transmission from the worm 1443 to the self-locking worm gear nut 1442, and achieve self-locking of the self-locking worm gear nut 1442 to the worm 1443 at the same time, thereby preventing the sliding seat 1421 from rotating incorrectly due to gravity, impact or other reasons and thus driving the winding reel 130 to rotate for unwinding.

In some embodiments, as shown in FIG. 67, the cordage guiding mechanism 1424 includes a cordage arranging port 1425 disposed on the sliding seat 1421, a rotating seat 1426 located at a rear side of the cordage arranging port 1425 and rotatably disposed on the sliding seat 1421 around an outgoing direction of the cordage arranging port 1425. The rotating seat 1426 is provided with a threading channel along a rotating axis direction, and a direction-changing port 1427 disposed on the rotating seat 1426 and communicated with the threading channel. The direction-changing port 1427 is tangent to the rotating axis of the rotating seat 1426, and the cordage 900 sequentially passes through the cordage arranging port 1425, the threading channel and the direction-changing port 1427, and finally passes out from the cordage box outlet 110.

The cordage arranging port 1425 is disposed on the sliding seat 1421 opposite to the winding reel 130, and the cordage arranging port 1425 includes a cordage incoming direction entering from the winding reel 130 and a cordage outgoing direction leaving the cordage arranging port 1425 and entering the threading channel of the rotating seat 1426.

During operation, as the sliding seat 1421 slides along the smooth shaft 1422, positions of the cordage guiding mechanism 1424 and the cordage box outlet 110 will inevitably change, resulting in changes in a relative distance and a relative angle between the cordage guiding mechanism 1424 and the cordage box outlet 110. In an embodiment, by providing the rotating seat 1426 and utilizing the tension on the cordage 900, the rotating seat 1426 can adaptively adjust an angle with the change in a relative position between the cordage guiding mechanism and the cordage box outlet 110, so that the direction-changing port 1427 of the rotating seat 1426 is always aligned with the cordage box outlet 110, thereby preventing cordage jumping phenomenon caused by excessive change in the relative position between the cordage guiding mechanism 1424 and the cordage box outlet 110.

In some embodiments, a first direction-changing wheel 1428 may further be disposed at the cordage arranging port 1425 in the cordage guiding mechanism 1424, and the first direction-changing wheel 1428 is tangent to the rotating axis direction of the rotating seat 1426. In some embodiments, a second direction-changing wheel 1429 may further be disposed at the direction-changing port 1427 in the cordage guiding mechanism 1424, and the second direction-changing wheel 1429 is tangent to the rotating axis direction of the rotating seat 1426, that is, by providing the first direction-changing wheel 1428 and the second direction-changing wheel 1429, sliding of the cordage 900 relative to the cordage guiding mechanism 1424 is converted into rolling, thereby reducing frictional resistance and wear.

In some embodiments, as shown in FIG. 67, a cordage outlet wheel 123 is disposed at the cordage box outlet 110, which can reduce the wear of the cordage 900 passing through the cordage box outlet 110. In some embodiments, the cordage outlet wheel 123 is a pair of wheels, and at least one of the cordage outlet wheels 123 is provided with rotational damping. By providing the rotational damping, the cordage 900 can have a certain tension when unwinding or winding and arranging, so that the cordage 900 is tightened. The rotational damping for the cordage outlet wheel 123 can be directly provided for rotation of the cordage outlet wheel 123.

In some embodiments, the transmission ratio of the linkage mechanism 144 can be reasonably set, so that when a coil 550 rotates one circle every time, the linkage mechanism 144 drives the threading port of the cordage arranging mechanism 140 to translate or pivot by a cordage 900 diameter, further improving precision of cordage arranging and unwinding.

In some embodiments, when the winding reel 130 rotates in the same direction, the linkage mechanism 144 drives the cordage arranging mechanism 140 to pivot or slide from one end of the winding reel 130 to the other end, achieving orderly unwinding or winding of the cordage 900 from one end to the other end of the winding reel 130. In some embodiments, as the length of the cordage 900 increases, it is necessary to make full use of the winding reel 130 to perform multi-layer cordage arrangement on the winding reel 130. At this time, when the winding reel 130 rotates in the same direction, the linkage mechanism 144 drives the cordage arranging mechanism 140 to pivot or slide back and forth between the two ends of the winding reel 130, so that when arranging each layer of cordage, the cordage arranging mechanism 140 can be configured for limited unwinding or winding from one end to the other end of the winding reel 130. The linkage mechanism 144 can adopt any transmission mechanism in the related art capable of achieving reciprocating motion (e.g., a cylindrical cam, an end cam, a crank-slider mechanism).

In some embodiments, as shown in FIG. 64, the cordage box 100 is further provided with a third limiting structure 111, and the third limiting structure 111 is configured to limit a limit position of the cordage arranging mechanism 140. The third limiting structure 111 limits the limit position of the movement of the cordage arranging mechanism 140, preventing incorrect cordage arranging of the cordage 900 caused by the cordage arranging mechanism 140 exceeding the limit position. In some embodiments, the third limiting structure 111 is further provided with a micro switch 112. When the cordage arranging mechanism 140 moves to the limit position, the micro switch 112 is triggered, and the micro switch 112 can send an electrical signal, which indicates that the cordage arranging mechanism 140 has moved to the third limiting structure 111. The electrical signal can be configured to warn the limit position of the cordage arranging mechanism 140 or make corresponding responses, such as stopping unwinding and arranging.

In some embodiments, as shown in FIGS. 60-64, the cordage arranging mechanism 140 includes a guiding mechanism 143, and the guiding mechanism 143 is configured for the cordage 900 to pass through. The guiding mechanism 143 can guide the cordage 900, and a cordage guiding wheel 1431 can be used in the guiding mechanism 143 to reduce friction and wear when the cordage 900 passes through the guiding mechanism 143. In some embodiments, the guiding mechanism 143 is further provided with a limiting frame 1432 in addition to the cordage guiding wheel 1431. The limiting frame 1432 can be a larger frame or a smaller frame that is shaped like the cordage 900. The limiting frame 1432 is configured to limit the cordage 900 on the cordage guiding wheel 1431, preventing the cordage 900 from contacting other structures except the cordage guiding wheel 1431. In some embodiments, as shown in FIG. 63, the guiding mechanism 143 includes a pair of cordage guiding wheels 1433, and each of the paired cordage guiding wheels 1433 is provided with a cordage groove. At this time, the cordage 900 passes through the cordage grooves at a tangent position of two cordage guiding wheels 1433. A space formed by two cordage grooves at the tangent position can limit a position of the cordage 900, preventing the cordage 900 from friction with other structures.

In some embodiments, a motion detection apparatus is further included, and the motion detection apparatus is configured to detect a current motion position of the cordage arranging mechanism 140. By detecting the current motion position of the cordage arranging mechanism 140 and combining with a pre-known parameter such as a transmission ratio of the linkage mechanism 144, the diameter of the winding reel 130, or the diameter of the cordage 900, it is possible to determine the number of revolutions of the winding reel 130 when unwinding or winding and arranging, a length of the cordage 900 when unwinding, a length of the cordage 900 when winding, and an arrangement position of the cordage 900 on the winding reel 130, etc. may be inferred.

Exemplarily, when the cordage arranging mechanism 140 pivots, the motion detection apparatus may be the magnetic ring 1414 or the magnetic member 1415 in some of the foregoing embodiments. When the cordage arranging mechanism 140 slides, the motion detection apparatus may include a magnetic member 1415 disposed on the sliding seat 1421, and a pivoting Hall sensor 1416 disposed on the cordage box 100. By detecting magnetic field strength of the magnetic member 1415 via the pivoting Hall sensor 1416, motion state of the sliding seat 1421 and the cordage arranging mechanism 140 can be known.

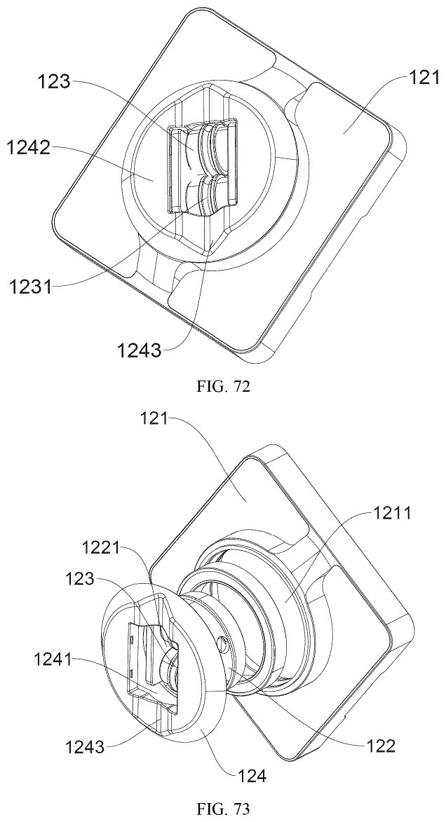

Referring to FIGS. 70-79, an embodiment of the present disclosure discloses a universal cordage outlet mechanism, which includes a base 121, a rotating seat 122, a cordage outlet wheel 123, and a cordage outlet seat 124. The base 121 is configured to connect with an output device, and a first channel 1211 is provided in the middle of the base 121. The rotating seat 122 is rotatably disposed on the base 121, and a second channel 1221 is opened on a central axis of the rotating seat 122, The second channel 1221 is in communication with the first channel 1211. The cordage outlet wheels 123 are arranged in pairs on the rotating seat 122, and the cordage outlet wheels 123 are arranged in pairs along a first direction. The middle of the paired cordage outlet wheels 123 is in communication with the second channel 1221. The cordage outlet seat 124 is provided on the rotating seat 122 and located on a side of the rotating seat 122 away from the base 121. The cordage outlet seat 124 is provided with a strip-shaped cordage outlet hole 1241, and the cordage outlet hole 1241 is arranged along the first direction. The first channel 1211, the second channel 1221, and the cordage outlet hole 1241 are sequentially communicated.

During operation, the cordage 900 passes through the first channel 1211 of the base 121, and then sequentially passes through the second channel 1221 and the cordage outlet hole 1241. When the cordage 900 is unwound or wound along a direction perpendicular to the first channel 1211, the cordage 900 will not interact with the cordage outlet wheel 123 or the cordage outlet seat 124, nor will the cordage 900 be worn. When a direction of unwinding or winding the cordage 900 changes, the cordage 900 will first rest on the cordage outlet seat 124 and interact with the cordage outlet seat 124. At this time, a component force of the cordage 900 acting on the cordage outlet seat 124 will drive the cordage outlet seat 124 to rotate. When the cordage outlet seat 124 rotates, a direction of the cordage outlet wheel 123 relative to the cordage 900 will also change. When the cordage outlet seat 124 rotates until the cordage 900 rests on the cordage outlet wheel 123, a stable cordage outlet state is entered. The cordage outlet seat 124 is no longer in contact with the cordage 900, and the cordage 900 will not generate a rotational component force on the cordage outlet seat 124. At this time, the projection of the cordage 900 on the cordage outlet seat 124 is the same as an arrangement direction of the cordage outlet wheel 123, both of which are the first direction, so that the cordage 900 can be stably unwinding or winding through the cordage outlet wheel 123.

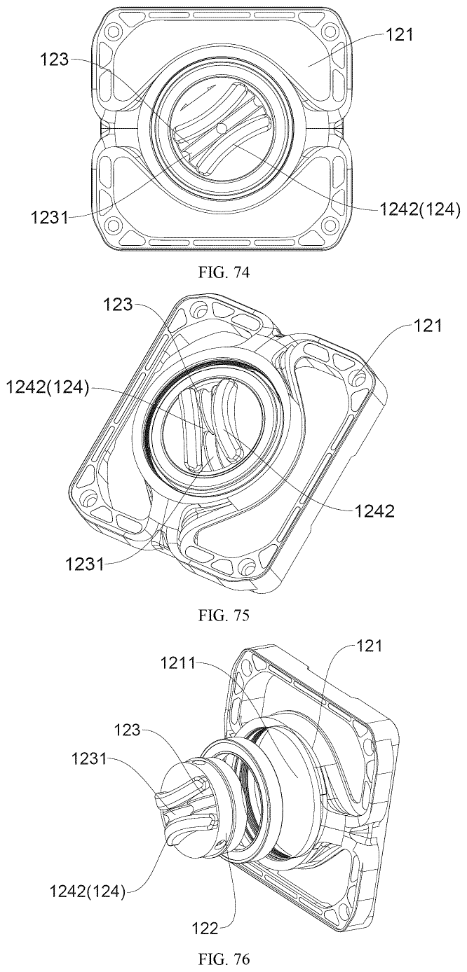

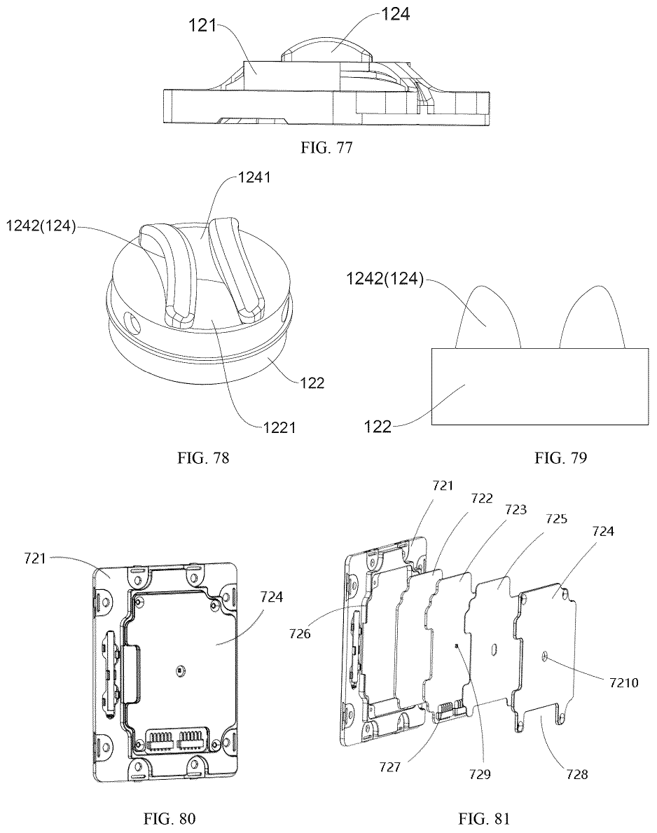

The division between the rotating seat 122 and the cordage outlet seat 124 is only a functional division, and they can be arranged separately or integrally formed, as shown in FIG. 71 or FIG. 74, the first direction is a direction perpendicular to an axis of the cordage outlet wheel 123 in a plane where axes of the paired cordage outlet wheel 123 are located, as shown in FIG. 77, the cordage outlet seat 124 covers the cordage outlet wheel 123 from the side, that is, with reference to a reference plane that passes through the first direction and is perpendicular to the plane where the axes of the cordage outlet wheel 123 are located, the projection of the cordage outlet seat 124 on the reference plane can cover the projection of the cordage outlet wheel 123 on the reference plane.

In some embodiments, a contour of the cordage outlet seat 124 can cover the cordage outlet wheel 123 on a side of the cordage outlet wheel 123. By providing the cordage outlet seat 124 covering the cordage outlet wheel 123, contact and friction between the cordage 900 and the cordage outlet wheel 123 before entering a stable cordage outlet state can be prevented. At this time, through direct contact between the cordage outlet seat 124 and the cordage 900, the cordage outlet seat 124 can be deflected in the first time, and the stable cordage outlet state where the cordage 900 rests on the cordage outlet wheel 123 for unwinding can be entered in advance.

In some embodiments, as shown in FIGS. 74-76, the cordage outlet seat 124 includes a cordage guiding block 1242, and the cordage guiding block 1242 is arranged in pairs on the rotating seat 122 along a second direction. The second direction is perpendicular to the first direction. The two cordage guiding blocks 1242 are respectively located on both sides of the paired cordage outlet wheels 123, and the cordage guiding block 1242 covers the cordage outlet wheel 123 from the side. A cordage outlet hole 1241 is formed between the two cordage guiding blocks 1242. The cordage outlet hole 1241 can be formed not only by directly opening on the cordage outlet seat 124, but also by providing two cordage guiding block 1242, and the cordage outlet hole 1241 is formed by the two cordage guiding block 1242. The cordage 900 is guided by the cordage guiding block 1242, so that the cordage 900 slides to both sides of the cordage guiding block 1242 under guidance of the cordage guiding block 1242, and finally rests on the cordage outlet wheel 123 for unwinding.

In some embodiments, as shown in FIG. 74, FIG. 78, and FIG. 79, the width of the cordage outlet hole 1241 gradually widens from the middle to both sides, that is, both sides of the cordage outlet hole 1241 form an arc. When the cordage 900 just rests in the middle of the cordage outlet hole 1241 of the cordage outlet seat 124, the cordage 900 will be in an unstable state and will be more likely to slide to both sides of the cordage outlet hole 1241. In some embodiments, the width of a middle portion of the cordage outlet hole 1241 is approximately the same as the diameter of the cordage 900, which ensures that the cordage 900 can pass over the middle part of the cordage outlet hole 1241, and at the same time, minimizes a size of the middle part of the cordage outlet hole 1241, reducing probability that the cordage 900 gets stuck in the middle part of the cordage outlet hole 1241.

In some embodiments, as shown in FIG. 77, the height of the cordage guiding block 1242 gradually decreases from the middle to both sides along the first direction. When the cordage 900 rests in the middle of the cordage guiding block 1242, the cordage 900 will also be in an unstable state, and thus more likely to slide along the first direction to the cordage outlet wheel 123 on one side, entering a stable cordage outlet state. In some embodiments, as shown in FIG. 79, the height of the cordage guiding block 1242 gradually increases from the middle to the edge of the cordage outlet seat 124 along the second direction, and a curved surface of the cordage guiding block 1242 extending in the second direction is disposed obliquely. When the cordage 900 rests on the cordage guiding block 1242, a bending angle of the cordage 900 is gentler, a length of interaction between the cordage 900 and the cordage guiding block 1242 increases, and interaction relative to the cordage guiding block 1242 decreases, so that the cordage 900 can more easily slide on the cordage guiding block 1242 along the first direction and pass through the cordage guiding block 1242 more easily. In some embodiments, as shown in FIG. 78, a paired gap of the cordage guiding blocks 1242 gradually decreases from the middle to both sides along the first direction, that is, opposite sides of the two cordage guiding block 1242 are both curved, and a spacing in the middle of the opposite sides is the smallest, and the spacing gradually increases from the middle to both sides, so that when the cordage rests in the middle of the cordage guiding block 1242, the cordage is in an unstable state and more likely to slide to the cordage outlet wheel 123 on one side along the first direction. In some embodiments, the middle distance of the cordage guiding blocks 1242 is approximately the same as the diameter of the cordage 900, which ensures that the cordage 900 can pass over the middle portions of the two cordage guiding block 1242, and at the same time, minimizes the gap between the middle parts of the two cordage guiding block 1242, reducing probability that the cordage 900 gets stuck in the middle parts of the two cordage guiding block 1242.

In some embodiments, the surface of the cordage guiding block 1242 is smoothly transitioned, so that the cordage 900 can be more easily guided by the cordage guiding block 1242 to slide onto the cordage outlet wheel 123. In some embodiments, the cordage guiding block 1242 or the cordage outlet seat 124 is made of metal. The cordage guiding block 1242 and the cordage outlet seat 124 made of metal have a low friction coefficient, which can better guide the cordage 900. The metal has a high hardness and is not easy to wear. At the same time, the metal has a good thermal conductivity and can timely dissipate heat generated by friction of the cordage 900.

In some embodiments, as shown in FIGS. 71-73, cordage outlet grooves 1243 are opened on both sides of the cordage outlet seat 124 along the first direction. For example, the cordage outlet groove 1243 is configured to avoid the cordage 900, so as to prevent unnecessary wear caused by friction between the cordage 900 and the cordage outlet seat 124 when the cordage 900 rests on the cordage outlet wheel 123. For example, the cordage outlet groove 1243 can also be configured to position the cordage 900, so as to improve accuracy of the cordage 900 resting on the cordage outlet wheel 123, that is, when the cordage 900 shifts on the cordage outlet wheel 123, the cordage outlet grooves 1243 can correct the cordage 900.

In some embodiments, at least one of the paired cordage outlet wheel 123 is provided with rotational damping, that is, by applying resistance to the cordage outlet wheel 123, the cordage 900 can maintain a minimum tension when unwinding or winding, thereby tensioning the cordage 900 and making process of unwinding or winding more stable.

In some embodiments, as shown in FIGS. 71-76, the cordage outlet wheel 123 is provided with an outlet wheel cordage groove 1231 circumferentially. The cordage outlet wheel cordage grooves 1231 of the two cordage outlet wheels 123 form a circular hole at a tangent position. After the outlet wheel cordage groove 1231 is contoured to the cordage 900, when the cordage 900 passes through the circular hole formed by the two outlet wheel cordage grooves 1231, the cordage 900 will not shift significantly, ensuring stable unwinding or winding through the circular hole, thereby limiting a position of the cordage 900 passing through a guiding hole or the cordage outlet hole 1241, and further improving the stability of unwinding or winding.

In some embodiments, the base 121 and the rotating seat 122 are rotatably connected via a bearing, so that the rotating seat 122 can be more easily driven and rotated by the cordage 900.

In some embodiments, the power supply assembly 600 may include: a battery 610 fixed on the cordage box 100 and electrically connected to a PCB board 740 on the cordage box 100; and a display screen 611 fixed on the cordage box 100 and electrically connected to the PCB board 740.

In this solution, the battery 610 can supply power to the motor 500 and related components on the PCB board 740. The display screen 611 can display working status information of the output device, facilitating user operation and use of the output device.

In some embodiments, the display screen 611 may be a touch screen, for example. A user can issue a control command by touching the display screen 611, and the output device may operate in response to the control command, making it more convenient for the user to operate and use the output device.

In some embodiments, the display screen 611 is located at a side of the battery 610.

For example, the display screen 611 may be located at the front side of the battery 610, so that the user can easily view the information displayed on the display screen 611.

In some embodiments, the power supply assembly 600 may further include: a battery holder 619 fixedly connected to the cordage box 100, and both the battery 610 and the display screen 611 are fixedly connected to the battery holder 619. For example, the battery holder 619 may be fixed to the cordage box 100 via a screw.

In some embodiments, the second unlocking trigger apparatus 6125 may be disposed on the battery holder 619.

In another possible implementation, the second unlocking trigger apparatus 6125 may be disposed on the battery 610, and a relief hole corresponding to the second unlocking trigger apparatus 6125 may be disposed on the battery holder 619, allowing the user to directly press or touch the second unlocking trigger apparatus 6125 through the relief hole.

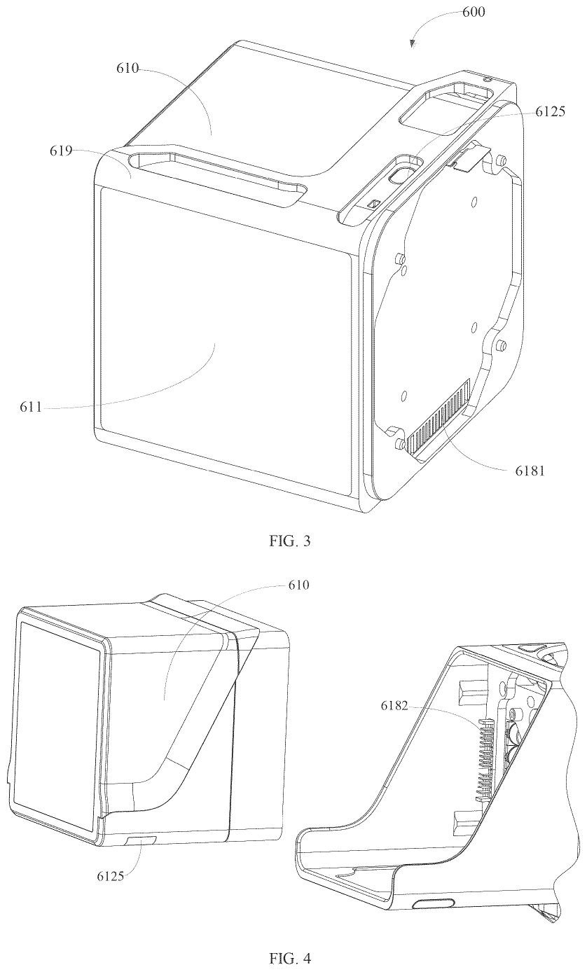

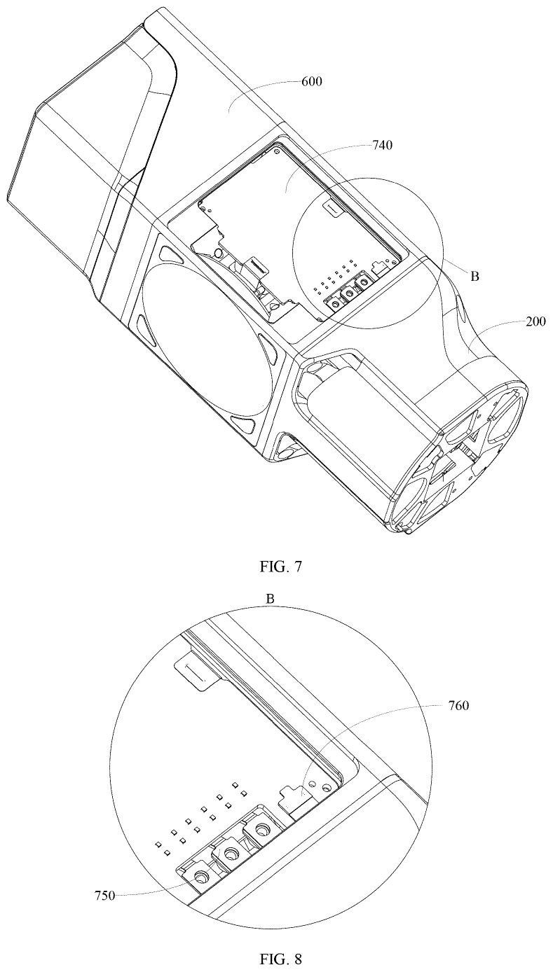

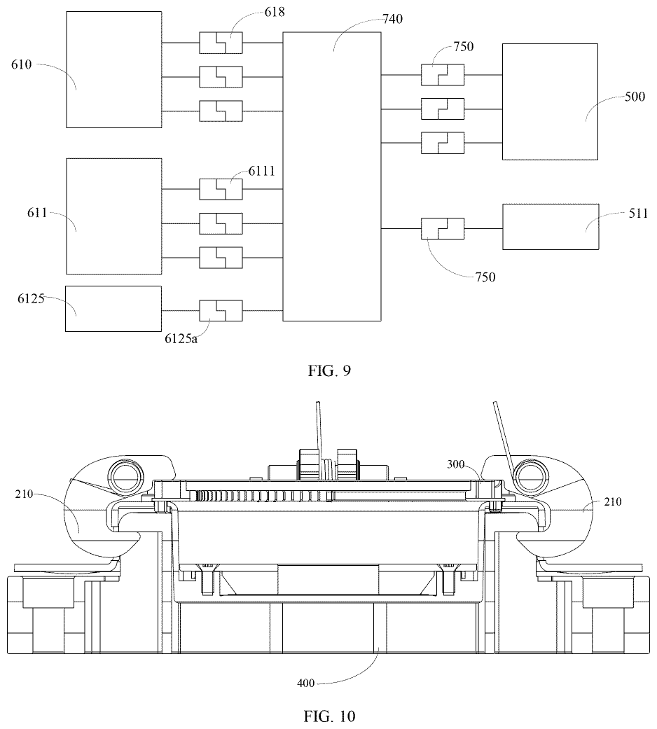

In some embodiments, referring to FIG. 3, FIG. 4, and FIG. 9, the battery 610 is electrically connected to the PCB board 740 via a first quick-connect connector 618, thus facilitating quick disassembly of the battery 610.

Specifically, the first quick-connect connector 618 may include a first quick-connect sub-connector 6181 and a second quick-connect sub-connector 6182. The first quick-connect sub-connector 6181 is disposed on the battery 610, and the second quick-connect sub-connector 6182 is disposed on the PCB board 740. When the battery 610 is mounted, the first quick-connect sub-connector 6181 is plugged into the second quick-connect sub-connector 6182 to achieve electrical connection between the battery 610 and the PCB board 740.

Referring to FIG. 9, the display screen 611 is electrically connected to the PCB board 740 via a second quick-connect connector 6111. In this solution, by providing the second quick-connect connector 6111, the display screen 611 can be quickly disassembled.

In some embodiments, referring to FIGS. 7 to 9, the motor 500 is electrically connected to the PCB board 740 on the cordage box 100 via a third quick-connect connector 750. In this solution, the third quick-connect connector 750 facilitates quick disassembly of the motor 500, making maintenance and repair more convenient.

In some embodiments, referring to FIGS. 7 to 9, the first unlocking trigger apparatus 511 is connected to the PCB board 740 on the cordage box 100 via a fourth quick-connect connector 760.

In some embodiments, referring to FIG. 9, the second unlocking trigger apparatus 6125 is connected to the PCB board 740 on the cordage box 100 via a fifth quick-connect connector 6125a.

In some embodiments, referring to FIG. 11, the output device may further include: a voice sensor communicatively connected to a controller of the output device. The controller is configured to control the motor 500 to operate according to a voice command received by the voice sensor. In this solution, voice control of the output device can be achieved by providing the voice sensor.

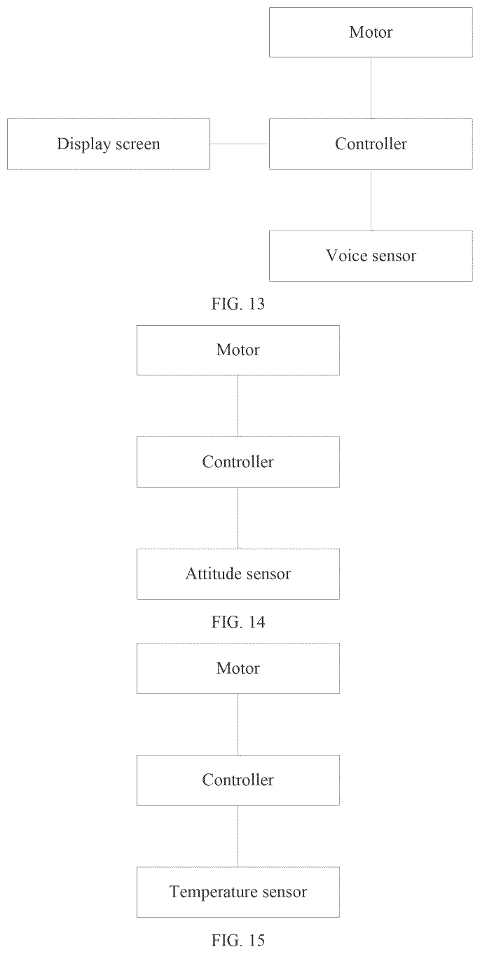

Further, referring to FIG. 13, the controller may also be communicatively connected to the display screen 611, and working status information of the output device (e.g., the current traction force, etc.) may be displayed via the display screen 611, facilitating the user to accurately operate the output device as needed.

In some embodiments, the controller is further configured to: control the motor 500 to stop operation when the voice command received by the voice sensor exceeds a preset loudness. In this solution, when the user encounters an emergency, the user can stop the motor 500 by emitting a sound exceeding the preset loudness, thereby improving safety of use.

In some embodiments, referring to FIG. 14, the output device may further include: an attitude sensor communicatively connected to the controller of the output device. The controller is configured to determine current motion state information of the output device according to the attitude sensor, and control the motor 500 to operate according to the motion state information. The motion state information includes at least one of the following: a current acceleration of the output device, a current angle of the output device.

For example, the attitude sensor may be a gyroscope, and the gyroscope may be a mechanical gyroscope or a MEMS (Micro Electro Mechanical Systems). It can be understood that the current acceleration of the output device can be determined by the gyroscope. By continuously tracking the current acceleration of the output device, a current state, a current angle of the output device, and whether the output device is oscillating, etc., can be determined, so that abnormalities can be discovered in time during the use of the output device, and corresponding measures can be taken.

For example, if the current acceleration of the output device exceeds a preset acceleration threshold, the output device may accidentally fall off, and the motor 500 can be controlled to stop operation at this time.

In some embodiments, referring to FIG. 15, the output device may further include: a first temperature sensor configured to detect the temperature of the motor 500 and communicatively connected to the controller of the output device. The controller is configured to reduce the output power of the motor 500 when it is determined that the temperature of the motor 500 exceeds a preset first temperature threshold.

In this solution, when the temperature of the motor 500 exceeds the preset first temperature threshold, reducing the output power of the motor 500 can prevent the motor 500 from overheating. For example, when the temperature of the motor 500 is very high, the motor 500 can be controlled to stop operation immediately. When the temperature of the motor 500 is relatively high, the operation of the motor 500 can be appropriately reduced to decrease the temperature rise of the motor 500.

In some embodiments, the controller is further configured to: when the temperature of the motor 500 exceeds a preset second temperature threshold, control a prompt apparatus to issue prompt information. The second temperature threshold is less than the first temperature threshold.

In this solution, when the temperature of the motor 500 exceeds the preset second temperature threshold, the prompt apparatus is controlled to issue prompt information. The prompt information can be in various forms. For example, voice prompt information can be issued via a loudspeaker or a buzzer to prompt the user that the temperature of the motor 500 is relatively high. Alternatively, the motor 500 can be controlled to generate vibration to prompt the user. Alternatively, display information corresponding to relatively high temperature of the motor 500 can be displayed via the display screen 611. Of course, when the output device is wirelessly connected to a user terminal via Bluetooth or the like, prompt information can also be pushed to the user terminal.

The prompt information may remind the user to use the motor 500 gently to reduce the temperature rise of the motor 500, or remind the user not to touch the motor 500 to prevent burns, etc. The present disclosure does not limit this.

As shown in FIG. 80, the present disclosure provides a resistor structure 720, and the resistor structure 720 is disposed inside a housing of fitness equipment or a fixing frame. The resistor structure 720 includes a first plate body 721, a first heat-conducting component 722, and a resistor plate 723. The first plate body 721 is connected to the housing, or is integrally formed with the housing, or is integrally formed with part of the housing. The first heat-conducting component 722 is located between the resistor plate 723 and the first plate body 721, and the resistor plate 723 is configured to dissipate electric energy generated by the motor of the fitness equipment. In the present disclosure, the resistor plate 723 may be a plate-like structure formed by stamping a resistance wire, or may be a ceramic resistor plate, a composite resistor plate, a chip resistor plate, or any other plate-type resistor element in the related art.

It should be noted that the fixing frame may be a fixing frame for fitness equipment or a fixing frame for sports equipment. The fitness equipment and the fixing frame may be detachably connected. A user can connect the fitness equipment to the fixing frame as needed. During connection, the fitness equipment can be electrically connected to the resistor structure 720 provided on the fixing frame, so that excess electric energy generated by the fitness equipment during fitness process can be dissipated by the resistor structure 720 on the fixing frame.

Based on the above technical solution, the housing of the fitness equipment or the fixing frame is configured as a mounting plate and the heat dissipation plate 712 of the resistor structure 720, as shown in FIG. 81, when the resistor structure 720 is in use, the resistor plate 723 can dissipate the electric quantity generated by the motor 500 through heating, so that the resistor structure 720 can bear a part of the electric quantity generated by the motor 500, avoiding a situation where a reverse charging electric quantity is greater than an output electric quantity of the battery 610. The resistor plate 723 will generate a large amount of heat when dissipating electric quantity, and the heat is mainly transferred from the first heat-conducting component 722 to the first plate body 721. In the embodiment, the first plate body 721 is connected to the housing or is integrally formed with the housing, so as to transfer heat from the first plate body 721 to the housing of the equipment, and a large-area housing is more conducive to rapid heat dissipation. The first plate body 721 may also be integrally formed with a part of the housing, facilitating installation, disassembly, and quick replacement of the resistor structure 720, thereby improving interchangeability of the resistor structure 720.

In some embodiments, as shown in FIG. 80 and FIG. 81, the resistor structure 720 further includes a second plate body 724, and the second plate body 724 is connected to a side of the resistor plate 723 away from the first plate body 721. The second plate body 724 is at least configured for fixing the resistor plate 723 to the first plate body 721 or for heat insulation.

When mounting the resistor structure 720, the first plate body 721 is first connected to the housing, then the resistor plate 723 is integrated into the housing through the first heat-conducting component 722, and then the second plate body 724 is mounted. For example, both the first plate body 721 and the second plate body 724 are provided with corresponding mounting holes, and a screw is configured to connect and fix the second plate body 724 to the first plate body 721 through the mounting holes, so that the first plate body 721 and the second plate body 724 form a clamping structure, thereby fixing the resistor plate 723 between the first plate body 721 and the second plate body 724. Of course, the first plate body 721 and the second plate body 724 are not limited to a screw connection mode, and may also be connected by snap-fitting or welding, as long as the resistor plate 723 can be fixed between the first plate body 721 and the second plate body 724. In addition, in some embodiments, the second plate body 724 can also be configured to insulate heat generated inside the housing, so that heat generated by the resistor plate 723 is transferred from the first plate body 721 to the housing, avoiding heat transfer from the second plate body 724 to the inside of the housing.

In some embodiments, as shown in FIG. 84, the resistor structure 720 further includes a second heat-conducting component 725, and the second heat-conducting component 725 is connected between the resistor plate 723 and the second plate body 724. The second plate body 724 is also configured to transfer heat inside the housing to the second heat-conducting component 725 or to be connected to a heat dissipation element.

For example, a first heat-conducting component 722 is arranged between the first plate body 721 and the resistor plate 723, and a second heat-conducting component 725 is arranged between the second plate body 724 and the resistor plate 723. The first heat-conducting component 722 and the second heat-conducting component 725 transfer heat generated by the resistor plate 723 and heat inside the housing to the first plate body 721, and exchange heat with the outside through the large-area housing, thereby achieving a heat dissipation process.

It should be noted that several components are arranged inside the housing, including an electrical element and a heat dissipation element. The electrical element generates heat inside the housing and transfers heat to the second plate body 724. Heat of the second plate body 724 can be transferred to a surface of the housing through the first plate body 721 to exchange heat with the outside. In some embodiments, heat exchange can also be performed via a heat dissipation element, so that heat generated by the resistor plate 723 is dissipated via the internal heat dissipation element. For example, the heat dissipation element can be a condensation pipe, and the condensation pipe is arranged inside the housing, thereby achieving a heat dissipation process.

In some embodiments, the first heat-conducting component 722 and/or the second heat-conducting component 725 can be thermally conductive silicone, which has better thermal conductivity and is beneficial to improving the speed of heat transfer and heat dissipation. The silicone can be a prefabricated silicone pad, or a glue layer formed by potting during assembly.

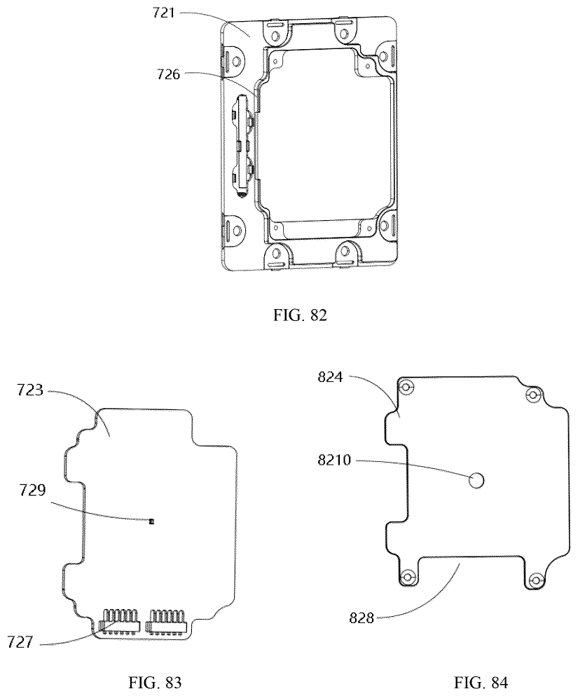

In some embodiments, as shown in FIG. 81 and FIG. 82, a resistor plate protruding edge 726 is provided on a side of the first plate body 721 facing the resistor plate 723, and the resistor plate protruding edge 726 is arranged around the resistor plate 723.

Specifically, the shape of the resistor plate protruding edge 726 is adapted to the shape of the resistor plate 723, so that the resistor plate 723 can be limited within the surrounding range of the resistor plate protruding edge 726, making installation of the resistor plate 723 more stable and firm.

As a preferred embodiment, as shown in FIGS. 80 to 82, the first heat-conducting component 722, the resistor plate 723, the second heat-conducting component 725 and the second plate body 724 are all limited within the surrounding range of the resistor plate protruding edge 726, so as to ensure that the resistor structure 720 can be stably mounted, overall integration of the resistor structure 720 is higher, which is beneficial to reducing a space occupied by the resistor structure 720 inside the housing.

In some embodiments, as shown in FIG. 81 and FIG. 83, a sixth quick-connect connector 727 configured for quick connection with fitness equipment is provided on a side of the resistor plate 723 facing away from the first plate body 721.

It should be understood that a control circuit board is usually provided in the housing of the fitness equipment, and the control circuit board is electrically connected to the motor 500 and the battery 610. The resistor plate 723 is connected to the control circuit board via the sixth quick-connect connector 727, thereby achieving the function of dissipating an electric quantity generated by the motor 500 or an excess electric quantity of the battery 610.

Specifically, the sixth quick-connect connector 727 includes several conductive sheets perpendicular to the resistor plate 723, and the control circuit board is located at a corresponding position. The circuit board is provided with an insertion slot 5211 corresponding to the sixth quick-connect connector 727, and the insertion slot 5211 includes several sockets corresponding to the conductive sheets. During installation, the sixth quick-connect connector 727 is inserted into the insertion slot 5211, and each conductive sheet of the sixth quick-connect connector 727 is inserted into the corresponding socket of the insertion slot 5211, thereby achieving quick connection.

In some embodiments, as shown in FIG. 81 and FIG. 84, the resistor structure 720 includes a second plate body 724, and the second plate body 724 is connected to a side of the resistor plate 723 away from the first plate body 721. The second plate body 724 in the embodiment is provided with an avoidance hole 728 corresponding to the sixth quick-connect connector 727.

Specifically, the resistor plate 723 is first integrated into the housing via the first heat-conducting component 722, and then the second plate body 724 is connected and fixed to the first plate body 721. The second plate body 724 is provided with an avoidance hole 728, so that after the second plate body 724 is in close contact with the first plate body 721, the sixth quick-connect connector 727 on the resistor plate 723 can be connected to the motor 500 of the fitness equipment through the avoidance hole 728 on the second plate body 724.

In some embodiments, as shown in FIG. 81 and FIG. 84, the resistor structure 720 further includes a second plate body 724, and the second plate body 724 is connected to a side of the resistor plate 723 away from the first plate body 721. The resistor structure 720 provided in the embodiment further includes a second temperature sensor 729, and the second temperature sensor 729 is disposed on a side of the resistor plate 723 away from the first plate body 721, The second temperature sensor 729 is configured to monitor the temperature inside the housing. Correspondingly, the second plate body 724 is provided with a plate body through hole 7210, and the plate body through hole 7210 corresponds to the second temperature sensor 729, so that the second temperature sensor 729 can monitor the temperature inside the housing. When the second temperature sensor 729 detects that the temperature inside the housing is abnormal, an alarm will be issued to facilitate corresponding adjustments.

The resistor structure 720 in the above embodiments may also be applied to other fitness equipment or fixing frames.

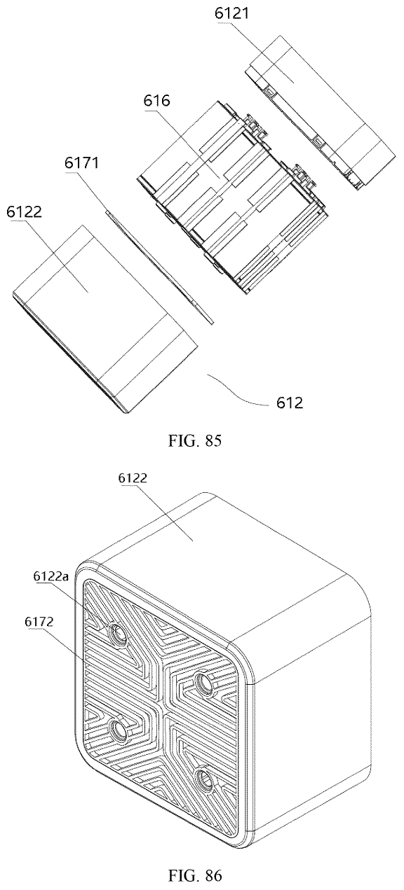

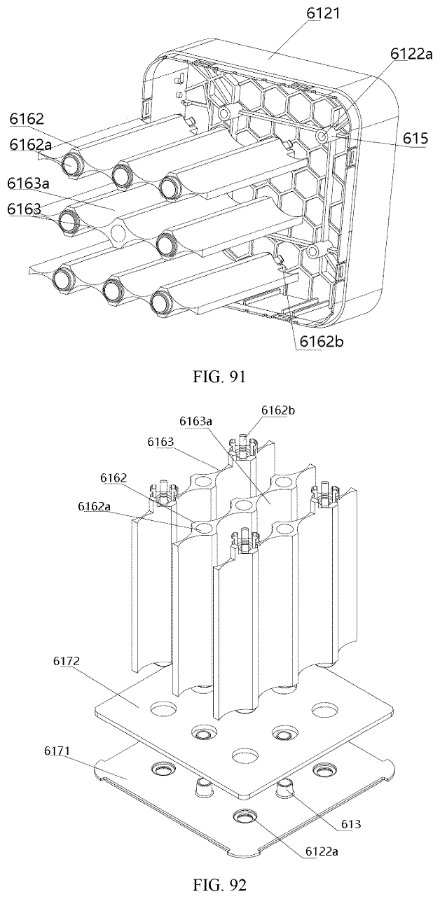

As shown in FIGS. 85-93, in an embodiment of the present disclosure, a battery 610 is provided, the battery 610 includes a battery housing 612, a battery cell 616, and an elastic heat-conducting pad 6171. The battery housing 612 includes a first housing 6121 and a second housing 6122 connected by a battery 610 snap in a first direction. The battery cell 616 is mounted in the battery housing 612. The elastic heat-conducting pad 6171 is sandwiched between the battery cell 616 and the battery housing 612 in the first direction. One side of the elastic heat-conducting pad 6171 is in contact with the battery cell 616, and the other side is in contact with an inner wall of the battery housing 612.

The battery housing 612 is formed by the first housing 6121 and the second housing 6122 being butted together and then connected by a battery 610 snap. A butting direction of the first housing 6121 and the second housing 6122 is defined as the first direction.

The elastic heat-conducting pad 6171 can be disposed between the first housing 6121 and the battery cell 616, or between the second housing 6122 and the battery cell 616. There may also be at least two elastic heat-conducting pads 6171, which are respectively disposed between the first housing 6121 and the battery cell 616 and between the second housing 6122 and the battery cell 616.

Thus, the first housing 6121 and the second housing 6122 are connected by the battery 610 snap, which is simpler and more convenient to use compared with an installation method through a bolt connection commonly used in the related art. The elastic heat-conducting pad 6171 is sandwiched between the battery cell 616 of the battery 610 and the battery housing 612, and heat generated by the battery cell 616 during operation can be transferred to the battery housing 612 via the elastic heat-conducting pad 6171 for heat dissipation, and the heat dissipation effect is good. At the same time, the elastic heat-conducting pad 6171 is configured in the butting direction of the first housing 6121 and the second housing 6122. Since the elastic heat-conducting pad 6171 has a certain elasticity, when the first housing 6121 and the second housing 6122 are connected by the battery 610 snap, the elastic heat-conducting pad 6171 can be compressed, eliminating an installation gap, ensuring the stability of the battery 610 structure, and further ensuring heat conduction efficiency.

In some embodiments, the first housing 6121 and the second housing 6122 can be nested with each other when butted and mounted. At a mutual nesting position of the first housing 6121 and the second housing 6122, a fixing groove 6121b and a battery snap protrusion 6121a are matched with each other and are arranged in a one-to-one correspondence. The fixing groove 6121b can be provided on the nested battery housing 612, and the battery snap protrusion 6121a can be provided on the nesting battery housing 612. The fixing groove 6121b can also be provided on the nesting battery housing 612, and the battery snap protrusion 6121a can be provided on the nested battery housing 612. The nesting portion 1321 of the nested battery housing 612 and the nesting battery housing 612 can also be provided with a fixing groove 6121b, and the nesting portion 1321 of the nested battery housing 612 and the nesting battery housing 612 can also be provided with a corresponding battery snap protrusion 6121a. Thus, through cooperation of the fixing groove 6121b and the battery snap protrusion 6121a, installation and positioning of the first housing 6121 and the second housing 6122 can be achieved.

For safety reasons, the battery housing 612 of the battery 610 is generally made of a plastic material, and heat dissipation performance of the plastic material is generally poor. Based on this, in some embodiments, the battery housing 612 further includes a heat sink 6172, and the heat sink 6172 is integrally formed with the battery housing 612 or the heat sink 6172 is mounted on the battery housing 612.

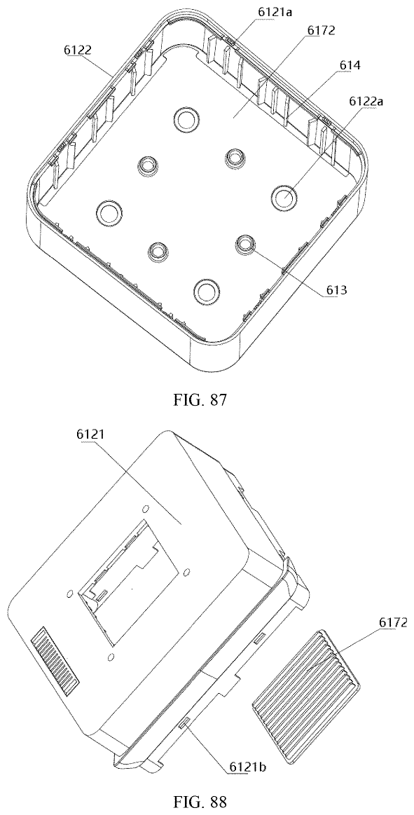

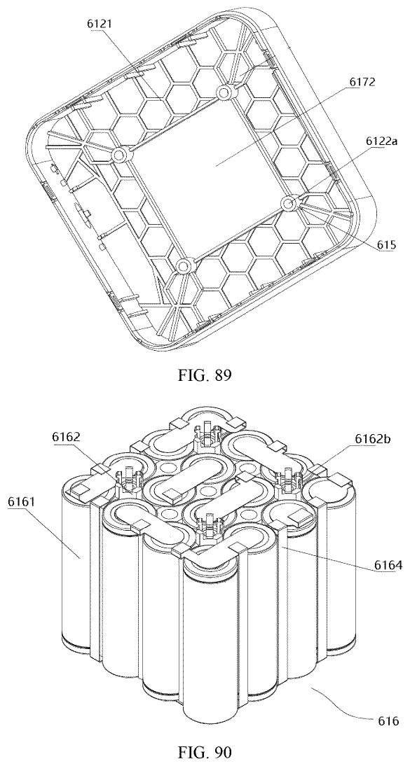

In some embodiments, the battery housing 612 is made of a plastic material, and the heat sink 6172 is made of a material with good thermal conductivity, such as a metal material, and is made into a structure with a larger heat dissipation area, such as a fin structure. There are generally two ways to integrate the heat sink 6172 into the battery housing 612. One is to directly injection-mold the heat sink 6172 and the battery housing 612 as one piece when the battery housing 612 is produced. For example, a bottom surface of the second housing 6122 is entirely designed as a metal heat sink 6172, which is integrally injection-molded with part of the plastic battery shell 612, referring to FIGS. 86-87. The other is to produce the battery housing 612 and the heat sink 6172 separately, and then mount the heat sink 6172 on the battery housing 612, for example, through a battery 610 buckle, a step structure, an interference fit, or a bolt connection to achieve installation of the heat sink 6172 and the battery housing 612, such as the structure of the first housing 6121, referring to FIGS. 88-89. Of course, the method is not limited to the above description, as long as the heat sink 6172 and the battery housing 612 can be mounted together.

In some embodiments, a heat sink 6172 is provided on a wall of the battery housing 612 in the first direction, and by contacting with the elastic heat-conducting pad 6171, a heat dissipation area can be effectively increased, and the heat dissipation effect can be improved. As shown in FIG. 88, a heat sink 6172 may be provided on a wall of the first housing 6121 in the first direction, and the heat sink 6172 is mounted on the first housing 6121 by assembly. As shown in FIG. 86, a heat sink 6172 can also be provided on the wall of the second housing 6122 in the first direction, and the heat sink 6172 is prefabricated on the first housing 6121. In addition, heat sinks 6172 can also be provided on walls of the first housing 6121 and the second housing 6122 in the first direction. It should be noted that the way of disposing the heat sinks 6172 on the first housing 6121 and the second housing 6122 is not limited to the above-mentioned ones, and it is not limited to disposing heat sinks 6172 on other walls of the battery housing 612, as long as the overall structural strength and safety requirements can be guaranteed.

As shown in FIG. 90, in some embodiments, the battery cell 616 includes a plurality of cylindrical batteries 6161 and a plurality of supporting rods 6162. A length direction of the cylindrical battery 6161 is the first direction, and a gap is left between at least three adjacent cylindrical batteries 6161. The supporting rod 6162 passes through the gap between adjacent cylindrical batteries 6161, and two ends of the supporting rod 6162 are respectively connected to the first housing 6121 and the second housing 6122. This configuration can ensure the structural stability of the battery cell 616, facilitate positioning of the battery cell 616 in the battery housing 612, and at the same time make the connection between the first housing 6121 and the second housing 6122 more stable. Furthermore, the supporting rod 6162 can be contoured according to the shape of the gap, with a better stabilization effect. Of course, if an area of the heat sink 6172 is large enough, the supporting rod 6162 can also be directly connected to the heat sink 6172.

In some embodiments, four cylindrical batteries 6161 form a group, stacked to form a square structure, and a gap sandwiched between the four cylindrical batteries 6161 is filled with a supporting rod 6162. In addition, three batteries 610 can also form a group, stacked to form a triangular structure, and a gap sandwiched between the three cylindrical batteries 6161 is filled with a supporting rod 6162.

In some embodiments, the supporting rod 6162 includes a central hole 6162a, and positioning holes are opened on the first housing 6121 and the second housing 6122, and the central hole 6162a is in communication with the positioning hole. The central hole 6162a mentioned here is along the first direction. When the supporting rod 6162 is connected to the first housing 6121 and the second housing 6122, the central hole 6162a on the supporting rod 6162 is in communication with the positioning hole on the first housing 6121 and the positioning hole on the second housing 6122, forming a through hole penetrating the battery 610. The through hole can be configured to fix the battery 610. By passing a bolt through the through hole, the battery 610 can be fixedly installed on a bracket or other mounting position, ensuring the stability of installation of the battery 610. At the same time, the through hole is formed by the supporting rod 6162 and the first housing 6121 and the second housing 6122 in contact with the battery cell 616, which can also play a role in heat dissipation and improve the heat dissipation effect of the battery 610.

In some embodiments, the positioning holes on the battery housing 612 include a blind hole on an inner side of a wall of the battery housing 612 and a through hole penetrating the wall of the battery housing 612. The diameter of the blind hole is larger than the diameter of the through hole, and a rod diameter of an end portion of the supporting rod 6162 is no greater than the diameter of the blind hole, enabling the supporting rod 6162 to be inserted into the blind hole, so that the through hole is in communication with the central hole 6162a of the supporting rod 6162. In addition, a battery protruding portion 615 can also be provided on the inner side of the wall of the battery housing 612, a positioning hole is provided on the battery protruding portion 615, the battery protruding portion 615 is inserted into the central hole 6162a, and the positioning hole is in communication with the central hole 6162a.

In some embodiments, an end portion of the supporting rod 6162 can be connected to the first housing 6121 by a battery 610 snap, and connected to the second housing 6122 by other means. The end of the supporting rod 6162 can also be connected to the second housing 6122 by a battery 610 snap, and connected to the first housing 6121 by other means. Of course, both ends of the supporting rod 6162 can be connected to the first housing 6121 and the second housing 6122 by battery 610 snaps. As shown in FIGS. 90-92, a battery snap structure 6162b is provided at an end of the supporting rod 6162, and a corresponding groove structure is provided on the inner side of the wall of the battery housing 612. The battery snap structure 6162b and the groove structure form a battery 610 snap connection to achieve installation and positioning of the battery cell 616 and the battery housing 612, and the other end of the supporting rod 6162 is connected to the second housing 6122 by other means.

In some embodiments, a battery positioning protrusion 613 is provided on an inner wall of the first housing 6121 and/or the second housing 6122, and the battery positioning protrusion 613 is configured to cooperate with an end portion of the supporting rod 6162. In this positioning method, the end portion of the supporting rod 6162 is provided with a hole or the supporting rod 6162 is provided with a through hole 1381c, and the battery positioning protrusion 613 is inserted into the hole at the end portion of the supporting rod 6162 for positioning.

The above-mentioned positioning methods of the supporting rod 6162 can be selected as needed, and the connection between the supporting rod 6162 and the first housing 6121 and the second housing 6122 can select different methods. A specific implementation is provided below. Referring to FIG. 87 and FIGS. 89-92, the battery cell 616 includes sixteen cylindrical batteries 6161, which are stacked in groups of four to form a square battery cell 616 structure, and gaps between the cylindrical batteries 6161 are filled with nine supporting rods 6162. The four supporting rods 6162 at corners are positioned and connected to the first housing 6121 and the second housing 6122 by means of positioning holes, which are subsequently configured to fix the battery 610. Specifically, a battery protruding portion 615 is provided on an inner wall of the first housing 6121, a positioning hole is provided on the battery protruding portion 615, and at the same time, a battery 610 snap connection is configured to improve stability, and a positioning hole formed by a blind hole and a through hole is provided on an inner wall of the second housing 6122. The other supporting rods 6162 are positioned by providing battery positioning protrusions 613 on an inner wall of the battery housing 612. In this solution, positioning is only performed on the second housing 6122, and positioning is performed by a main control board in a direction of the first housing 6121.

As shown in FIGS. 90-92, in some embodiments, adjacent supporting rods 6162 in the same row are connected via a second connecting rib 6163; thus, connecting the supporting rods 6162 together can play a better role in stable support. In some embodiments, the second connecting rib 6163 is provided with a positioning groove 6163a for connecting the cylindrical battery 6161. The positioning groove 6163a is designed according to the shape of structure of the battery cell 616, and the second connecting rib 6163 is made as thin as possible, so that the cylindrical battery 6161 is positioned more stably, layout of the battery cell 616 is made more compact, and volume of the battery cell 616 is reduced.

A plurality of cylindrical batteries 6161 of the battery cell 616 needs to be connected in series, and a traditional wiring method is complicated. Based on this, as shown in FIG. 92, in some embodiments, the battery cell 616 further includes a first FPC flexible cable 6164, and the first FPC flexible cable 6164 is configured to connect the plurality of cylindrical batteries 6161 in series. The FPC flexible cable has a certain toughness and can be arranged arbitrarily according to space requirements, which can effectively simplify the wiring, reduce the volume and the weight of the battery 610, and make layout of the battery 610 more compact.

In order to improve the stability of the battery cell 616 inside the battery housing 612, as shown in FIG. 87, in some embodiments, a plurality of fixing ribs 614 along the first direction is further provided on a side wall of the battery housing 612, and the fixing rib 614 is configured to position the battery cell 616. For example, at least two fixing ribs 614 are formed into a group, and a side wall of the cylindrical battery 6161 leans between the two fixing ribs 614, which can reduce the shaking of the battery cell 616 and improve the stability of the battery cell 616.

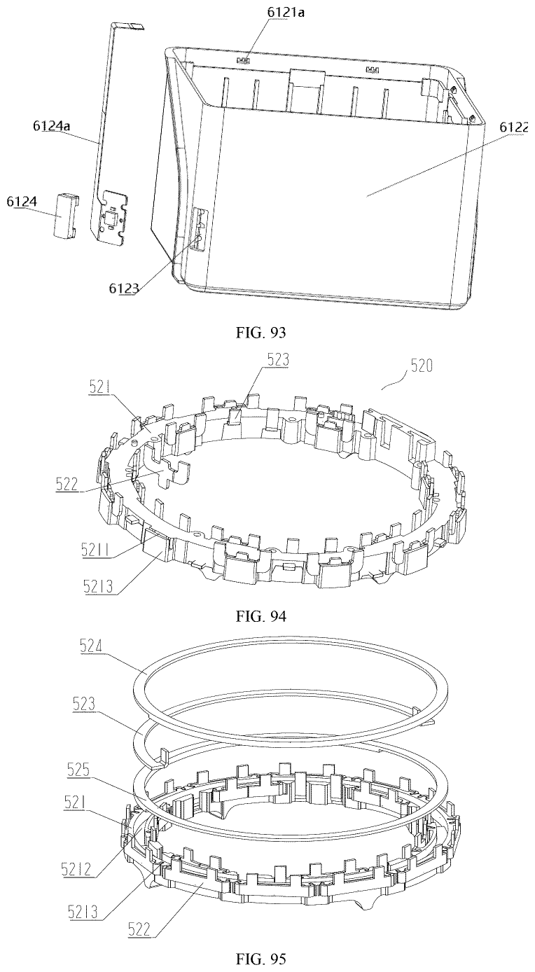

As shown in FIG. 93, in some embodiments, the battery housing 612 is further provided with a battery key mounting position 6123 for mounting a first functional key 6124. The first functional key 6124 can be a key related to a function of the battery 610, such as a switch, etc., or can be a key related to a function of a device where the battery 610 is located, especially when there is no location for configuring a key on the device, the key can be configured on the battery 610, providing more sufficient installation space. The battery key mounting position 6123 is connected to a main control of the battery 610 via a second FPC flexible cable 6124a for easy wiring.

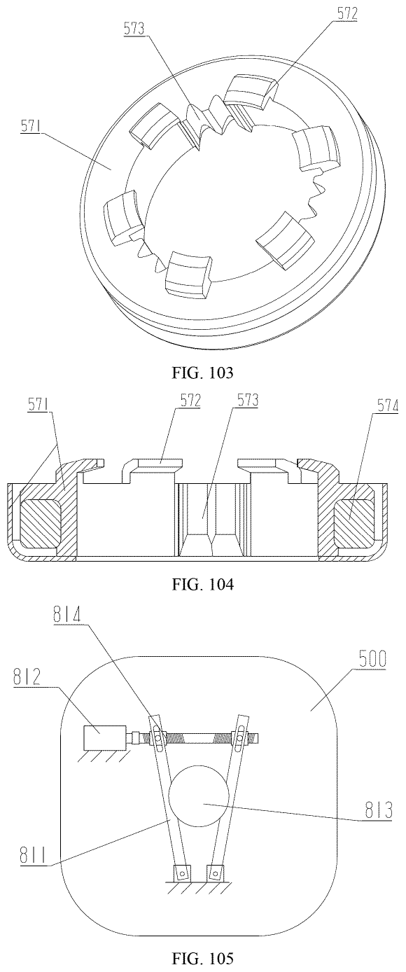

The connecting busbar 520 and the motor 500 provided in some embodiments are described below with reference to FIGS. 94-104.

An embodiment of a first aspect of the present disclosure provides a connecting busbar 520, and the connecting busbar 520 includes a mounting seat 521 and a first connecting member 522 disposed on the mounting seat 521. The mounting seat 521 is an insulator, there is at least one first connecting member 522, the first connecting member 522 is plugged into the mounting seat 521, and the first connecting member 522 includes at least two first connecting ends 5221 for connecting to the coil 550. Specifically, the mounting seat 521 is an insulator, which can be formed by injection molding, can support the first connecting member 522, and play an isolating role to prevent the first connecting member 522 from being connected in series with other components. The first connecting member 522 is assembled to the mounting seat 521 by plugging, and includes at least two first connecting ends 5221. When the connecting busbar 520 is assembled to the motor 500, the first connecting end 5221 is configured to connect to the coil 550 to achieve a connection function. The coil 550 connected to the first connecting end 5221 can be either a stator winding coil or a rotor winding coil. The first connecting member 522 is assembled to the mounting seat 521 by plugging, which has a simple structure and is more convenient to assemble compared with a traditional assembly method using a bolt connection.

In some embodiments, the connecting busbar 520 includes a mounting seat 521 and a second connecting member 523 disposed on the mounting seat 521. The mounting seat 521 is an insulator, there is at least one second connecting member 523, the second connecting member 523 is disposed in the mounting seat 521, and the second connecting member 523 includes at least two second connecting ends 5231 for connecting to the coil 550. Specifically, the mounting seat 521 is an insulator, which can be formed by injection molding, can support the second connecting member 523, and play an isolating role to prevent the second connecting member 523 from being connected in series with other components. The second connecting member 523 is disposed in the mounting seat 521 by prefabrication or subsequent assembly. The second connecting member 523 is a conductor and includes at least two second connecting ends 5231. When the connecting busbar 520 is assembled to the motor 500, the second connecting end 5231 is configured to connect to the coil 550 to achieve a connection function. The coil 550 connected to the second connecting end 5231 can be either a stator winding coil or a rotor winding coil.

In some embodiments, the connecting busbar 520 includes a mounting seat 521, a first connecting member 522 and a second connecting member 523 disposed on the mounting seat 521. The mounting seat 521 is an insulator. There is at least one first connecting member 522, and the first connecting member 522 is plugged into the mounting seat 521. The first connecting member 522 includes at least two first connecting ends 5221 for connecting to the coil 550. There is at least one second connecting member 523, the second connecting member 523 is plugged into the mounting seat 521, and the second connecting member 523 includes at least two second connecting ends 5231 for connecting to the coil 550. Specifically, the mounting seat 521 is an insulator, which can be formed by injection molding, can support the first connecting member 522 and the second connecting member 523, and play an isolating role to prevent the first connecting member 522 and the second connecting member 523 from being connected in series with other components. The first connecting member 522 is assembled to the mounting seat 521 by plugging, and the second connecting member 523 is disposed in the mounting seat 521 by prefabrication or subsequent assembly. Both the first connecting member 522 and the second connecting member 523 are conductors, and the first connecting member 522 includes at least two first connecting ends 5221, and the second connecting member 523 includes at least two second connecting ends 5231. When the connecting busbar 520 is assembled to the motor 500, both the first connecting end 5221 and the second connecting end 5231 are configured to connect to the coil 550 to achieve a connection function. The coil 550 connected to the first connecting end 5221 and the second connecting end 5231 can be either a stator winding coil 550 or a rotor winding coil 550.

The connecting busbar 520 disclosed in the present disclosure provides positioning and fixation for the connecting member via the mounting seat 521, avoiding irregular wiring between the coils 550. The use of the mounting seat 521 simplifies installation of the connecting busbar 520. The second connecting member 523 preset inside the mounting seat 521 can be directly connected to the corresponding coil 550 during installation. The first connecting member 522 plugged into the mounting seat 521 can first assemble the mounting seat 521 to the motor 500, and then insert the first connecting member 522 into the mounting seat 521 and connect the corresponding coil 550. The first connecting member 522 can also be combined with the mounting seat 521 and then assembled into the motor 500 together to achieve the connection between the first connecting member 522 and the mounting seat 521.

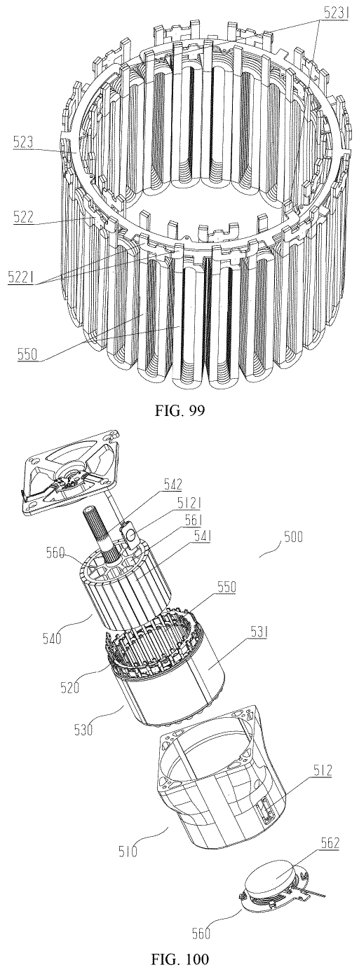

Referring to FIG. 99, in some embodiments, two adjacent coils 550 that are relatively close to each other can be connected to each other via the first connecting member 522. At this time, the two first connecting ends 5221 of the first connecting member 522 are relatively close, so that the volume of the first connecting member 522 is small, ensuring the strength of the first connecting member 522 during plugging and assembly. In some embodiments, two adjacent coils 550 that are relatively far apart can be connected to each other via the second connecting member 523. At this time, the second connecting ends 5231 of the second connecting member 523 are relatively far apart, and the second connecting member 523 is disposed in the mounting seat 521, which can ensure the strength and can be designed to be larger, and is suitable for connecting non-adjacent or relatively far coils 550 that need to be connected. It should be noted that the first connecting member 522 and the second connecting member 523 can be used separately or simultaneously. The above-mentioned first connecting member 522 is configured to connect adjacent coils 550, and the second connecting member 523 is configured to connect distant coils 550, which is only an optional usage method, and does not exclude usage of connecting distant coils 550 with the first connecting member 522 and connecting adjacent coils 550 with the second connecting member 523.

Referring to FIGS. 94-95, in some embodiments, the mounting seat 521 is simultaneously provided with both a first connecting member 522 and a second connecting member 523. The first connecting ends 5221 of the first connecting member 522 are arranged close to each other and can connect two adjacent coils 550, and the second connecting ends 5231 of the second connecting member 523 are arranged far apart and can connect distant coils 550. Connecting close coils 550 via the first connecting member 522 and distant coils 550 via the second connecting member 523 allows adjustment according to connection requirements of the coils 550, enabling flexible use of the first connecting member 522 and the second connecting member 523 to connect the coils 550.

Specifically, the mounting seat 521 is provided with at least one insertion slot 5211 configured to be plugged into by the first connecting member 522. The first connecting member 522 further includes a plug-in portion 5222, and the plug-in portion 5222 is configured to be plugged into the insertion slot 5211. Exemplarily, the mounting seat 521 is annular, and slots 5211 are provided on an inner side, an outer side, or both the inner side and the outer side of the mounting seat 521. The number of slots 5211 can correspond to the number of the first connecting members 522. After the plug-in portion 5222 of the first connecting member 522 is inserted into the insertion slot 5211, the first connecting end 5221 is ensured to be exposed on the inner side or the outer side of the mounting seat 521. At this time, after the connecting busbar 520 is assembled to the motor 500, the first connecting end 5221 can be connected to the coil 550. Of course, the mounting seat 521 can also be assembled to the motor 500 first, and then the first connecting member 522 can be inserted.

Referring to FIG. 94, in some embodiments, a third protruding portion 5213 is provided on a side wall of the mounting seat 521, and the insertion slot 5211 is provided on the third protruding portion 5213. The insertion slot 5211 is formed by opening a vertical slot downward from an upper end of the third protruding portion 5213, ensuring that after the plug-in portion 5222 of the first connecting member 522 is inserted into the insertion slot 5211, the first connecting end 5221 is exposed on the inner side or the outer side of the mounting seat 521, thereby facilitating subsequent connection with the coil 550.

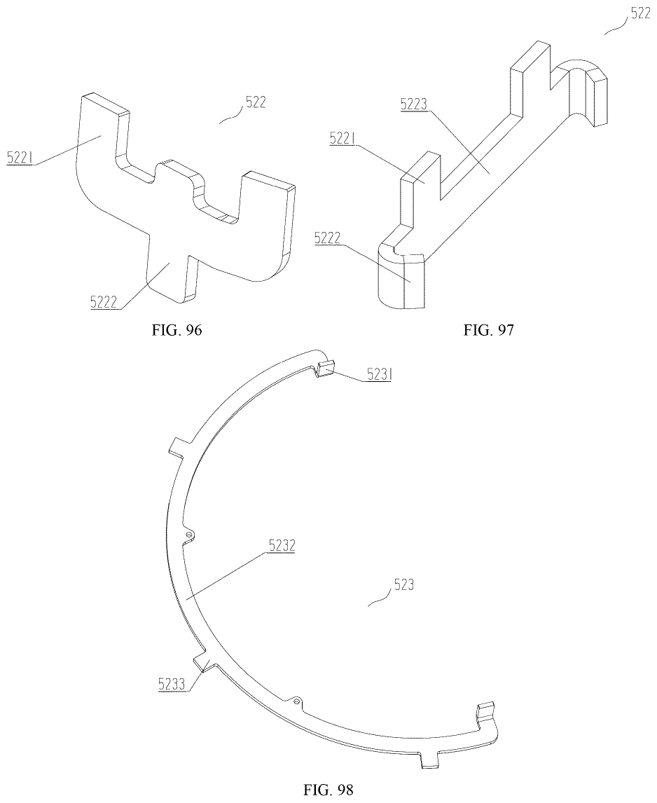

Referring to FIG. 96, in some embodiments, each first connecting member 522 includes a plug-in portion 5222 and two first connecting ends 5221. The plug-in portion 5222 is connected to the two first connecting ends 5221, and the two first connecting ends 5221 are located on both sides of the plug-in portion 5222. A middle part of the first connecting member 522 is the plug-in portion 5222, and parts extending from both sides are the first connecting ends 5221. The corresponding insertion slot 5211 can be provided on the third protruding portion 5213 protruding from the side wall of the mounting seat 521. The insertion slot 5211 is provided vertically on the upper side of the third protruding portion 5213. After the plug-in portion 5222 is inserted into the insertion slot 5211, the two first connecting ends 5221 are on the outside, which can be conveniently connected to the coil 550.

Referring to FIG. 97, in other embodiments, each first connecting member 522 includes two plug-in portions 5222 and two first connecting ends 5221. The two first connecting ends 5221 are connected to each other. The two plug-in portions 5222 are located on both sides of the first connecting ends 5221. The plug-in portion 5222 and the first connecting end 5221 are arranged at an angle. The two first connecting ends 5221 are connected by a long strip-shaped first connecting portion 5223, and are connected to a side of the first connecting portion 5223, or are an integral structure with the first connecting portion 5223. Two conductor ends of the first connecting portion 5223 are connected to the plug-in portions 5222, or the two ends are bent to form the plug-in portions 5222. The plug-in portions 5222 and the first connecting end 5221 are arranged at the angle to make the connection between the first connecting member 522 and the insertion slot 5211 more stable.

Exemplarily, the angle between the plug-in portion 5222 and the first connecting end 5221 is less than 90 degrees. That is, ends of the two plug-in portions 5222 at both ends should face each other, further improving the stability of the plug-in connection. Meanwhile, the size of the first connecting member 522 can be minimized, so that the mounting seat 521 can stack more first connecting members 522.

Referring to FIG. 94, FIG. 95, FIG. 99, and FIG. 100, in some embodiments, the mounting seat 521 is annular to accommodate a rotating body of the motor 500. The coil 550 of the motor 500 is arranged circumferentially, and the annular mounting seat 521 can also simplify installation.

As shown in FIG. 95, in some embodiments, the mounting seat 521 is provided with an annular groove 5212. The second connecting member 523 is mounted in the annular groove 5212, and the second connecting end 5231 extends out of the annular groove 5212. In this subsequent installation method, when manufacturing the mounting seat 521, an annular groove 5212 is preformed on a top surface of the mounting seat 521, leaving an opening for the second connecting end 5231 to extend out. The second connecting member 523 is then mounted in the annular groove 5212, ensuring that the second connecting end 5231 extends out of the annular groove 5212 from the opening.

Further, the connecting busbar 520 also includes a connecting cover plate 524. The connecting cover plate 524 is combined with the annular groove 5212 to fix the second connecting member 523, so that installation of the second connecting member 523 is more stable.

In some embodiments, there are a plurality of second connecting members 523. When the plurality of second connecting members 523 is mounted in the annular groove 5212, adjacent second connecting members 523 are isolated by an insulating pad 525. In this method of assembling the second connecting members 523 to the mounting seat 521, to facilitate processing and assembly, the annular groove 5212 is not designed with a structure to isolate adjacent connecting busbars 520. Therefore, when mounting the second connecting members 523, an insulating pad 525 is mounted between adjacent second connecting members 523 for isolation to avoid direct connection of the second connecting members 523.

Referring to FIG. 94, in other embodiments, the second connecting member 523 is embedded in the mounting seat 521, and the second connecting end 5231 extends out of the mounting seat 521. In this manner, the second connecting member 523 and the mounting seat 521 are preformed and do not need subsequent assembly, greatly simplifying assembly process.

Exemplarily, the second connecting member 523 and the mounting seat 521 are preformed by injection molding. The second connecting member 523 further includes a positioning portion 5233. The positioning portion 5233 extends out of the mounting seat 521 after molding, and the positioning portion 5233 is configured to position the second connecting member 523 during injection molding.

Referring to FIG. 98, regardless of subsequent installation or prefabrication, the second connecting member 523 includes a second connecting portion 5232. The second connecting end 5231 extends from or is connected to a side of the second connecting portion 5232 to form an angle. In the preforming method, a positioning portion 5233 also extends from or is connected to the side of the second connecting portion 5232. During injection molding, the second connecting member 523 is positioned in a mold via the positioning portion 5233, and it is necessary to ensure that the plurality of second connecting members 523 does not contact each other. Thus, the mounting seat 521 with an embedded second connecting member 523 can be obtained through injection molding.

An embodiment of a second aspect of the present disclosure provides a motor 500. As shown in FIG. 100, the motor 500 includes a motor housing 510, a stator assembly 530, and a rotor assembly 540. The stator assembly 530 is fixedly disposed in the motor housing 510, and the rotor assembly 540 is rotatably disposed in the motor housing 510. The stator assembly 530 and/or the rotor assembly 540 is provided with a coil 550 and a connecting busbar 520 according to any one of the embodiments of the first aspect. All or part of the coil 550 is connected to the first connecting end 5221 or the second connecting end 5231 of the connecting busbar 520. By using the connecting busbar 520, the motor 500 is more concise in design, easier to assemble, and more stable.

In some embodiments, the stator assembly 530 of the motor 500 is provided with a coil 550, and the connecting busbar 520 includes a mounting seat 521, and a first connecting member 522 and a second connecting member 523 disposed on the mounting seat 521. The first connecting end 5221 of the first connecting member 522 is arranged close to each other and can connect two adjacent coils 550. The second connecting end 5231 of the second connecting member 523 is disposed far away from each other and can connect distant coils 550. When the stator assembly 530 is assembled, the first connecting end 5221 of the first connecting member 522 is connected to adjacent coils 550, and the second connecting end 5231 of the second connecting member 523 is connected to distant coils 550, working together to power the coil 550. Of course, the motor 500 may be configured such that the coil 550 is provided on the rotor assembly 540.

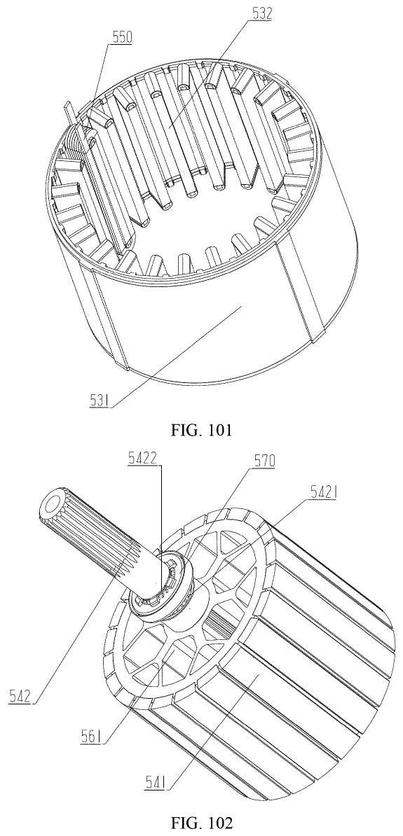

Further, the motor 500 also includes an iron core, and the iron core is annular. A plurality of winding frames 532 is provided in the iron core. A flat wire is wound on the winding frame 532 to form the coil 550. The coil 550 is wound with the flat wire, which has a smaller volume, less material and lower cost at the same power. The contact area between the flat wires is large, and heat dissipation and heat conduction are better, which is beneficial to improving the heat dissipation effect of the motor 500. Moreover, a terminal of the coil 550 wound by the flat wires is sheet-shaped, and the first connecting end 5221 of the first connecting member 522 and the second connecting end 5231 of the second connecting member 523 are also in sheet shape, which can better and more conveniently achieve the connection between a first terminal, a second terminal and the coil 550. Referring to FIG. 101, in some embodiments, the stator assembly 530 employs a winding method. The stator core 531 is annular, and a plurality of winding frames 532 is arranged circumferentially inside the stator core. The flat wire is wound on the winding frame 532.

The heat dissipation effect has a great influence on performance of the motor 500. When the motor 500 is configured in equipment that needs to repeatedly rotate forward and reverse, such as a cordage power device, higher heat dissipation requirements are imposed. In some embodiments, the motor 500 further includes a heat dissipation fan 730. The rotor assembly 540 and/or the stator assembly 530 is provided with an avoidance portion for mounting the heat dissipation fan 730. The heat dissipation fan 730 is mounted in the avoidance portion and accelerates air flow by rotating, enhancing the heat dissipation effect of the motor 500.

As shown in FIG. 100 and FIG. 102, in some embodiments, the heat dissipation fan 730 is a passive fan, and the heat dissipation fan 730 is disposed in the avoidance portion of the rotor assembly 540. For example, the rotor core 541 of the rotor assembly 540 is annular, and the heat dissipation fan 730 is fixedly disposed in an annular structure. When a rotor rotates, the heat dissipation fan 730 can be driven to rotate synchronously, effectively improving heat dissipation capacity of the motor 500.

However, when the motor 500 needs to frequently rotate forward and reverse or operates at a low speed, the above-mentioned heat dissipation method using a passive fan exhibits a problem of unstable heat dissipation capacity, which is greatly affected by the forward and reverse rotation and the rotational speed of the motor 500. This imposes certain limitations on improving the heat dissipation capacity of the motor 500 and cannot ensure that the motor 500 operates at an appropriate operating temperature. Based on this, referring to FIG. 100, in other embodiments, the heat dissipation fan 730 is an active fan 562. The heat dissipation fan 730 is connected to the stator assembly 530 or the motor housing 510, and rotates independently relative to the rotor assembly 540. For example, the iron core of the rotor assembly 540 is annular, and the heat dissipation fan 730 is located in the annular structure but does not contact the iron core; or, there is a gap between an end portion of the stator assembly 530 and the motor housing 510, and the heat dissipation fan 730 is located in the gap. This design of using the active fan 562 for heat dissipation is not affected by the forward and reverse rotation and the rotational speed of the motor 500, can maintain stable heat dissipation capacity, and ensures that the motor 500 operates at an appropriate operating temperature.

Exemplarily, the active fan 562 is integrated with a driving apparatus and connected to a motor 500 terminal board via a third FPC flexible cable. The third FPC flexible cable has a certain flexibility and can be arranged arbitrarily according to spatial layout, simplifying wiring, making internal layout of the motor 500 more compact and the motor 500 more miniaturized. The third FPC flexible cable is located on the outside of the stator assembly 530, and a metal protective plate is provided on a side of the third FPC flexible cable facing the rotor assembly 540 or the stator assembly 530, so that the third FPC flexible cable can be bent into a required shape through the metal protective plate, facilitating routing. The metal protective plate can also protect the third FPC flexible cable, and also isolate magnetic field, reducing adverse effects of the magnetic field.

Referring to FIGS. 102-104, in some embodiments, a magnetic ring 570 is further included. The magnetic ring 570 is disposed on a rotor shaft 542 of the rotor assembly 540. The magnetic ring 570 can be connected to the rotor shaft 542 by bonding, which is convenient to use. The magnetic ring 570 and the rotor shaft 542 can also be connected by structural cooperation, such as axial positioning via a magnetic ring snap 572 and circumferential positioning via a spline 573, instead of gluing, to avoid excessive glue filling and overflow, or insufficient glue filling and unstable connection. Exemplarily, an inner ring of the magnetic ring 570 is provided with a spline 573, which can be a continuous ring of tooth structure or discontinuous, separate segments of tooth structure. A side of the magnetic ring 570 is provided with a magnetic ring snap 572, and the corresponding rotor shaft 542 is provided with a keyway 5421 and a groove 5422. When the magnetic ring 570 is mounted on the rotor shaft 542, the spline 573 cooperates with the keyway 5421, and the magnetic ring snap 572 is snap-fit into the groove 5422.

Further, the magnetic ring 570 includes a housing 571 and a magnetic component 574 embedded in the housing 571. When connected to the rotor shaft 542 by structural cooperation, structures such as the magnetic ring snap 572 and the spline 573 provided on the magnetic ring 570 for connection are all disposed on the housing 571.

In some embodiments, the housing 571 is injection-molded outside the magnetic component 574. In this way, the magnetic component 574 is magnetized after injection molding and cooling, preventing high temperature during injection molding from affecting magnetism of the magnetic component 574.

Referring to FIG. 104, in other embodiments, the housing 571 is provided in a split manner, and the housing 571 is assembled outside the magnetic component 574. The separately produced housing 571 includes at least two parts, which are connected into a whole via a magnetic ring snap 572 or an interference fit, and includes a cavity inside, and the magnetic component 574 is mounted in the cavity.

In some embodiments, the motor housing 510 is further provided with a motor key mounting position 512 for mounting a second functional key 5121, and the second functional key 5121 is connected to a motor 500 terminal board via a third FPC flexible cable. The second functional key 5121 can be a key related to a function of the motor 500, such as a switch of the motor 500, or a control switch of the active fan 562. The second functional key 5121 can also be a key related to a function of a device where the motor 500 is located. Especially when there is no location for configuring a key on the device, the key can be configured on the motor 500, providing more sufficient installation space.

In some embodiments, two second functional keys 5121 may be provided to control a locking mechanism of the connecting structure 200. Pressing the two second functional keys 5121 at the same time can unlock the locking mechanism, so that the output device can be removed from the base 400.

In some embodiments, the first functional key 6124 and the second functional key 5121 can be provided at the same time. Pressing the two second functional keys 5121 at the same time can unlock the locking mechanism, so that the output device can be removed from the base 400. At this time, both hands are respectively located on the battery 610 and the motor 500, so that gripping and handling the device is more stable.

In some embodiments, an angle sensor and/or a revolution sensor can be disposed on a motor shaft, a reel shaft, or any transmission shaft, for recording a rotation angle and/or the number of revolutions of the corresponding transmission shaft, and further calculating how long the cordage 900 of the current output device has been pulled out based on a transmission ratio between the transmission shaft and the reel shaft, and a circumference of the reel shaft.

In some embodiments, one or more of the technical solutions of the universal cordage outlet mechanism 120, the technical solution of the winding reel 130 to fix the cordage 900, the solution of arranging the cordage on the winding reel 130 via the cordage arranging mechanism 140, the solution of coupling the connecting structure 200 with the base 400, the solution of the connecting busbar 520 in the motor 500, and the solution of the battery 610 can be applied not only to the output device but also to the corresponding structures of other fitness equipment.

The description with reference to terms such as “an embodiment”, “some embodiments”, “specifically”, or “some examples” means that a specific feature, structure, material, or characteristic described in conjunction with the embodiment or example is included in at least one embodiment or example of the present disclosure. In this specification, the exemplary expressions of the above terms do not necessarily refer to the same embodiment or example. Moreover, the described specific features, structures, materials, or characteristics may be combined in any one or more embodiments or examples in a suitable manner.

Although the embodiments of the present disclosure have been shown and described, those having ordinary skill in the art can understand that various changes, modifications, substitutions, and variations may be made to the embodiments without departing from the principle and spirit of the present disclosure, and the scope of the present disclosure is defined by the claims and their equivalents.

What is claimed is:

1. An output device, comprising:
a cordage box, wherein a rear side of the cordage box is provided with a connecting structure configured to be fixedly connected to a base, and a cordage from the cordage box is led out from a front side of the cordage box;
a motor, fixedly connected to the cordage box, wherein the motor is configured to provide a traction force for the cordage; and
a power supply assembly, fixedly connected to the cordage box, wherein the power supply assembly is configured to supply power to the motor.

2. The output device according to claim 1, wherein the fixed connection between the motor and the cordage box comprises a detachable connection and a quick-release connection, or the fixed connection between the power supply assembly and the cordage box comprises a detachable connection and a quick-release connection.

3-11. (canceled)

12. The output device according to claim 1, wherein the base is provided with a first limiting portion; the connecting structure is coupled to the base along a first direction, the connecting structure is provided with a second limiting portion, and the first limiting portion and the second limiting portion are configured to be locked along the first direction, and wherein when the first limiting portion and the second limiting portion are locked along the first direction, the connecting structure is configured to move relative to the base along a second direction to unlock the first limiting portion and the second limiting portion.

13-14. (canceled)

15. The output device according to claim 12, wherein the first limiting portion comprises a first limiting groove, the second limiting portion comprises a hook movably disposed on the connecting structure, and the hook is snapped into the first limiting groove to lock the base and the connecting structure in the first direction; and wherein the output device further comprises a locking member, movably disposed on the connecting structure; when the hook is locked with the first limiting groove, the locking member is configured to move relative to the connecting structure and abut against the hook to limit the movement of the hook.

16-40. (canceled)

41. The output device according to claim 1, further comprising:
a locking mechanism, the locking mechanism being configured to lock the connecting structure;
a first unlocking trigger apparatus, disposed on the motor and communicatively connected to the locking mechanism; and
a second unlocking trigger apparatus, disposed on the power supply assembly and communicatively connected to the locking mechanism;
wherein, the locking mechanism is configured to unlock the connecting structure when both the first unlocking trigger apparatus and the second unlocking trigger apparatus are triggered.

42-43. (canceled)

44. The output device according to claim 1, wherein a winding reel is disposed in the cordage box, and the winding reel is linked with the motor for winding the cordage.

45. The output device according to claim 44, wherein the winding reel comprises:
an inner core, which is rotatably mounted in a casing of the output device;
a winding reel housing, which is partially or fully sleeved on an outer side of the inner core, the winding reel housing is configured to wind the cordage, and the thermal conductivity of the winding reel housing is greater than the thermal conductivity of the inner core.

46-59. (canceled)

60. The output device according to claim 44, wherein the winding reel comprises:
a reel body, a fixing position is opened on a side surface of the reel body, and the reel body is configured for winding;
a cordage pressing block, the cordage pressing block is mounted on the fixing position, and the cordage pressing block and the fixing position press and fix the cordage.

61-81. (canceled)

82. The output device according to claim 1, wherein the cordage box is further provided with:
a winding reel, the winding reel is rotatably disposed on the cordage box, and the winding reel is configured to be wound by the cordage;
a cordage arranging mechanism, the cordage arranging mechanism is slidably or pivotably disposed on the cordage box, the cordage arranging mechanism is configured for the cordage wound around the winding reel to pass through, and the cordage moves with the cordage arranging mechanism;
a cordage box outlet, the cordage box outlet is disposed on the cordage box, and the cordage box outlet is configured for the cordage passing through the cordage arranging mechanism to pass out;
a linkage mechanism or a power mechanism, the linkage mechanism is connected to the winding reel and the cordage arranging mechanism, the linkage mechanism is configured to link the winding reel and the cordage arranging mechanism, and the power mechanism is configured to drive the cordage arranging mechanism to slide or pivot.

83-95. (canceled)

96. The output device according to claim 82, wherein the linkage mechanism is configured to drive the threading port of the cordage arranging mechanism to translate or pivot by a cordage diameter when a coil rotates one circle.

97.-101. (canceled)

102. The output device according to claim 1, wherein the cordage box outlet is provided with a universal cordage outlet mechanism, comprising a base for connecting with the cordage box, and a first channel is provided in the middle of the base;
a rotating seat, the rotating seat is rotatably connected to the base, a second channel is opened on a central axis of the rotating seat, and the second channel is in communication with the first channel;
cordage outlet wheels, which are arranged in pairs on the rotating seat along a first direction, and the cordage outlet wheels are located at the second channel;
a cordage outlet seat, which is provided on the rotating seat and located on a side of the cordage outlet seat far away from the base, the cordage outlet seat is provided with a cordage outlet hole, the cordage outlet hole is strip-shaped, the cordage outlet hole is arranged along a first direction, and the cordage outlet hole is in communication with the second channel.

103-122. (canceled)

123. The output device according to claim 1, further comprising a resistor structure, disposed on a housing of the cordage box, the motor, or the power supply assembly, wherein the resistor structure comprises a first plate body, a first heat-conducting component, and a resistor plate; the first plate body is connected to the housing, or is integrally formed with the housing, or is integrally formed with part of the housing; the first heat-conducting component is located between the resistor plate and the first plate body; and the resistor plate is configured to dissipate electric energy generated by a motor of fitness equipment.

124-130. (canceled)

131. The output device according to claim 1, wherein the power supply assembly comprises a battery, and the battery comprises:
a battery housing, comprising a first housing and a second housing connected by a battery snap in a first direction;
a battery cell, mounted in the battery housing;
an elastic heat-conducting pad, sandwiched between the battery cell and the battery housing in the first direction, wherein one side of the elastic heat-conducting pad is in contact with the battery cell, and the other side is in contact with an inner wall of the battery housing.

132-141. (canceled)

142. The output device according to claim 1, wherein the motor comprises a connecting busbar, and the connecting busbar comprises: a mounting seat, the mounting seat being an insulating member;
at least one first connecting member, the first connecting member being plugged into the mounting seat, the first connecting member including at least two first connecting ends for connecting to a coil; or,
at least one second connecting member, the second connecting member being disposed on the mounting seat, the second connecting member including at least two second connecting ends for connecting to a coil.

143-160. (canceled)

161. An output assembly, comprising:
an output device; and
a base, detachably connected to the connecting structure of the output device,
wherein the output device comprises:
a cordage box, wherein a rear side of the cordage box is provided with a connecting structure configured to be fixedly connected to a base, and a cordage from the cordage box is led out from a front side of the cordage box;
a motor, fixedly connected to the cordage box, wherein the motor is configured to provide a traction force for the cordage; and
a power supply assembly, fixedly connected to the cordage box, wherein the power supply assembly is configured to supply power to the motor.
